(19) United States
(12) Patent Application Publication
(10) Pub. No.: US 2006/0275736 A1
(43) Pub. Date: Dec. 7, 2006

(54) Computer aided orthodontic treatment planning

(75) Inventors: Huafeng Wen, Redwood City, CA (US); Muhammad Ziaullah Khan Chishti, Washington, DC (US); Frank Zhenhuan Liu, San Carlos, CA (US); Kashif Mohammad, Karachi (PK); Syed Wasi Mohsin Raza Rizvi, Karachi (PK); Yasser Bashir, Lahore (PK)

Correspondence Address: MORRISON & FOERSTER LLP, 755 PAGE MILL RD, PALO ALTO, CA, 94304-1018, US

(73) Assignee: OrthoClear Holdings, Inc., Tortola (VG)

(21) Appl. No.: 11/404,643

(22) Filed: Apr. 13, 2006

Related U.S. Application Data
(60) Provisional application No. 60/673,851, filed on Apr. 22, 2005.
(60) Provisional application No. 60/673,970, filed on Apr. 22, 2005.
(60) Provisional application No. 60/675,003, filed on Apr. 25, 2005.
(60) Provisional application No. 60/676,546, filed on Apr. 29, 2005.
(60) Provisional application No. 60/731,371, filed on Oct. 27, 2005.

(51) Int. Cl. A61C 11/00; A61C 3/00

(52) U.S. Cl. 433/213; 433/24

(57) ABSTRACT

Methods, devices and systems for digitizing a patient's arch and manipulating the digital dental arch model. In one variation the methods includes producing a physical arch model for the patient's arch, separating the physical arch model into a plurality of arch model components, mounting the arch model components on a scan plate, capturing one or more images of the arch model components, and developing digital representations of the arch model components using the captured one or more images.

### CROSS-REFERENCE TO RELATED APPLICATIONS

The present patent application claims priority to US provisional patent applications: U.S. Provisional Patent Application Ser. No. 60/673,851, titled “COMPUTER AIDED ORTHODONTIC TREATMENT PLANNING” by Huafeng Wen et al., filed Apr. 22, 2005; U.S. Provisional Patent Application Ser. No. 60/673,970, titled “SYSTEMS FOR DIGITIZING AND REGISTERING A SUBJECT'S UPPER AND LOWER ARCHES” by Huafeng Wen, filed Apr. 22, 2005; U.S. Provisional Patent Application Ser. No. 60/675,003, titled “METHOD FOR PRESCRIBING ORTHODONTIC TREATMENTS” by Huafeng Wen et al., filed Apr. 25, 2005; U.S. Provisional Patent Application Ser. No. 60/676,546, titled “DIGITIZATION OF DENTAL ARCH MODEL” by Huafeng Wen et al., filed Apr. 29, 2005; and U.S. Provisional Patent Application Ser. No. 60/731,371, titled “METHOD FOR GENERATING DIGITAL DENTAL ARCH MODEL” by Huafeng Wen et al., filed Oct. 27, 2005. Each of these applications is herein incorporated by reference in its entirety.

Refer also to commonly assigned U.S. patent application Ser. No. 11/107,584, titled “DIGITAL ALIGNER DEVICES HAVING SNAP-ON FEATURES” by Huafeng Wen et al., filed Apr. 15, 2005; U.S. patent application Ser. No. 10/979,823, titled “METHOD AND APPARATUS FOR MANUFACTURING AND CONSTRUCTING A PHYSICAL DENTAL ARCH MODEL” by Huafeng Wen, filed Nov. 2, 2004, U.S. patent application Ser. No. 10/979,497, titled “METHOD AND APPARATUS FOR MANUFACTURING AND CONSTRUCTING A DENTAL ALIGNER” by Huafeng Wen, filed Nov. 2, 2004, U.S. patent application Ser. No. 10/979,504, titled “PRODUCING AN ADJUSTABLE PHYSICAL DENTAL ARCH MODEL” by Huafeng Wen, filed Nov. 2, 2004, and U.S. patent application Ser. No. 10/979,824, titled “PRODUCING A BASE FOR PHYSICAL DENTAL ARCH MODEL” by Huafeng Wen, filed Nov. 2, 2004, each of which is incorporated herein by reference in its entirety for all purposes as if each individual patent application were specifically and individually set forth herein.

Refer also to commonly assigned U.S. patent application Ser. No. 11/013,152, titled “A BASE FOR PHYSICAL DENTAL ARCH MODEL” by Huafeng Wen, filed Dec. 14, 2004, commonly assigned U.S. patent application Ser. No. 11/012,924, titled “ACCURATELY PRODUCING A BASE FOR PHYSICAL DENTAL ARCH MODEL” by Huafeng Wen, filed Dec. 14, 2004, commonly assigned U.S. patent application Ser. No. 11/013,145, titled “FABRICATING A BASE COMPATIBLE WITH PHYSICAL DENTAL TOOTH MODELS” by Huafeng Wen, filed Dec. 14, 2004, commonly assigned U.S. patent application Ser. No. 11/013,156, titled “PRODUCING NON-INTERFERING TOOTH MODELS ON A BASE” by Huafeng Wen, filed Dec. 14, 2004, commonly assigned U.S. patent application Ser. No. 11/013,160, titled “SYSTEM AND METHODS FOR CASTING PHYSICAL TOOTH MODEL” by Huafeng Wen, filed Dec. 14, 2004, commonly assigned U.S. patent application Ser. No. 11/013,159, titled “PRODUCING A BASE FOR ACCURATELY RECEIVING DENTAL TOOTH MODELS” by Huafeng Wen, filed Dec. 14, 2004, and commonly assigned U.S. patent application Ser. No. 11/013,157, titled “PRODUCING ACCURATE BASE FOR DENTAL ARCH MODEL” by Huafeng Wen, filed Dec. 14, 2004, each of which is incorporated herein by reference in its entirety for all purposes as if each individual patent application were specifically and individually set forth herein.

### TECHNICAL FIELD

This application generally relates to the field of dental care, and more particularly to the field of orthodontics.

### BACKGROUND

Orthodontics is the practice of manipulating a subject's teeth to provide better function and appearance. In general, brackets are bonded to a subject's teeth and coupled together with an arched wire. The combination of the brackets and wire provide a force on the teeth causing them to move. Once the teeth have moved to a desired location and are held in a place for a certain period of time, the body adapts bone and tissue to maintain the teeth in the desired location. To further assist in retaining the teeth in the desired location, a subject may be fitted with a retainer.

To achieve tooth movement, orthodontists utilize their expertise to first determine a three-dimensional mental image of the subject's physical orthodontic structure and a three-dimensional mental image of a desired physical orthodontic structure for the subject, which may be assisted through the use of x-rays and/or models. Based on these mental images, the orthodontist further relies on his/her expertise to place the brackets and/or bands on the teeth and to manually bend (i.e., shape) wire, such that a force is asserted on the teeth to reposition the teeth into the desired physical orthodontic structure. As the teeth move towards the desired location, the orthodontist makes continual judgments as to the progress of the treatment, the next step in the treatment (e.g., new bend in the wire, reposition or replace brackets, is head gear required, etc.), and the success of the previous step.

In general, the orthodontist makes manual adjustments to the wire and/or replaces or repositions brackets based on his or her expert opinion. Unfortunately, in the oral environment, it is difficult for a human being to accurately develop a visual three-dimensional image of an orthodontic structure due to the limitations of human sight and the physical structure of a human mouth. In addition, it is difficult (if not impossible) to accurately estimate three-dimensional wire bends (with accuracy within a few degrees) and to manually apply such bends to a wire. Further, it is difficult (or impossible) to determine an ideal bracket location to achieve the desired orthodontic structure based on the mental images. It is also extremely difficult to manually place brackets in what is estimated to be the ideal location. Accordingly, orthodontic treatment is an iterative process requiring multiple wire changes, with the success and speed of the process being dependent on the orthodontist's motor skills and diagnostic expertise. As a result of multiple wire changes, cost and subject discomfort is increased. The quality of care may also vary greatly from orthodontist to orthodontist, as does the time to treat a subject.

The practice of orthodontic is very much an art, relying on the expert opinions and judgments of the orthodontist. In an effort to shift the practice of orthodontic from an art to a science, many innovations have been developed. For example, U.S. Pat. No. 5,518,397 issued to Andreiko, et. al. provides a method of forming an orthodontic brace. Such a method includes obtaining a model of the teeth of a patient's mouth and a prescription of desired positioning of such teeth. The contour of the teeth of the patient's mouth is determined, from the model. Calculations of the contour and the desired positioning of the patient's teeth are then made to determine the geometry (e.g., grooves or slots) to be provided. Custom brackets including a special geometry are then created for receiving an arch wire to form an orthodontic brace system. Such geometry is intended to provide for the disposition of the arched wire on the bracket in a progressive curvature in a horizontal plane and a substantially linear configuration in a vertical plane. The geometry of the brackets is altered, (e.g., by cutting grooves into the brackets at individual positions and angles and with particular depth) in accordance with such calculations of the bracket geometry. In such a system, the brackets are customized to provide three-dimensional movement of the teeth, once the wire, which has a two dimensional shape (i.e., linear shape in the vertical plane and curvature in the horizontal plane), is applied to the brackets.

Other innovations relating to bracket and bracket placements have also been described. For example, such patent innovations are disclosed in U.S. Pat. No. 5,618,716 entitled “Orthodontic Bracket and Ligature,” which describes a method of ligating arch wires to brackets, U.S. Pat. No. 5,011,405 “Entitled Method for Determining Orthodontic Bracket Placement,” U.S. Pat. No. 5,395,238 entitled “Method of Forming Orthodontic Brace,” and U.S. Pat. No. 5,533,895 entitled “Orthodontic Appliance and Group Standardize Brackets therefore and methods of making, assembling and using appliance to straighten teeth”.

Kuroda et al. (1996) Am. J. Orthodontics 110:365-369 describes a method for laser scanning a plaster dental cast to produce a digital image of the cast. See also U.S. Pat. No. 5,605,459. U.S. Pat. Nos. 5,533,895; 5,474,448; 5,454,717; 5,447,432; 5,431,562; 5,395,238; 5,368,478; and 5,139,419, assigned to Ormco Corporation, which describe methods for manipulating digital images of teeth for designing orthodontic appliances.

U.S. Pat. No. 5,011,405 describes a method for digitally imaging a tooth and determining optimum bracket positioning for orthodontic treatment. Laser scanning of a molded tooth to produce a three-dimensional model is described in U.S. Pat. No. 5,338,198. U.S. Pat. No. 5,452,219 describes a method for laser scanning a tooth model and milling a tooth mold. Digital computer manipulation of tooth contours is described in U.S. Pat. Nos. 5,607,305 and 5,587,912. Computerized digital imaging of the arch is described in U.S. Pat. Nos. 5,342,202 and 5,340,309.

Other patents of interest include U.S. Pat. Nos. 5,549,476; 5,382,164; 5,273,429; 4,936,862; 3,860,803; 3,660,900; 5,645,421; 5,055,039; 4,798,534; 4,856,991; 5,035,613; 5,059,118; 5,186,623; and 4,755,139.

Efficiency in treatment and maximum quality in results may depend on a realistic simulation of the treatment process. Plaster models of the upper and lower arch may be made, the model may be cut into single tooth models and these tooth models can be stuck into a wax bed, in a desired position, to create a “set-up.” This approach allows modeling of a perfect occlusion without any guessing. The next step is to bond a bracket at every tooth model. This would tell the orthodontist the geometry of the wire to run through the bracket slots to receive exactly this result. Then the bracket position may be transferred to the original malocclusion model. To make sure that the brackets will be bonded at exactly this position at the real patient's teeth, small templates for every tooth would have to be fabricated that fit over the bracket and a relevant part of the tooth and allow for reliable placement of the bracket on the patient's teeth. To increase efficiency of the bonding process, another option would be to place each single bracket onto a model of the malocclusion and then fabricate one single transfer tray per arch that covers all brackets and relevant portions of every tooth. Using such a transfer tray guarantees a very quick and yet precise bonding using indirect bonding.

U.S. Pat. No. 5,431,562 to Andreiko et al. describes a computerized, appliance-driven approach to orthodontics. In this method, first certain shape information of teeth is acquired. A uniplanar target archform is calculated from the shape information. The shape of customized bracket slots, the bracket base, and the shape of the orthodontic archwire, are calculated in accordance with a mathematically-derived target archform. The goal of the Andreiko et al. method is to give more predictability, standardization, and certainty to orthodontics by replacing the human element in orthodontic appliance design with a deterministic, mathematical computation of a target archform and appliance design. Hence the '562 patent teaches away from an interactive, computer-based system in which the orthodontist remains fully involved in patient diagnosis, appliance design, and treatment planning and monitoring.

Align Technologies recently began offering transparent, removable aligning devices as a new treatment modality in orthodontics. In this system, an impression model of the dentition of the patient is obtained by the orthodontist and shipped to a remote appliance-manufacturing center, where it is scanned with a CT scanner. A computer model of the dentition in a target situation is generated at the appliance-manufacturing center and made available for viewing to the orthodontist over the Internet. The orthodontist indicates changes they wish to make to individual tooth positions. Later, another virtual model is provided over the Internet and the orthodontist reviews the revised model, and indicates any further changes. After several such iterations, the target situation is agreed upon. A series of removable aligning devices or shells are manufactured and delivered to the orthodontist. The shells, in theory, will move the patient's teeth to the desired or target position.

U.S. Pat. No. 6,699,037 by Align Technologies describes an improved methods and systems for repositioning teeth from an initial tooth arrangement to a final tooth arrangement. Repositioning is accomplished with a system comprising a series of appliances configured to receive the teeth in a cavity and incrementally reposition individual teeth in a series of at least three successive steps, usually including at least four successive steps, often including at least ten steps, sometimes including at least twenty-five steps, and occasionally including forty or more steps. Most often, the methods and systems will reposition teeth in from ten to twenty-five successive steps, although complex cases involving many of the patient's teeth may take forty or more steps. The successive use of a number of such appliances permits each appliance to be configured to move individual teeth in small increments, typically less than 2 mm, preferably less than 1 mm, and more preferably less than 0.5 mm. These limits refer to the maximum linear translation of any point on a tooth as a result of using a single appliance. The movements provided by successive appliances, of course, will usually not be the same for any particular tooth. Thus, one point on a tooth may be moved by a particular distance as a result of the use of one appliance and thereafter moved by a different distance and/or in a different direction by a later appliance.

The individual appliances will preferably comprise a polymeric shell having the teeth-receiving cavity formed therein, typically by molding as described below. Each individual appliance will be configured so that its tooth-receiving cavity has a geometry corresponding to an intermediate or end tooth arrangement intended for that appliance. That is, when an appliance is first worn by the patient, some of the teeth will be misaligned relative to an undeformed geometry of the appliance cavity. The appliance, however, is sufficiently resilient to accommodate or conform to the misaligned teeth, and will apply sufficient resilient force against such misaligned teeth in order to reposition the teeth to the intermediate or end arrangement desired for that treatment step.

The fabrication of aligners by Align Technologies utilizes stereo lithography process as disclosed in U.S. Pat. Nos. 6,471,511 and 6,682,346. Several drawbacks exist however with the stereo lithography process. The materials used by stereo lithography process may be toxic and harmful to human health. Stereo lithography process builds the aligner layer by layer by layer, which may create room to hide germs and bacteria while it is worn by a patient. Furthermore, stereo lithography process used by Align Technology also requires a different aligner mold at each stage of the treatment, which produces a lot of waste and is environmental unfriendly. There is therefore a long felt need for practical, effective and efficient methods to produce a dental aligner.

Another challenge for orthodontic treatment using removable dental aligning devices is that dental aligners often deform or otherwise loose their shape with age, use and/or environment. For example, a dental aligner (e.g., a “shell”) may be deformed by chewing, biting, and hot beverages during wearing by the patient. The deformation can affect the proper function of the removable dental aligning device, because the ability of the aligner to effectively move teeth may depend upon the contact that the aligner makes with the teeth.

Furthermore, dental aligners may become relaxed and open up after repeated usage by a patient, which causes a loss of corrective forces applied by the aligner to the patient's teeth. This results in insufficient or inaccurate teeth movement and costly corrective measures in the orthodontic treatment.

Another difficulty with the current removable dental aligning devices is that the narrow tolerance for the removable dental aligning devices to fit to the patient's teeth. The removable dental aligning devices have to be produced very close to the surface profiles of the patient's teeth. Mismatch between the removable dental aligning devices and patient's teeth often produce discomfort in wearing the removable dental aligning devices.

Existing aligner have not adequately addresses these problems. For example, U.S. Pat. No. 4,793,803 by Martz discloses separate appliances insertable in and removable from the upper and lower jaws of the subject to correct minor malocclusions. Martz describes: (a) a fairly rigid portion which mates with or securely grips the tooth surface, (b) a rigid portion to provide the base and shape, and (c) an intermediate, flexible resilient portion interposed between (a) and (b) which biases the teeth into the desired position. The rigidity of the rigid portion may vary depending on the condition of an individual case. In some instances the rigid portion need only be somewhat flexible, thereby performing the function of the intermediate portion as well.

U.S. Pat. No. 6,309,215 by Phan et al. describes systems and methods for removably attaching a dental positioning appliance to the teeth of a subject during orthodontic treatment. Such removable dental positioning appliances are often preferred over conventional braces for tooth repositioning due to comfort, appearance and ease of use. These appliances apply force to specific surfaces of the teeth to cause directed movement. However, the type of movement and amount of force applied is usually dependent on the surface characteristics and positions of connection to the teeth. The appliances or connection between the appliance and the teeth may not provide sufficient anchoring to impart a desired force on the teeth to be repositioned. Thus, such systems may require the use of one or more attachment devices that may be positioned on the teeth to provide the appropriate physical features. Appliances may attach to a subject's teeth by interactions with a pit or dimple on the dental aligning devices are often not secure enough, especially when large teeth movements are required. Furthermore, over a period of usage by a subject, an aligner can also become relaxed and open up. Dental aligning devices that attach to the subject's teeth by dimples may slip over the attachment, which can result in inaccurate teeth movement and costly corrective measures in the orthodontic treatment. However, specific design and location of these attachment devices may provide more effective repositioning forces, anchoring ability and appliance retention.

Another issue with most commercially available removable aligning devices (e.g., the devices manufactured by Align Technologies) is that the aligning devices do not allow oxygen to pass through them. A typical treatment takes about 18 to 24 months, and during this interval the cervical lines of the patient wearing such appliances typically remain covered for the major part of the day without letting air to pass through them. Oxygen cannot reach the cells of the cervical lines, and air trapped inside the aligning appliances cannot readily escape. Anaerobic bacteria such as Fusobacterium and Actinomyces often thrive in an oxygen-deprived environment and may produce volatile sulfur compounds (VSC) as byproducts, which can result in bad breath (halitosis) and hygiene problems in the patient's mouth.

In addition to the problems identified above, many aligners are also limited in their ability to effect corrections requiring lateral expansion of the palate. Most presently available aligners move only the teeth, with only minimal impact on the motion of the palate. Further, traditional devices for expanding the palate are difficult to manufacture, and are incapable of correcting the entire upper dental arch. For example, U.S. patent application Ser. No. 10/636,313 to McSurdy (herein incorporated by reference in its entirety) describes a palatal expansion device. Thus, it would be desirable to provide an economical, easily fabricated aligner capable of reforming the entire upper dental arch, including the palate.

The devices, systems, and methods described herein illustrate removable dental aligners having one or more features addressing at least some of the problems described above. In particular described herein are variations of dental aligners including dental aligners having through-holes through which connectors securable to a subject's teeth may pass and be secured, dental aligners including controllably deformable regions or textured surfaces (e.g., wrinkled aligners), non-uniform and/or multilayer dental aligners, and dental aligners which are fluid and/or gas permeable. Any or all of these features may be combined to form a dental aligner, as described more fully below.

### SUMMARY OF THE INVENTION

Described herein are systems, methods and devices to correct or modify a subject's dental arch. In particular, described herein are methods, systems and devices for digitizing all or a portion of a subject's dental arch. Also described herein are devices, methods and systems for digitally modeling the teeth, including regions of the teeth that are not directly measured, modeled or digitized, such as the roots. Also described herein are methods, systems and devices for displaying digital models of all or a portion of the subject's dental arch and for allowing one or more user to interact with these digital models. The user may interact by selecting one or more dental arch features, modifying the view or shape of the dental arch feature, and submitting a set of treatment instructions based on the user interaction and/or the manipulated digital model.

In one aspect, the present invention relates to a method for digitizing a patient's tooth arch. One variation comprises producing a physical arch model for the patient's tooth arch, separating the physical arch model into a plurality of arch model components, mounting the arch model components on a scan plate, capturing one or more images of the arch model components, and developing digital representations of the arch model components using the captured one or more images.

Another variation comprises producing a physical arch model for the patient's arch, separating the physical arch model into a plurality of arch model components, mounting the arch model components on a scan plate, capturing one or more images of the arch model components, developing digital representations of the arch model components using the captured one or more images, and combining the digital representations for the arch model components into a digital arch model.

In another aspect, the present invention relates to a system for digitizing a patient's arch. One variation of the system comprises a scan plate configured to be mounted with a plurality of arch model components that are separated from a physical arch model corresponding to the patient's arch, an image capturing device configured to capture at least one image of the arch model components, and a computer configured to develop digital representations of the arch model components using the captured one or more image.

Variations of the method and the system may include one or more of the following advantages. The disclosed system and methods may support the digitization of a patient's tooth arch at high throughput. In one variation, a plurality of tooth arch model components can be mounted on a rotatable scan table and scanned simultaneously. The system may be configured such that three dimensional scanning can be conducted on the arch model components at high throughput in parallel. For example, multiple scanning platforms may be setup next to each other to process a large number of tooth arches at the same time. The multiple scanning platforms may be configured with network connections to allow each of the scanning platforms to communicate with a central computer, such that data and/or images collected from scanning can be sent to a central computer for processing.

Variations of the methods and systems for digitizing a patient's tooth arch may allow one to achieve improved accuracy in scanning of the individual tooth model. In one configuration, the patient's tooth arch model is separated into components (e.g., individual tooth models) to allow three-dimensional scanning of the critical areas of the arch model components. The components and the scanning system may be configured such that the surfaces of the arch model components can be scanned in a fashion as to avoid obstruction by different parts of the same arch model component or other components mounted on the rotate-able scan table.

In one variation, registration marks, such as locking pins, are implemented in the tooth arch model components. These registration marks may improve scanning and digital reconstruction accuracy. In one variation, the digital representations of the tooth arch model components are translated into the common coordinates for the tooth arch model, and then combined to form the digital models of the patient's tooth arch. The digital arch models may be used as input or reference for various applications. For example, the digital tooth arch models may be utilized in CNC based manufacturing of dental arch models, dental arch base, and/or dental aligners for the patient. Furthermore, the digital representation of the tooth arch model may be utilized with root modeling techniques and/or implemented with computer display system for various dental and orthodontic applications.

Also disclosed herein are methods for generating a digital representation of a patient's tooth arch. In one approach, the method comprises creating a positive dental arch replica based on a negative dental arch mold (e.g., dental impression). The positive dental arch is then separated into a plurality of individual tooth replicas. The individual tooth replicas are divided into two or more groups. Tooth replicas within each group are placed onto a plate together, and scanned as a group of objects with a scanner (e.g., laser scanner, optical scanner, CAT scanner, MRI, etc.) to capture the profile for each of the teeth. The scanning plate may be related to a reference coordinate, and each of the teeth being scanned is related to the reference coordinate. Digital representations of the scanned teeth are generated by the computer based on the scan. The digital representation can include a surface profile of the crown portion of the tooth in relation to the reference coordinate. Once all the groups of teeth, which form the complete tooth arch, are digitized, a computer then constructs a digital representation of the complete tooth arch based on the digital representation of the two or more groups of tooth replicas.

In one example, the positive teeth replicas are separated into two groups. Each group includes teeth representing every other tooth in the tooth arch. Each group is then placed on a plate forming a partial tooth arch, where each tooth is positioned and oriented to represent its position within the tooth arch in relation the other tooth in the group. The first group of teeth is scanned to form a digital representation of a first partial tooth arch. Then, the second group of teeth is scanned to form a digital representation of a second partial tooth arch. By removing the adjacent tooth replicas for each of the tooth replicas being scanned, the scanner is able to better capture the surface profile of the teeth, which would otherwise have been partially blocked by the adjacent teeth.

In one variation the same scanning plate is configured for positioning and scanning both groups of tooth replicas. In another variation, two different plates with a common reference coordinate system are utilized for each of the group scan. The digital representation of the first partial tooth arch and the digital representation of the second partial tooth arch are then superimposed over each other to form a digital representation of the complete tooth arch. Since that, at least portion of the sides of each of the positive tooth replicas are scanned, this digital representation of the tooth can include more information of individual tooth profile in comparison to a full dental arch scan performed without breaking apart individual teeth in positive dental arch during the scanning process. In addition, by arranging each tooth replica according to its position and orientation within the complete tooth arch, the computer can quickly construct the digital representation of the tooth arch since the relative position of each of the tooth to the tooth arch are captured in the digital representation of the partial tooth arch.

Depending on user preference, the user may create the partial arch from scanning by leaving out one tooth on each side, two teeth on each side, or one tooth on one side while two teeth on the other side is omitted. One of ordinary skill in the art having the benefit of this disclosure would also appreciate that other combinations are possible. One of ordinary skill in the art having the benefit of this disclosure would appreciate that the tooth replicas within each tooth arch can also be divided into three or more groups for scanning. For example, the tooth replicas in a given tooth arch can be divided into three groups and then scanned to generate three digital representation of partial tooth arches. The three digital representations of partial tooth arches are then superimposed over each other to form a single digital representation of a complete tooth arch.

In another variation, each group of the positive tooth replicas is placed on a plate having a flat surface serving as a reference plane. If two or more plates are utilized, reference markers may be provided, such that scanning performed on different plates can be referenced against each other. For example, two identical plates may be used. The tooth replicas may be placed on the plate in relation to their position in the tooth arch. In an alternative approach, the tooth replicas are placed on a plate having a predefined matrix. The tooth replicas are arranged on the plate, such that once they are digitized, a full or partial tooth arch can be generated by moving the tooth on the reference plane (e.g., X-axis and Y-axis) to form a complete or partial tooth arch without moving the teeth in and out of the reference plane (e.g., Z-axis) or tilting the teeth to fit them within the overall tooth arch.

In another example, all the tooth replicas are placed onto a single scanning plate having a reference plane. Each of the tooth replicas is placed within a position in the reference matrix which allows the user to track the tooth in relation to the tooth arch (e.g., location of the tooth within the complete tooth arch). In one approach, the teeth are positioned on the plate such that the tilt/orientation for each of the teeth corresponds to the tilt/orientation of the tooth within the tooth arch, and once the tooth replicas are scanned, the computer can quickly construct the digital representation of the complete tooth arch by moving the digital representation of the tooth replicas on a reference plane (e.g., recalculate the X-Y position information) without the need to move the digital representation of the tooth replica on the Z-axis nor tilting/rotating the tooth replicas. In one variation, a full scan of the complete positive dental arch can be scanned ahead of the time. Information from the full arch scan can then be utilized during the construction of digital representation of the completely tooth arch by fitting digital representation of individual tooth into the appropriate position within the tooth arch.

In addition, a reference marker such as an extension (e.g., one or more pins, etc.) may be provided on the individual tooth replicas before the individual tooth replicas are separated from the positive dental arch replica. For example, extensions may be incorporated into the positive tooth replicas as they are being formed from the negative dental arch mold. Receptacles, which match the extensions on the corresponding tooth replicas, are then provided on the scanning plate to position the individual tooth replicas on the plate. By tracking the position of the reference marker (e.g., extension) for each of the positive tooth replica, the computer can reconstruct the complete tooth arch from digital representation of individual tooth replicas, which may be scanned in groups of two or more tooth replicas.

Also described herein are methods, systems, and apparatus to manufacture and construct models of the dental arch. For example, described herein are methods of modeling a subject's dental arches in occlusion. These methods may include: identifying an upper arch model with a first fiduciary reference, identifying a lower arch model with a second fiduciary reference, aligning the upper arch model and the lower arch model to a bite-down position, and measuring the relative positions of the upper arch model and the lower arch model by measuring the relative positions of the first and second fiduciary references. These methods may also include mapping the upper arch model and the lower arch model to the same coordinate system.

In some variations, the step of aligning the upper arch model and the lower arch model to a bite-down position may include aligning the upper arch model and the lower arch model to a bite-down position using a bite-down registration device. The bite-down registration device may be a wax bit.

In some variations, the identifying an upper arch model with a first fiduciary reference comprises labeling the upper arch model with a first fiduciary reference, and identifying a lower arch model with a second fiduciary reference comprises labeling the lower arch model with a second fiduciary reference. In some versions, identifying an upper arch model with a first fiduciary reference comprises mounting the upper arch model on a first fixture, wherein the first fixture comprises a first fiduciary reference, and identifying a lower arch model with a second fiduciary reference comprises mounting the lower arch model on a second fixture, wherein the second fixture comprises a second fiduciary reference.

The method may also include scanning at least a part of the upper arch model and the first fiduciary reference to model the upper arch model; and scanning at least a part of the lower arch model and the second fiduciary reference to model the upper arch model. In some variations, the method also includes producing a digital representation of the upper arch model; and producing a digital representation of the lower arch model.

The method of modeling a subject's dental arches in occlusion may include producing a digital representation of the upper arch model and the lower arch model in the same coordinate system.

Another method described here for digitizing a subject's arch includes mounting an upper arch model for the subject on a first fixture, mounting a lower arch model for the subject on a second fixture, aligning the upper arch model and the lower arch model to a bite-down position using a bite-down registration device, and measuring the relative positions of the upper arch model and the lower arch model.

In one variation, the method of digitally modeling a subject's dental arch includes: identifying an upper arch model with a first fiduciary reference; identifying a lower arch model with a second fiduciary reference; scanning the upper arch model to produce a digital upper arch model; scanning the lower arch model to produce a digital lower arch model; defining the coordinates of the digital upper arch model using the first fiduciary reference; defining the coordinates of the digital lower arch model using the second fiduciary reference; aligning the upper arch model and the lower arch model to a bite-down position; using a bite-down registration device; measuring the relative positions of the upper arch model and the lower arch model by measuring the relative positions of the first and second fiduciary references; and transforming the digital upper arch model and the digital lower arch model into a common coordinate system.

Also described herein are systems for digitizing a dental arch. These systems may include a scan plate configured to receive a plurality of arch model components separated from a model a dental arch, an image capturing device configured to capture at least one image of the arch model components, and a computer configured to construct the coordinates of the surfaces of the arch model components using the captured image to produce digital representations for the arch model components, and to transform the arch model components into a single coordinate system.

The computer may be configured to combine the digital representations for the arch model components into a digital dental arch model. The system may also include a rotation mechanism coupled to the scan plate, configured to rotate the scan plate under control of the computer to allow a plurality of images of the arch model components to be captured in a plurality of directions. The arch model components may comprise registration features that define relative positions of the arch model components. The scan table may include receiving features configured to receive the registration features on the arch model components.

In some variations, the system also includes a plurality of image capture devices configured to capture images at different directions relative to the arch model components.

The disclosed systems and methods may enable the digitization of a subject's upper and lower arches and may represent digital models of the two arches in a common coordinate system. The subject's upper arch model and lower arch model may be separately mounted on two fixtures or otherwise provided with references to provide basis for the fixture-specific coordinates for each of the arches. Two arch models can then be registered in a bite-down position by a registration device. The relative positions of the two arches during occlusion can be measured or scanned such that specific coordinates for a single dental arch can be translated into a common coordinate system for the upper and lower dental arch during occlusion. A unified digital model for the upper and lower arches may thus be obtained.

The disclosed methods and system may provide dental aligner devices in accordance with a unified digital model for the upper and lower arches. The dental aligner devices so obtained are comfortable for subjects to wear, to bite, or to chew. The proper alignment of the upper and lower aligner devices in the subject mouth also reduce damage to the aligner devices caused by biting, increasing the useful lifetime of the aligner device, and potentially reducing treatment costs.

Also described herein are various methods for displaying and/or modeling a patient's teeth. Method and system for modeling the roots of the teeth are also disclosed. In one variation, the method comprises generating a digital representation of a crown portion of a tooth for each of a plurality of teeth within the tooth arch of the patient. A computer is then utilized to generate a digital representation of a root portion of the tooth for each of the corresponding crown portions of the teeth. With the assistance of the computer, a digital representation of the tooth arch based on at least the digital representation of the crown portions and the digital representation of the root portions of the teeth is then formulated.

In one example, individual physical models of the patient's teeth are utilized to generate a digital representation of the crown for each of the teeth in the patient's tooth arch. Based on the profile or other parameters (e.g., size, dimension, X-ray, etc.) of the crown, the computer generates a simulated root for each of the corresponding crown portion of the teeth. The computer then creates a digital representation of a tooth arch including both the crown and root information. The digital representation of the patient's tooth arch is configured such that the user can selectively modify the position and/or orientation of an individual tooth relative to the rest of the teeth in the tooth arch. As one of ordinary skill in the art having the benefit of this disclosure would appreciate, a computer can be configured with an electronic display device (e.g., CRT monitor, LCD display panel, etc.) to display both the pre-modified tooth arch model and the post-modified tooth arch model in a side-by-side manner. In one variation, the software in the computer is configured such that as the user rotates one of the two tooth arch models, the other tooth arch model will rotate simultaneously in a corresponding manner. The two models may be shown in perspective views to allow the user to visualize the relative positions of the teeth within each of the tooth arches.

The dental arch (or multiple dental arches) may also be displayed using stereo images so that the dental arch appears to be three-dimensional. Any appropriate manner of displaying the dental arch (or teeth) in three dimensions may be used. For example, the practitioner or user viewing the dental arch may wear glasses or goggles permitting stereo images of the dental arch to be viewed as three-dimensional images. These stereo images may be manipulated using a control device appropriate for manipulating three-dimensional images, such as a 3D-mouse, joystick, gloves (e.g., haptic gloves with force feedback), or the like, appropriate for interaction with three-dimensional images.

Furthermore, once a digital representation of a tooth arch including the root information is generated, the root information may then be utilized by the user (e.g., dentists, dental technician, etc.) to detect potential problems that may arise due to adjustments of one or more teeth within the tooth arch. This detection may be assisted by a computer program configured to evaluate the modified tooth arch model based on a set a predefined parameter. For example, collision and/or potential collision between the roots may be detected. In addition, for each of the tooth within the tooth arch, boundary parameters may be defined base on the position of the adjacent roots, physiological understanding of other soft and/or hard tissues surrounding the root of the tooth, etc., to prevent the user from over adjusting the position and/or orientation of the tooth.

For example, periodontal ligament (PDL), which surrounds the root of each of the teeth, can be simulated. As the tooth is displaced and/or rotated, morphological change on the PDL due to compression or other physiological parameters can also be simulated. This may allow the computer program and/or the user to predict possible complications, such resorption of PDL due to compression force, inflammation due to soft tissue damage. In one variation, the PDL layer is displayed within the tooth arch model to provide the user with visual feedback.

In addition, the computer model of the tooth arch may also take into account the location of the jaw bone. The position of the jaw bone relative to the tooth arch may be generated based on the position of the roots and/or other parameters (e.g., X-ray, MRI, etc.). The computer simulated jaw bone may provide the user with visual reference of the jaw bone in relation to the root, such that as the user modifies the position of a particular tooth, the user may be able to predict the potential interaction between the root and the jaw bone. For example, excess compression of the root against a hard tissue (e.g., jaw bone) may lead to root resorption.

Moreover, methods for transmitting the digital representation of a patient's tooth arch are also disclosed herein. In one variation, the computer generated digital representation of the crowns are transmitted along with the corresponding digital representation of the roots, such that the receiving computer can display a tooth arch showing both the crowns and their corresponding roots. In another variation, parameters defining the root for each of the crowns within a tooth arch are transmitted along with the digital representation of the crown to a receiving computer. Software located on the receiving computer is then utilized to generate the root profile for display along with the crown, based on the parameters defining the roots. For example, root parameter may direct the software to extract and/or modify a predefined root profile from a digital library presiding on the receiving computer to generate the desired root and the associate such root with the appropriate crown.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a flow chart illustrating an example for digitizing a patient's tooth arch.

FIG. 2 illustrates an exemplified mechanical location device for acquiring the coordinates of the physical tooth models.

FIG. 3 illustrates an arch model component having registration features.

FIG. 4 is a top view of a scan plate mounted with a plurality of arch model components.

FIG. 5 is a side view of a scanning system including a scan plate mounted with a plurality of arch model components.

FIG. 6 is a block diagram illustrating an exemplary system for digitizing the tooth arch model components from a patient's tooth arch model.

FIG. 7A illustrates an example of a positive dental arch replica. In this example, each of the teeth within the dental arch replica is configured with an extension (i.e., a pair of pins) which serves as a reference marker for the corresponding crown portion of the tooth.

FIG. 7B illustrates a plate configured with receptacles for receiving the extensions for the teeth in the positive dental arch replica of FIG. 7A.

FIG. 7C shows a first group of individual tooth replica, which are separated from the positive dental arch replica of FIG. 7A, positioned on the plate of FIG. 7B, with their extensions inserted into corresponding receptacles. As shown in FIG. 7C, only every other position within the tooth arch is filled with a corresponding tooth replica.

FIG. 7D shows a second group of individual tooth replicas, which are complimentary to the first group, positioned on the plate of FIG. 7B, with their extensions inserted into corresponding receptacles. As shown in FIG. 7D, only every other position within the tooth arch is filled with a corresponding tooth replica.

FIGS. 8A and 8B illustrate an example for superimposing digital representations of partial tooth arches to generate a digital representation of a complete tooth arch. In this example, the digital representation of the first partial tooth arch is superimposed over the digital representation of the second partial tooth arch to form a digital representation of the complete tooth arch.

FIG. 9A illustrates an exemplary method for generating a digital dental arch model by scanning individual tooth replicas in groups, and then digitally constructing a dental arch which comprises individual tooth representations.

FIG. 9B illustrates another example of a method for generating a digital dental arch model.

FIG. 10A shows another example of a positive tooth arch replica of a patient's tooth arch. For illustration purposes, reference numerals are provided for each of the teeth within the tooth arch.

FIG. 10B illustrates one example of a scanning plate configured to receive the individual tooth replicas from the tooth arch shown in FIG. 10A. A matrix is provided with each of the teeth in the tooth arch reassigned to a specific location.

FIG. 10C shows the scanning plate of FIG. 10B with receptacles implemented within the matrix, such that each matrix position is configured with a receptacle for receiving the extension of the corresponding tooth, to secure the tooth in place.

FIG. 10D shows the individual tooth replicas from the positive dental arch replica of FIG. 10A separated from each other, and inserted into their corresponding positions on the scanning plate of FIG. 10C.

FIG. 11A illustrates an example of the graphical projection of the digital representation of a patient's tooth. In this particular example, the digital representation comprises the crown portion, without the root portion of the tooth.

FIG. 11B illustrates a simulated root being connected to its corresponding crown from FIG. 11A.

FIG. 11C illustrates an example of a typical incisor showing both the crown portion and the root portion.

FIG. 11D illustrates an example of a typical canine showing both the crown portion and the root portion.

FIG. 11E illustrates an example of a typical pre-molar showing both the crown portion and the root portion.

FIG. 11F illustrates an example of a typical molar showing both the crown portion and the root portion.

FIG. 12 illustrates an example of a graphical projection of a digital representation of a patient's upper and lower tooth arches. In this example, each of the teeth is represented by a crown portion and a corresponding root portion.

FIG. 13 illustrates the digital representation of the tooth arches shown with their corresponding gingival tissue overlaid on the teeth.

FIG. 14A is a flow chart illustrating an exemplary method of preparing and utilizing a digital representation of a tooth arch.

FIG. 14B is a flow chart illustrating another example of preparing and utilizing a digital representation of a tooth arch.

FIG. 15 illustrates an example of a user interface for displaying a digital representation of a patient's tooth arches. In this example, two windows are provided to display both the pre-modified tooth arch (shown in the left window) and the post-modified tooth arch (shown in the right window) in a side-by-side manner.

FIG. 16 is a cross-sectional view showing a typical example of a patient's tooth, where the root of the tooth is surrounded by a PDL and embedded within the jaw bone.

FIGS. 17A through 17J, illustrate an exemplary method to prepare a digital representation of a patient's tooth arch. In this example, a simulated root is generated for each of the corresponding teeth in the patient's tooth arch. One of ordinary skill in the art having the benefit of this disclosure would appreciate that, in one variation of the method, the root simulation step may be skipped, such that the digital representation of the tooth arch is utilized without the digitally simulated roots.

FIG. 17A illustrates the placement of a micro-scribe into a cavity within the negative impression of a patient's tooth arch to define an approximation of a root position for one of the tooth in the tooth arch.

FIG. 17B illustrates a cover plate with pins inserted into the holes on the cover plate. The positions of the pins relative to each other on the plate approximate the positions of the patient's roots relative to each other.

FIG. 17C illustrates the cover plate of FIG. 17B placed over the container of FIG. 17A, such that the pins are positioned within the cavity of the negative impression of the patient's tooth arch.

FIG. 17D illustrates a positive mold of the patient's tooth arch created from the apparatus shown in FIG. 17C.

FIG. 17E illustrates examples of individual teeth models that are separated from the positive mold of FIG. 17D.

FIG. 17F illustrates an example, where a positive model of a tooth selected from FIG. 17E being positioned on a based plate for scanning. The canner is configured to digitize the crown portion of the tooth by capturing three-dimensional profile of the crown portion of the tooth.

FIG. 17G illustrates graphical projections of the digital representations of the patient's individual teeth that are derived from the scanning step of FIG. 17F.

FIG. 17H-1a illustrates a digital representation of a patient's tooth arch, which is generated from the digital representation of the individual teeth shown in FIG. 17G.

FIG. 17H-1b illustrates a digital representation of a patient's tooth arch with simulated root portion of the tooth being created for each of the corresponding crown portion of the teeth.

FIG. 17H-2a illustrates roots being created for the individual crown section of the teeth shown in FIG. 17G.

FIG. 17H-2b illustrates a digital representation of a patient's tooth arch, which is generated from the digital representation of individual teeth shown in FIG. 17H-2a. As shown in FIG. 17H-2b, this digital representation of a patient's tooth arch comprises roots that extend from the crown portions of the teeth.

FIG. 17I is the digital representation of a patient's tooth arch from either FIG. 17H-1b or FIG. 17H-2b, with one of the tooth being modified in position relative to the rest of the teeth. In this particular drawing, the modified tooth is shaded for emphasis.

FIG. 17J-1a illustrates a digital representation of a removable alignment appliance, which is created based on the digital representation of the patient's tooth arch from FIG. 171.

FIG. 17J-1b illustrates a removable alignment (i.e., physical product), which is created based on the digital representation of the removable alignment appliance of FIG. 17J-1a.

FIG. 17J-2a illustrates a base plate configured to receive the physical model of individual teeth of FIG. 17E. The individual tooth models, when inserted into the base plate, form a physical tooth arch that corresponds to the digital tooth arch shown in FIG. 17I. The holes on the base plate are drilled into the plate according to the projected pin positions from the digital representation of the tooth arch of FIG. 17I.

FIG. 17J-2b illustrates a physical model of a modified tooth arch that corresponds to the modified digital tooth arch of FIG. 17I. The physical model of the tooth arch comprises the base plate of FIG. 17J-2a with the physical models of individual teeth of FIG. 17E inserted therein.

FIG. 17J-2c illustrates a polymeric sheet being placed over the physical model of the modified tooth arch, shown in FIG. 17J-2b, for the fabrication of a removable aligner.

FIG. 17J-2d illustrates the removable aligner formed from the set-up shown in FIG. 17J-2c. The polymeric sheet is suctioned onto the physical model of the tooth arch and heat-formed to create the removable aligner.

FIG. 17J-2e illustrates a removable aligner configured from the heat-formed polymeric sheet of FIG. 17J-2d by trimming excess materials off the edges of the heat-formed polymeric sheet.

FIG. 18 illustrates a digital scan of a complete tooth arch superimposed over a digital tooth generated from combining digital representation of individual teeth.

FIG. 19A illustrates a base place configured for receiving multiple sets of tooth models for forming three separate arches.

FIG. 19B shows the based plate of FIG. 19A inserted with a plurality of individual tooth models. For separate arches are formed on the surface of the base plate.

FIG. 20 illustrates the individual teeth from the positive dental arch replica of FIG. 17D being separated to form individual tooth replicas.

FIG. 21 illustrates an example of a plate configured for receiving the individual tooth replicas for scanning.

FIG. 22 illustrates an example where the scanning plate is configured with receptacle that are indented from the reference plane of the scanning plate, such that the tooth replica can be received and oriented at an angle representative of the position/orientation of the tooth within the dental arch. In this example, the tooth replica is configured with a crown portion and a base portion. Two pins, which serve as extension (i.e., reference marker) extends from the base portion.

FIG. 23 is a flow chart showing an example of a method for registering a subject's upper arch model and lower arch model in accordance with the present invention.

FIG. 24 is a side view of an arch model mounted on a fixture suitable for scanning.

FIG. 25 is a top view of an arch model mounted on a fixture suitable for scanning.

FIG. 26 is a side view of a system that is capable of registering an upper arch model and a lower arch model.

FIG. 27 shows some of the predefined views that may be configured as ‘buttons’ or icons on a user interface, as described herein.

FIG. 28A illustrates display option icons as described herein.

FIGS. 28B-28D show the effect of showing or hiding various portions of the digital dental arch using various display icons that may be included as part of a user interface.

FIG. 29 illustrates a “treatment” control region which may be included as part of a user interface as described herein.

FIG. 30 illustrates a user interface configured to allow a user to select and move individual teeth in a digital dental arch model.

### DESCRIPTION OF INVENTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

Before describing the present invention, it is to be understood that unless otherwise indicated this invention need not be limited to applications in orthodontic treatments. As one of ordinary skill in the art having the benefit of this disclosure would appreciate, variations of the invention may be utilized in various other dental applications, such as fabrication and/or treatment planning for dental crown, dental bridge, and aligner. The computer model of the tooth arch may also be modified to support research and/or teaching applications. Moreover, it should be understood that variations of the present invention may be applied in combination with various dental diagnostic and treatment devices to improve the condition of a patient's teeth.

It must also be noted that, as used in this specification and the appended claims, the singular forms “a,” “an” and “the” include plural referents unless the context clearly indicates otherwise. Thus, for example, the term “a tooth” is intended to mean a single tooth or a combination of teeth, “a fluid” is intended to mean one or more fluids, or a mixture thereof. Furthermore, as used herein, generating a digital representation comprises the process of utilizing computer calculation to create a numeric representation of an object, unless the context clearly indicates otherwise. A digital model may be a computer-manipulatable model. For example, the digital representation may comprise a file saved on a computer, wherein the file includes data that represent a three-dimensional projection of a tooth arch. In another variation, the digital representation comprises a data set including parameters that can be utilized by a computer program to recreate a digital model of the desired object.

As described herein, a digital dental arch model may include a digital representation of any or all of the subject's dental arch, including the subject's upper, lower teeth, palate, gingiva, etc. The digital dental arch model (or “digital model”) may include any information about the dental arch, including structural information such as how the teeth relate to each other spatially. In some variations, the dental arch model may include qualitative information about the hardness of the teeth, the health of the teeth or gingiva, etc.

For example, the digital dental arch model may include information about the occlusion of a subject's upper and lower arches. As used herein, the term “occlusion” generally refers to the alignment between the teeth of the upper arch and the lower arch when the jaws are brought together during biting. Thus, the systems, methods and devices described herein may be used to create accurate models of a subject's dental arches during occlusion, and may include at least a portion of a subject's upper arch and lower arch, and reflect the alignment between the upper and lower arches when the subject is biting.

A digital dental arch model is may be generated by any appropriate manner to accurately reflect a subject's dental arch. Examples of the different ways of forming a digital dental arch model are described herein. For example, the dental arch model may be created by digitally scanning either a subject dental arch directly, or by digitally scanning a negative or positive model of all or a part of a subject's dental arch. Generating a digital dental arch model in any of these ways is typically referred to as “digitizing” the dental arch. The various methods and techniques for scanning and digitizing a subject's teeth are described below. Different methods for scanning may provide different befits and may be used in combinations with other digitization techniques, as will be apparent to one of skill in the art. Once the dental arch has been digitized, it may be digitally represented in various ways, and manipulated by one or more practitioners.

A first general method for digitizing a subject's dental arch is described below. This first method uses a physical model of the subject's teeth (e.g., a positive or negative model). The model is broken into pieces which are then scanned on a scanning plate, allowing simultaneous and rapid scanning. The digitized pieces are then reassembled into a digital model of the dental arch. Variations of this scanning method are also described below.

Digitizing a Dental Arch

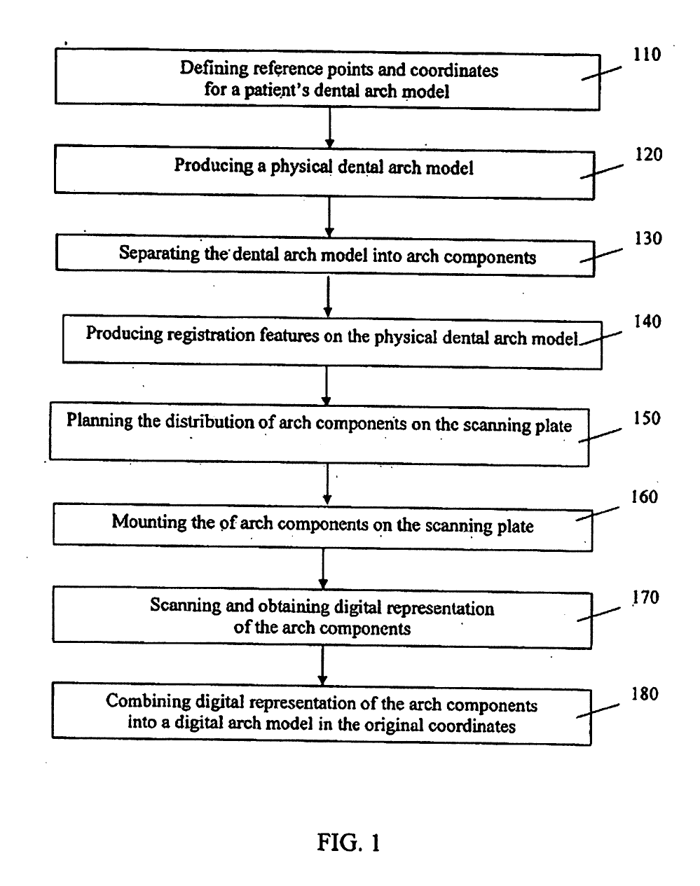

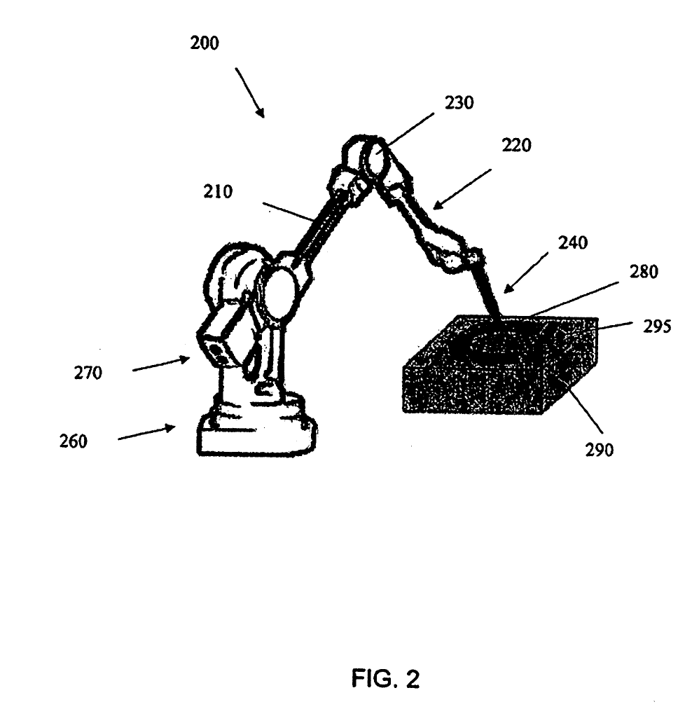

FIG. 1 illustrates one process for digitizing a patient's arch. In this process, reference points and coordinates are first determined for a patient's dental arch model in step 110. Any appropriate method of determining coordinates may be used. For example, as shown in FIG. 2, a negative impression 280 of a patient's arch can be obtained first. The negative dental impression 280 can be fixed in a container 290 using an epoxy. The container 290 can be marked by one ore more reference marks 295 that can define the coordinates of the impression 280. Relative positions of the patient teeth are then measured off the impression using a mechanical location device 200. An example of a mechanical location device is a microscribe, available from Immersion and Phantom. Any appropriate 3D digitizer that can be utilized to develop a digital computer model for an existing 3D object may also be implemented.

In the example shown in FIG. 2, the mechanical location device 200 includes mechanical arms 210, 220 having one or more mechanical joints 230. The mechanical joint 230 is equipped with precision bearings for smooth manipulation and internal digital optical sensors for decoding the motion and rotation of the mechanical arms 210, 220. The end segment is a stylus 240 that can be manipulated to touch surfaces on the dental impression 280 held in the container 290. The mechanical location device 200 may be fixed to a platform that is common to the container 290.

Accurate 3D positional and angular information of the points that the stylus touches can be decoded and output at the electronic output port 270. The positional and orientational information can be obtained by an additional decoder for self-rotation of the stylus. Additional sensors may be placed at the tip of the stylus to measure the hardness of the surface of the measurement object. Immersion Corp.'s MicroScribe® uses a pointed stylus attached to a CMM-type device to produce an accuracy of 0.009 inches.

In measuring the teeth positions from the impression of the patient's teeth, a digitizer such as the MicroScribe can be mounted on a fixture fixed to a base plate. The device can communicate with a host computer via USB, serial port, or other computer connections. The user then selects points of interest at each tooth positions in the impression and places the stylus at the point of interest. Positional and angular information are decoded and then transmitted to the computer. The coordinates (e.g., Cartesian XYZ, etc.) of the acquired points are then calculated and logged for each first feature location and orientation (or alternatively each tooth).

A new coordinate system may also be established based on the container chamber in which the arch impression is held. In one variation, the user establishes this system by taking readings for two points on two sides of the container to define the x-axis. Another reading on the plane establishes the x-y plane. An origin is then determined on the x-y plane. The z-axis will be established by taking the cross product of the x-axis and y-axis.

The user next selects a plurality of points on the surfaces of the arch impression corresponding to each tooth. The 3D points measured from the impression surfaces can be interpolated to create surfaces and solids integrated into an overall design.

Pin readings can then be taken. Pins may be fiduciary components, such as actual physical “pins” that are inserted into the base of a positive or digital tooth model. Pins may be placed to represent the roots, or so that they do not interfere with movement or manipulation of the teeth. Pins may also help coordinate different models (e.g., digital models) of the same teeth, as well multiple scans of the dental arch are compared and combined. A pin reading may be made using this preliminary digital model from the digitizer. For each tooth, a reading may be taken that determines the center of two pins, and their orientation vector. Two or more points are determined from this preliminary digital model (or from the physical model using the digitizer) that will provide the direction to move from the center point to find the location of the pins, and finally the dimensions and positions of two pins will be calculated using these values, and the pins can be visually rendered in the software. In one variation, the system allows the user to fine-tune these readings as required.

After acquiring the readings for pins corresponding to portions of the digital arch (e.g., teeth), the first feature locations and orientations are saved, and can be further fine tuned and visualized. First feature locations may be any of the features measured from the dental arch (e.g., the negative dental arch model described in FIG. 2). First features may also act as fiduciary markers. For example the digital dental arch model identified by the mechanical location device shown in FIG. 2 may be a “rough” model that includes measured fiduciary markers (e.g., shapes of the teeth, etc.) or defined fiduciary markers (e.g., pins, marks, etc.). A digital dental arch model can include a plurality of digital tooth models. Each model may be refined by combining one or more of the digital models, using the fiduciary marks (e.g., feature locations) to orient and combine them. The digital dental arch model can be developed based on the first feature locations and orientations, or alternatively the coordinates of the physical tooth models acquired by the mechanical location device. As with any digital dental arch model, the data can be exported data can be used to control CNC-based drilling and milling.

For this first-pass digital model (the model based on the mechanical location device), the number of points defining the curves and number of curves depends on the desired resolution in the model. Surfacing functions offered by the design application may be used to create and blend the model surfaces. The model may be shaded or rendered, defined as a solid or animated depending on the designer's intentions. The teeth may be labeled so the order of the physical tooth models can properly be defined for the physical dental arch model. All the readings acquired by the stylus can be rendered in real time to allow the user to visualize the digital tooth models. The coordinate axes and points can be rendered in the software using different colored cylinders/spheres etc. so as to distinguish the different meanings of values.

Depending on the precision that the mechanical sampling of the negative impression is taken, this type of digital tooth model (digital dental arch model) may form an adequate digital arch model, or it may serve as a first-pass dental arch model. For example, it may serve only to provide a somewhat lower resolution model of the dental arch (or a portion of the dental arch) providing a reference for use when forming a digital arch model by other techniques or by a higher-resolution mechanical sampling. Thus, the digital dental arch model may be assembled in iteratively, or in parts. For example, in FIG. 1, the first-pass digital dental arch model may serve (as step 110) to define reference points and coordinates for portions of the subject's dental arch.

A digital dental arch model may also be made from a positive mold of the teeth. For example, the negative impression 280 in the container 290 can be filled with malleable casting material, which after solidification forms a physical arch model of the patient's arch (step 120). The one ore more reference marks 295 are simultaneously molded on the physical arch model such that the surface points on the physical arch model can be accurately translated back to the original coordinates for the negative arch impression. Details of molding dental arch models are disclosed in the above referenced and commonly assigned U.S. patent application Ser. No. 11/013,160, titled “System and methods for casting physical tooth model” by Huafeng Wen, filed Dec. 14, 2004 and U.S. patent application Ser. No. 10/979,823, titled “Method and apparatus for manufacturing and constructing a physical dental arch model” by Huafeng Wen, filed Nov. 2, 2004, the disclosures of which are incorporated herein by reference in their entirety.

Referring back to FIG. 1, the physical dental arch model is then separated into a plurality of arch model components 300 in step 130. The arch model can include the upper arch, the lower arch (the jaw), a segment of an upper or lower arch comprising one or more teeth, or a fraction of a tooth. In one variation, the arch model components 300 are cut vertically, such that registration features 310 in the base portion 320 can be vertically mounted to a scan plate 520 as shown in FIG. 5 and discussed further below. The vertical mounting of the arch model components may 510 allows them to be scanned relatively uniformly around their longitudinal axis along the length of the tooth, which may be beneficial for constructing uniform surfaces in the digital representation of the arch model components.

In one variation, the criteria for separating the arch model into arch model components ensure that each arch model component can be easily scanned by one or more image capture devices as described below. In another variation, the arch model components are cut to a substantially convex shape such that the surfaces of the arch model component can be captured by an image capture device without being obstructed by another part of the same arch model component. In general, any appropriate method of cutting and/or separating the physical dental arch model so that it can be readily scanned (as by an optical scanning method) may be used.

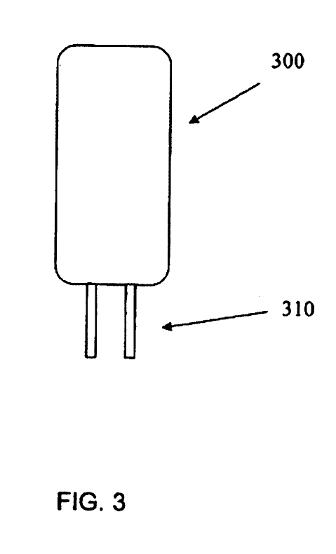

Registration features may also be produced on or in the arch model components, such as described in step 140 of FIG. 1. As mentioned above, a registration feature (e.g., a fiduciary feature) may simply be the unique shape of a region of the dental arch component (e.g., the crown of the tooth, etc.) or an additional registration feature may be added (e.g., a pin, a marking, etc.). FIG. 3 shows a conceptualization of an arch model component 300 that is separated from the arch model. The arch model component 300 includes registration features 310 (shown as pins) that are adapted to be attached to the receiving features in the scan plate as described below. The registration features 310 can include pins, protrusions, slots, holes, etc., and may preferentially be structures that are complimentary to the receiving features on the receiving features in the scan plate as described below. Alternatively, the registration features 310 can be produced in the arch model before the arch model is separated into arch model components 300. Details of obtaining a physical dental arch model having registration features and 3D reference positions are disclosed in above referenced U.S. patent application Ser. No. 11/013,159, titled “Producing a base for accurately receiving dental tooth models” by Huafeng Wen, filed Dec. 14, 2004, the content of which is incorporated herein by reference in its entirety.

The components of the arch model may then be scanned. Scanning may be optical scanning. Scanning the physical model of the dental arch model in this fashion may allow rapid scanning at high resolution, without missing region of the dental arch model that might otherwise be blocked if an intact physical arch model were to be scanned. Thus, by cutting the physical dental arch model into components, and scanning the components either individually or en masse (or large groupings), accurate digital models of the components can be made and then assembled into a digital dental arch model that may be readily manipulated.

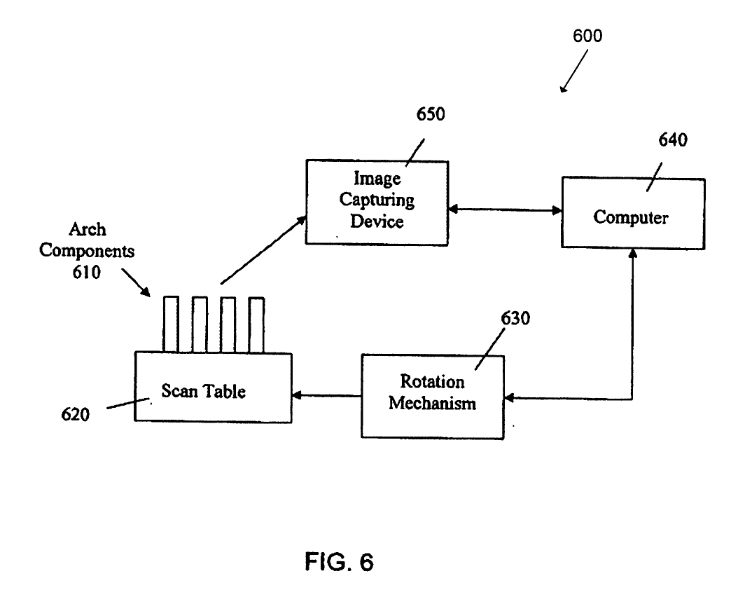

In one example, the arch model components are digitized by a scanning system 600 as shown in FIG. 6. The scanning system 600 includes a scan table 620 on which one or more arch model components 610 can be mounted. The scan table 620 can be rotated by a rotation mechanism 630 under the control of a computer 640. The rotation mechanism 630 can include a motor and a gear transport mechanism that is coupled to the scan plate 620. As the scan table is turned to an angular position, an image capture device 650 captures an image of the arch model components 610. The image capture device 650 can be a digital camera, and a digital video camera, laser scanner, other optical scanners, etc. There can also be provided a plurality of image capture devices. The throughput and accuracy may increase with the number of the image capture devices.

The optical axis of the image capture device can be, for example, 45 degrees off of the vertical axis (or the top surface of the scan table). As described above, in one variation the arch model components 610 that are cut from the physical arch model have elongated shapes that can be mounted vertically over the scan table. As the scan plate 620 is rotated by the rotation mechanism 630, the vertically mounted arch model components 610 can be scanned (i.e., image captured) at relatively uniform angle.

In one variation, the individual tooth arch model components 610 are placed on the scan table all at one time, and scanned in parallel (or in few groups of multiple components). A plurality of individual tooth arch model components 610 may be placed onto a single scan table and scanned together.

When multiple tooth arch model components are packed (or placed) onto a scan plate 620 and scanned together, the plurality of tooth arch model components may be arranged so that each of the components can be scanned by the scanner. Thus the distribution of the arch model components 610 on the scan plate may be predetermined prior to the placement of the arch model components on the scan plate (e.g., step 150) to improve the accuracy image scanning and improve throughput of the system. Various considerations and method implementing these considerations are described below.

In general, the scanning throughput is increased with increased packing density on the scan plate. On the other hand, higher packing density may decreases the distance between the arch model components, which may cause the adjacent arch model components to block each other in image captures. The desired packing density and distribution pattern for placement of the tooth arch components on the scan plate may be determined by appropriately arranging the scanning plate, arch components and image capture device (e.g., camera). For example, in one variation, larger arch components may be placed towards the center (e.g., center of rotation) of the scanning plate), while smaller components are placed towards the edge. Furthermore, the components may be spaced on the plate so that the outer components have more space separating them from each other than the components located more towards the center (“hub”) of rotation of the plate.

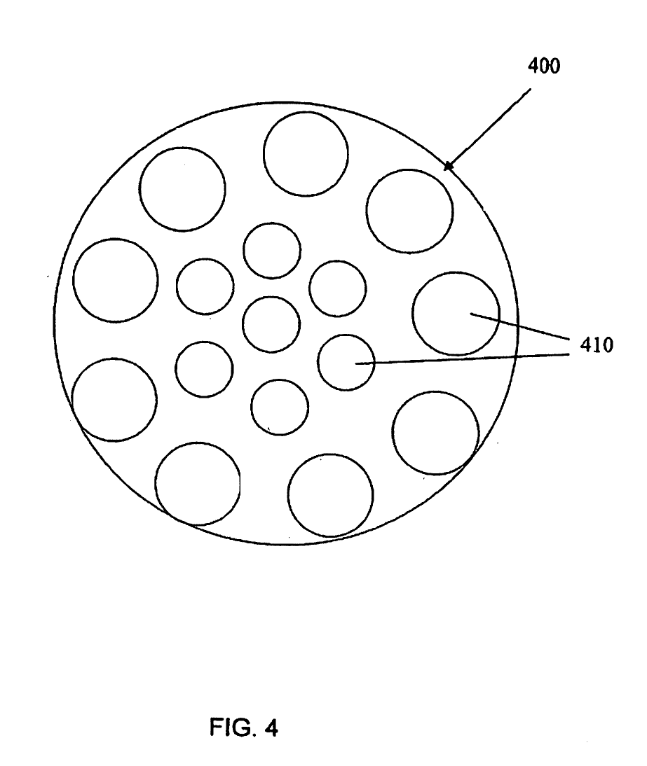

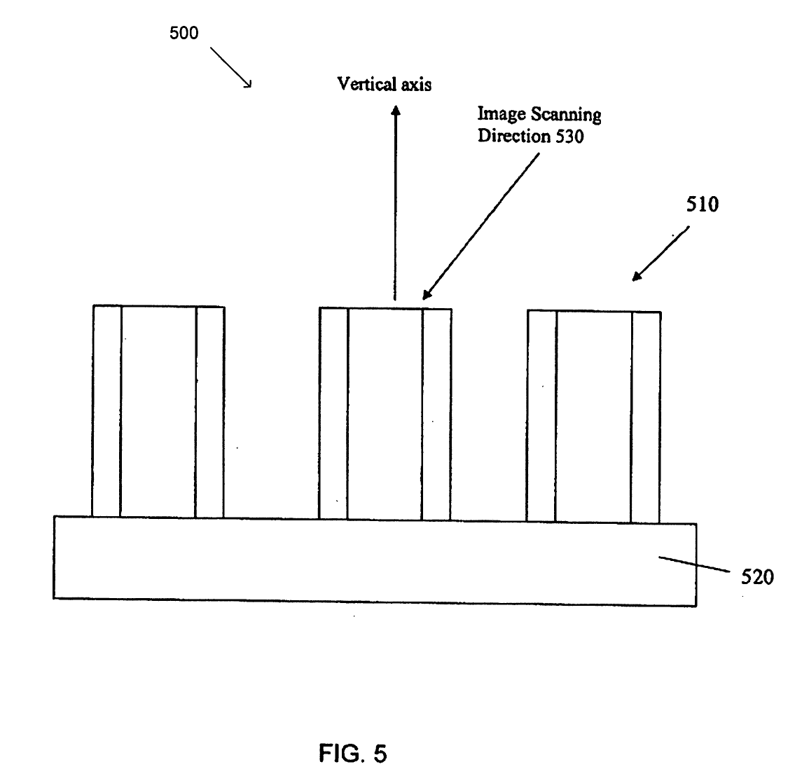

FIG. 4 illustrates the top view of another variation showing an arrangement of arch model components 410 over scan plate 400. In this variation, the larger components are located radially, and the smaller components more towards the hub of the scan plate. The arch model components 410 can have different sizes and shapes. For example, in FIG. 4, the small circles may be 10 mm in diameter and represent small teeth (e.g., lower incisors, canines, etc.) or tooth components. Large circles may be 15 mm in diameter, and may represent larger teeth (e.g. upper central incisors, molars, etc.) or larger tooth components. The arch components are placed at lease 5 mm apart from each other and almost equal height to avoid overlap. The scan plate 400 may be 150 mm in diameter. The scanning volume can be an extruded octane or a cylinder 20 mm in height. The packing efficiency of the arch model components 410 is determined by the sizes, the height, the shapes and the distribution of the arch model components 410. In some variations, the arch model components are not distributed uniformly over the scan plate, but are staggered so that rotating the scan plate provides a maximum exposure of the components on the scan plate.

FIG. 5 shows a side view of a scanning platform 500. The arch model components 510 are substantially vertically mounted over the scan plate 520. The image scanning (i.e. capture) direction 530 of oblique to the arch model components 510 such that the top and side surfaces of the arch model components 510 can be captured at different angles as the scan plate 520 is rotated. For example, the image scanning direction 530 can be 45 degree off the vertical axis. The scan plate 520 can be mounted to a goniometer and a translation stage, which can provide up to 6 axes for 6 degree of freedom movements.

In one arrangement, each arch model component is projected along the image capture direction (e.g. 45 degrees of vertical axis of the scan plate 400) around its axis to produce a shadow around the arch model component. In one variation, the arch model components can be distributed such that there are no overlaps between the shadow areas of the adjacent arch model components. The distributions of the arch model components 410 can be varied to ensure that there is no obstruction of views between adjacent arch model components. The distributions can be iterated to maximize the packing density.

In one variation, a model is prepared to simulate the shadow cast by the objects on the plate when the objects are being scanned in the designated scanning directions. One or more scanner may be implemented. The projection of the scanner may be direction to same over lapping region. The position of the object may then be adjusted, such that all the shadows are close to each other, but without overlaps. This configuration may then be utilized for scanning of the toot arch components. This model for determining a desired scanning configuration may be performed with either a physical model or a computer model.

In another arrangement, for each distribution of arch model components as shown in FIG. 4, the image scanning direction can be optimized. For example, a patient's arch model can be separated into 20 arch model components. The position of the 20 arch model components can be first simulated on a scan plate. The image scanning direction 530 can be varied to optimize the quality of the image capture. This simulation can be performed via computer simulation, for example.

In another variation, the operator creates each individual shadow projection based on one scanning direction. The articles/objects on the scan plate are arranged to ensure all the shadows are close to each other without overlap. Then, based on the plate design for all of the scanning directions, the final plate design can be determined. A computer may be used to calculate a configuration for distributing the objects on the plate for scanning, such that each of the individual tooth arch components can be scanned in the process. Each scanning direction's shadow collision can be calculated separately, and the final readjustment may be determined through several iterations of calculation to minimize interference.

In yet another arrangement, the shadows of the adjacent arch model components are allowed to overlap to certain extent, which means that certain surface areas on the arch model components are blocked from image scanning at certain directions. It is configured such that the overlap does not block a significant angular span of each surface area of an arch model component. This assures that the surface area blocked at certain direction can be scanned at other similar directions.

In another variation, individual shadow maps are projected based on two or more scanning directions. Shadows from each scan direction may be colored coded to determine which area the scanner is able to scan from a given scanning direction. The combined data for the shadow cast from all directions are mapped. The distribution of the objects on the scan plate can be adjusted to ensure that the combined shadow map shows the shadows close to each other with minimal or no overlaps. The color coded shadows may be utilized to associate problems with specific scanning direction. In one configuration, shadow maps are close to each other with no overlaps that show color loss, such that all the area can allow shadow overlaps, but there is no shadow color overlap. In another variation, the objects are positioned such that any area on the scan article is seen at least once by the scanner at a certain scan angle.

After the positions of the arch model components are optimized, the arch model components 510 may be actually positioned and/or mounted on the scan plate 520 in step 160. The images of the arch model components 510 are captured or scanned at different directions in step 170 as the scan plate is rotated. The coordinates of a plurality of surface points on the arch model components are computed by triangulation using the captured image data. The surfaces of the arch model components are constructed by interpolating computed coordinates of the points on the surface. Since the registration features of the arch component models and the receiving features of the scan plate are precisely known and inter-translatable, the coordinates of the surfaces of the arch model components can be translated to the original coordinates of the reference marks in the container 290 (e.g., casting chamber).

The registration features 310 and the receiving features on the scan plate 520 can together define the relative positions of the arch model components 300. The positions of the registration features 310 on each arch model component 300 are precisely defined. The receiving features are also produced at precise locations on the scan table 520. The captured image data can be interpreted to define the relative positions of the arch model components 510 relative to the receiving features on the scan plate 520. Thus, the coordinates of the arch model components 510 can be transformed into the original coordinates defined by the reference marks 295 for the impression of the patient's arch. As described above, any appropriate reference mark may be used (e.g., pins, etc.).

Once the surfaces of all arch model components are translated into the original coordinates, the digital representations of the arch model components can be combined into a digital arch model.

A digital arch model obtained in this way can be used as input data to produce a physical arch model, for example, using CNC based manufacturing, such as milling, stereo lithography, laser machining, molding, and casting. Additionally, digital arch models can be manipulated and modeled to simulate the teeth positions at each step of an orthodontic treatment of a patient's teeth. Furthermore, interference between adjacent tooth models can be prevented by simulation of teeth movement ahead of time. Details of these techniques are disclosed in the commonly assigned and above-referenced US patent applications, the disclosures of which are incorporated herein by reference in their entirety.

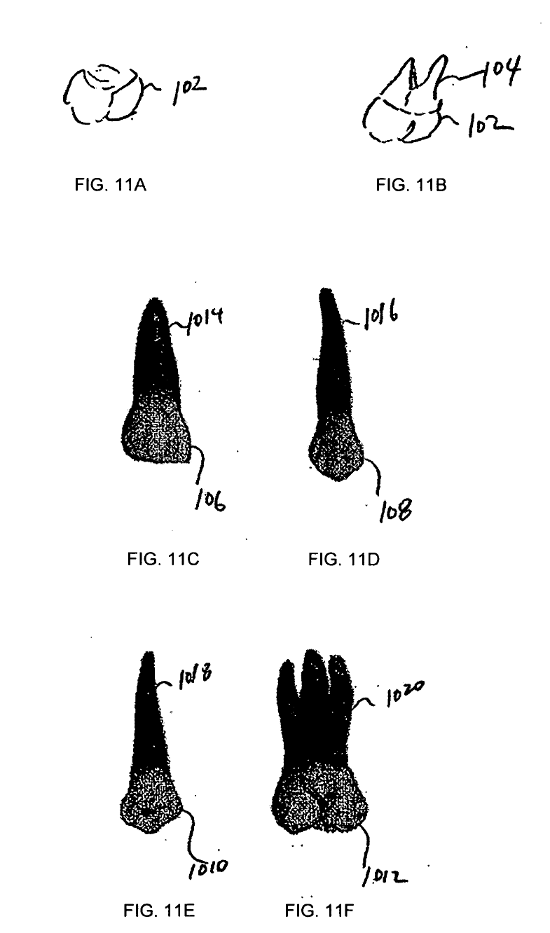

Any appropriate method may be used to scan and digitize all or a portion of the subjects dental arch. As described above, a positive mold for the patient's tooth arch may be created from a negative impression of the tooth arch. The teeth can then segmented into individual units. Each tooth can be scanned to digitize at least the crown portion 102 of the tooth, as shown in FIG. 11A. The tooth may be digitized by various three-dimensional scanning techniques as described above, including (but not limited to) laser scanning, optical scanning, destructive scanning, CT scanning and sound wave scanning. The scanning process may also capture the profile of a section of the gingival tissue.

In one variation, either a negative impression or a positive mold of the patient's tooth arch is scanned to generate a digital representation of a patient's tooth arch. The digital representation of the tooth arch comprises the crown portion of each of the teeth in the tooth arch. The digital dental arch model is subsequently smoothened and segmented into individual teeth, which are digital representations of the crown portion of the individual teeth.

In yet another variation, intraoral 3-D imaging device, such as OraScanner® manufactured by OraMetrix®, is utilized to digitize the patient's tooth arch. The digital dental arch model is subsequently segmented into individual teeth, which comprises digital representations of the crown portion of the individual teeth. In one application, the scanning of the patient's teeth is conducted at the dentist's office. The data generated from scanning, i.e., the digital representation of the patient's arch, is then transmitted over a computer network to a receiving computer for further processing.

Digitization Examples

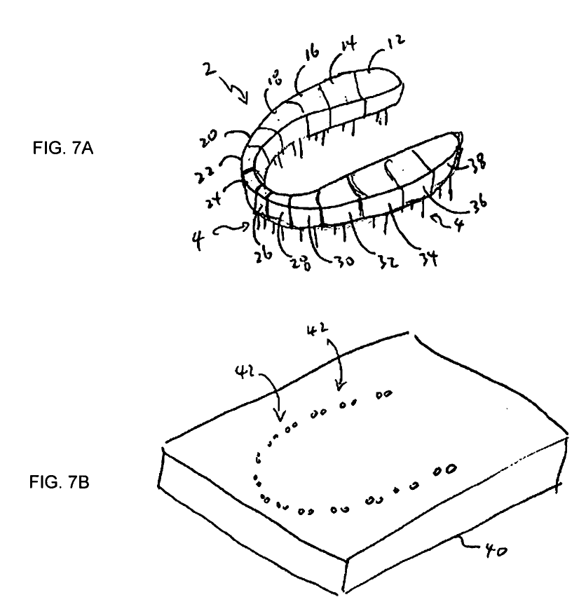

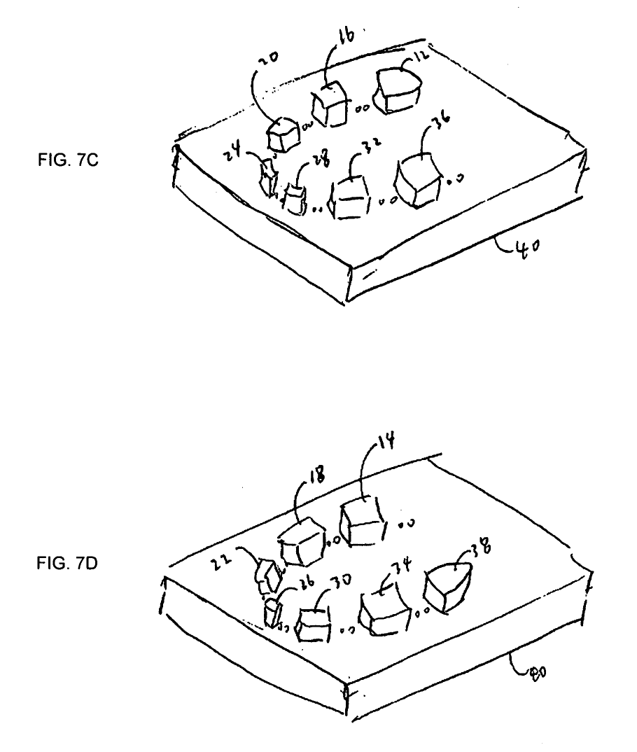

Referring to FIG. 7A, a positive dental arch model 2 is created based on a negative dental arch mold (not shown). Extensions 4 may be provided for each of the teeth 12, 14, 16, 18, 20, 22, 24, 26, 28, 30, 32, 34, 36, 38 in the positive dental arch model 2. The extension 4 may be configured such that by identifying the position/orientation of the extension within a three dimensional space would allow one to determined the position/orientation of the crown portion of the corresponding tooth. In the example shown in FIG. 7A-D, each extension 4 comprises a pair of pins. In one variation, each of the teeth within the positive dental arch 2 is configured with an extension which corresponds to the positions/orientation of the root of the tooth in relation to the corresponding crown portion of the tooth.

The positive dental arch model 2 is then separated into individual tooth replicas. A plate 40 is prepared with receptacles 42 to receive the extensions 4 of on the tooth replicas such that the tooth replicas can be arranged on the plate for scanning. In one variation the receptacles 42 are arranged in the form of an arch such that when the all the tooth replicas are inserted on the plate, a complete tooth arch is formed.

For the purposes of scanning, the user can insert a first group of tooth replicas 12, 16, 20, 24, 28, 32, 36 on the plate 40 where every other teeth position is filled, as shown in FIG. 7C. A scanner (e.g., laser, optical, MRI, CT, etc.) is then utilized to scan the tooth replicas 12, 16, 20, 24, 28, 32, 36 on the plate. By leaving the adjacent teeth position open for the teeth to be scanned, the scanner is able to capture at least a portion of the side profile of each tooth, which would have been covered/obstructed by the adjacent teeth if the adjacent teeth are in place. A digital representation of a partial dental arch can then be generated by a computer based on the data collected from scanning. The computer may register the partial dental arch as a collection of digital representation of individual tooth replicas that are scanned in the process. The computer may also record information regarding the relative position between the teeth in each group scan.

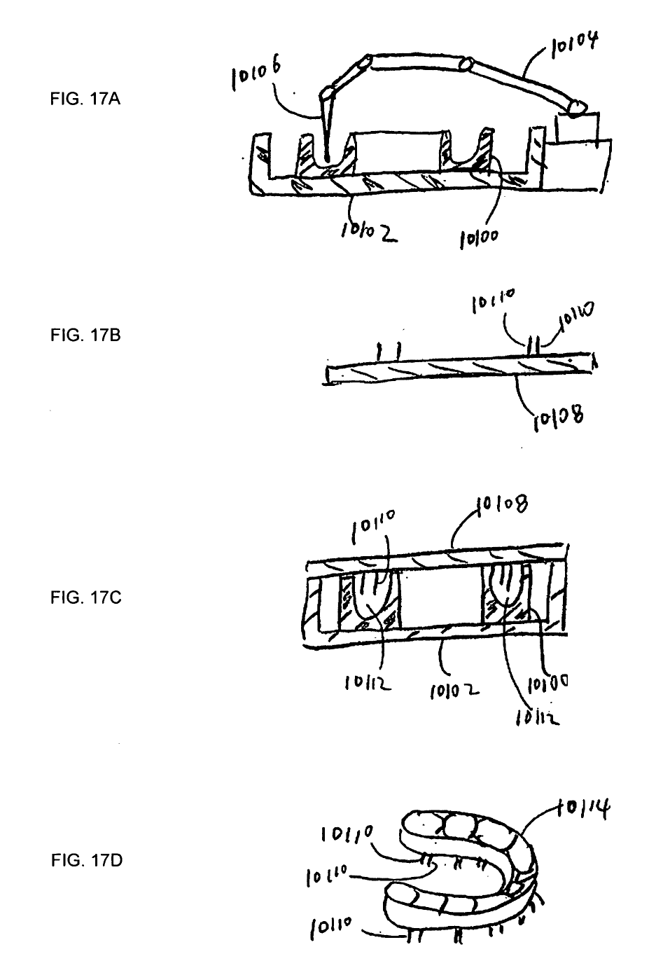

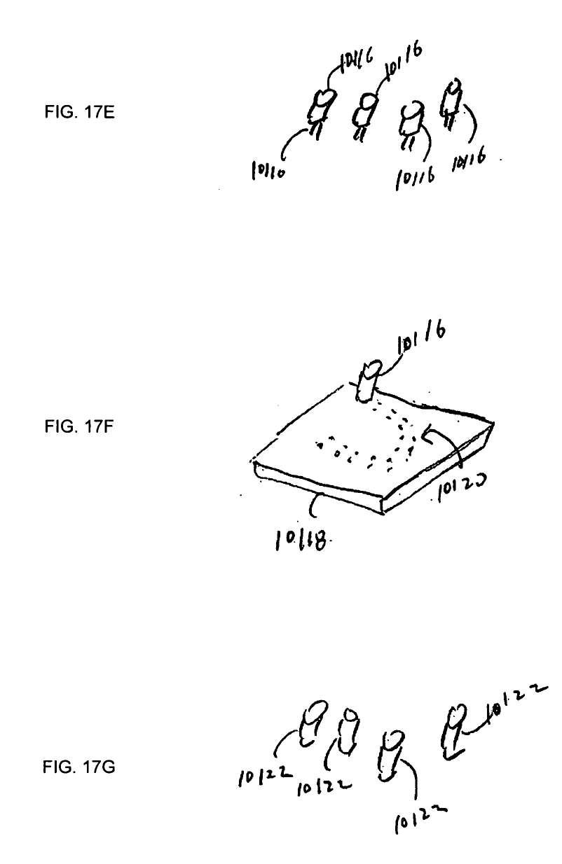

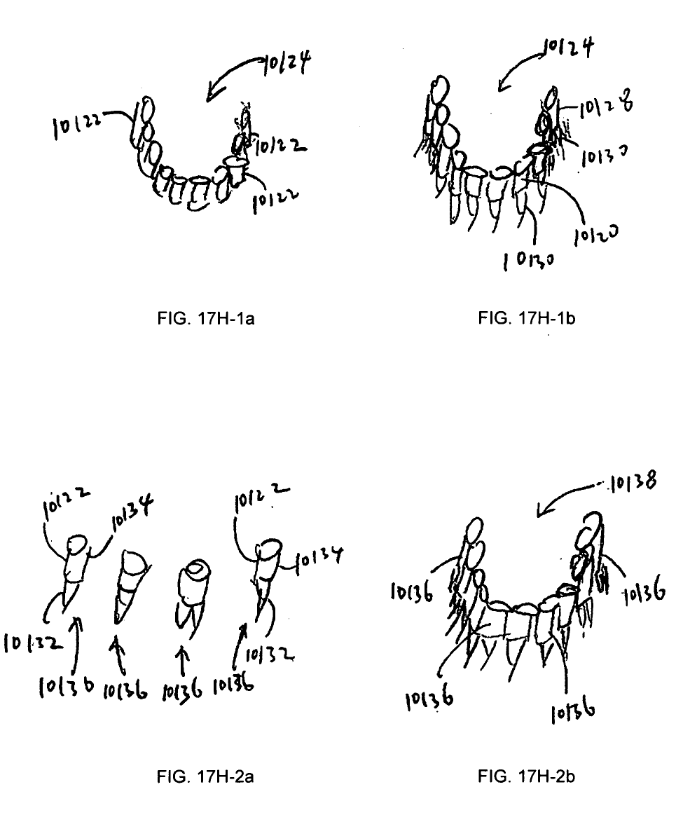

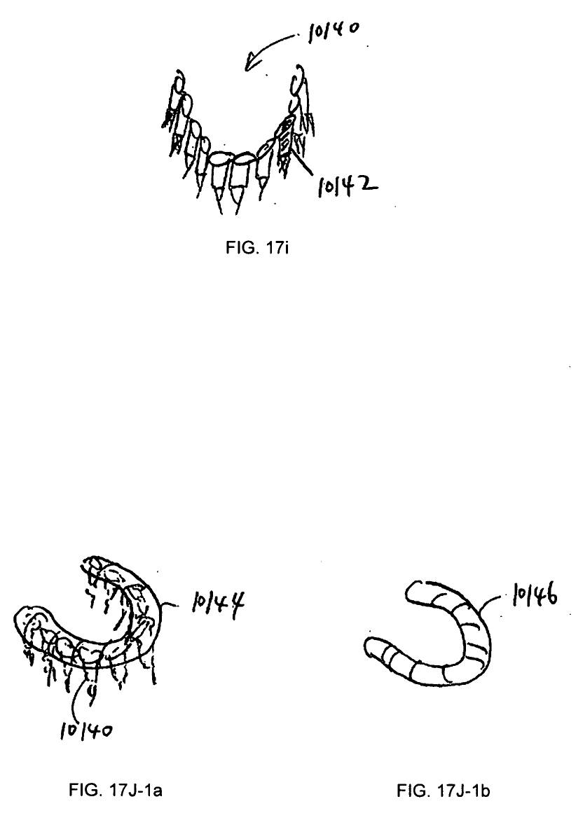

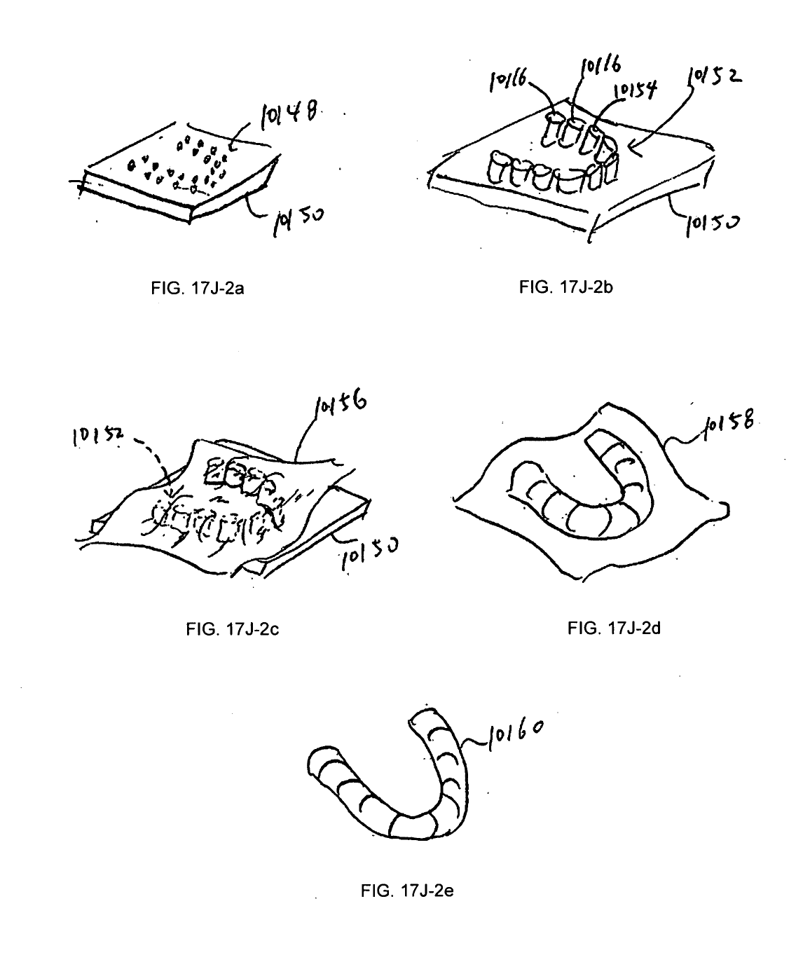

Once the scanning for the first group of tooth replica is completed, the tooth replicas 12, 16, 20, 24, 28, 32, 36 are removed from the plate, and a second group of complimentary tooth replicas 14, 18, 22, 26, 30, 34, 38 are placed onto the plate 40 as shown in FIG. 17D. Again, only every other teeth position is filled. The scanner is then utilized to scan the second group of tooth replicas 14, 18, 22, 26, 30, 34, 38, and the computer is implemented to calculate the digital representation of a partial tooth arch.

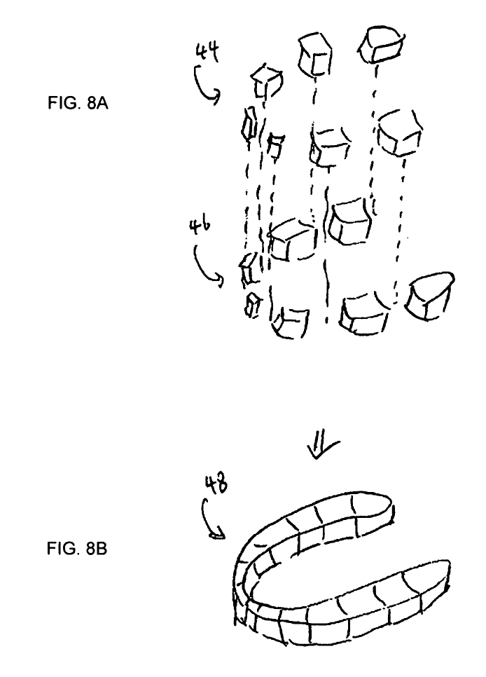

The digital representation of the first group of teeth 44 and the digital representation of the second group of teeth 46 are then combined to form a digital representation of the complete tooth arch 48, as shown in FIG. 8A. The digital representation 44 generated from scanning of the first group of tooth replicas 12, 16, 20, 24, 28, 32, 36 includes information which forms a partial tooth arch with information regarding every other tooth missing. The digital representation 46 generated from scanning of the second group of tooth replicas 14, 18, 22, 26, 30, 34, 38 includes information representing a partial tooth arch that is complementary to the partial tooth arch from the first scan. By combining data generated from the two separate scan, a digital representation of the complete tooth arch, which includes information on the side profile of each of the tooth, can be determined.

In one variation, the scanner is configured to scan completely around the crown of each of the tooth replicas in the tooth arch, such that the digital representation of resulting tooth arch include surface profile of the on both side of the tooth that are covered by the adjacent tooth when positioned within the tooth arch.

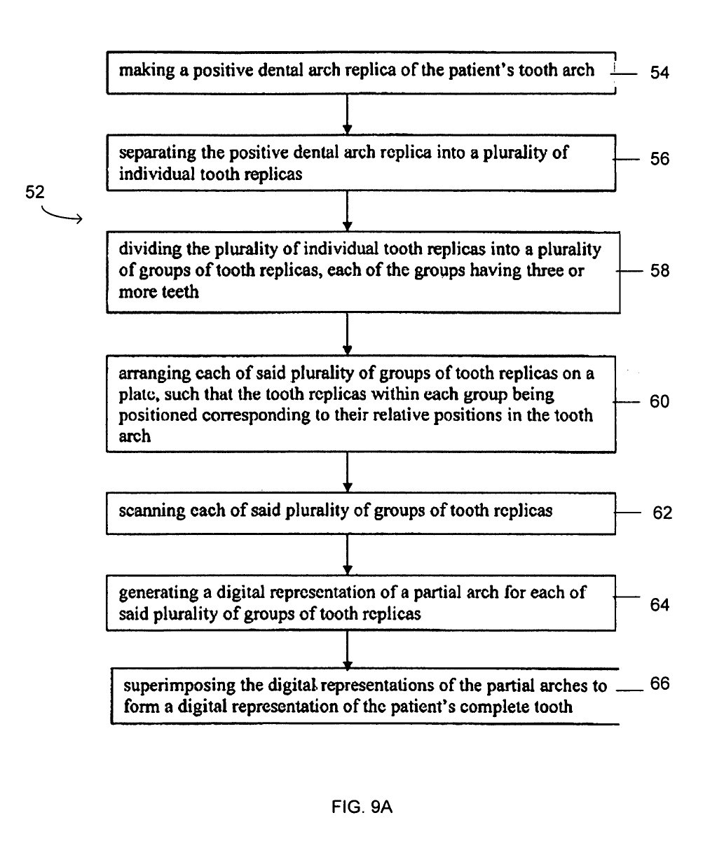

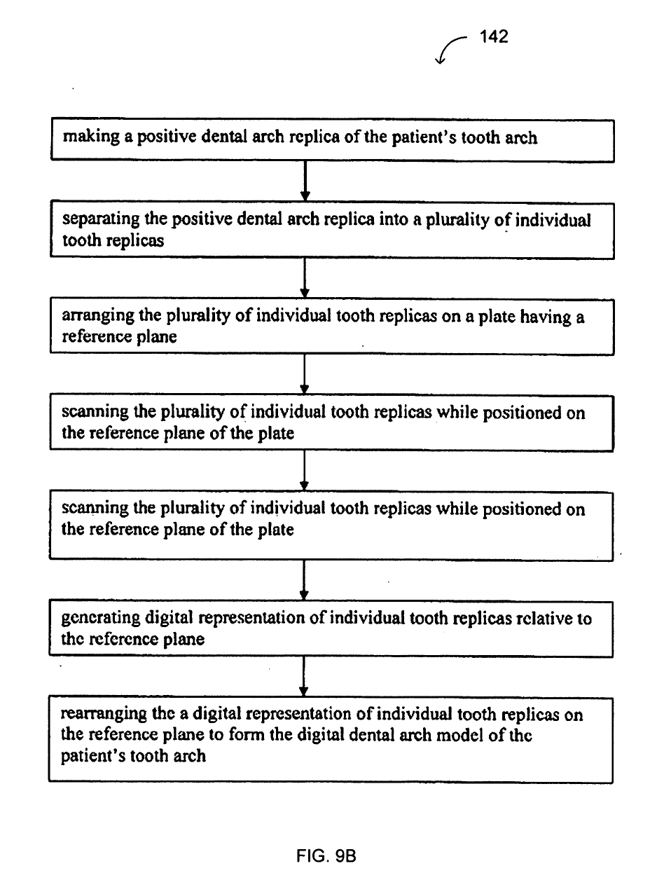

FIG. 9A illustrates one method 52 for scanning individual tooth replicas to generate a digital representation of a patient's tooth arch. The method comprises first making a positive dental arch replica of the patient's tooth arch 54. The positive dental arch is then separated into individual tooth replicas 56. The individual tooth replicas are divided into a plurality of groups of tooth replicas, each of the groups having three or more teeth 58. Each group of the tooth replicas are arranged on a scanning plate corresponding to their relative positions in the tooth arch 60. The groups of tooth replicas are scanned 62, and a digital representation of a partial arch (e.g., information regarding a group of individual tooth profile and their relative position and/or orientation information) for each of the groups of tooth replicas are calculated by a computer based on the scan 64. The computer then superimpose (e.g., combining data sets with information regarding groups of individual tooth profile and their relative position and/or orientation information to form a single data set representing the completely tooth arch) the digital representations of the partial arches to form a digital representation of the patient's complete tooth arch 66.

In one variation, each of the tooth replicas comprises an extension at a distal end and the proximal end of the tooth replica includes a profile representing the crown of the corresponding tooth in the patient's tooth arch. The plate comprises a plurality of receptacles for receiving the extensions of the tooth replicas. The receptacles are configured such that when all the tooth replicas are inserted into the plate a replica of the patient's complete tooth arch is formed. In another variation, the extension for each of the tooth replica is further configured such that the extension is oriented to correspond to the orientation of a root of the corresponding tooth in the patient's tooth arch. The extension can be configured to prevent the corresponding tooth from rotating in the receptacles. In addition, each of the receptacles is configured to hold the corresponding tooth replica on the plate at an angle representative of a tilt of the corresponding tooth in the patient' tooth arch. The plate may be provided with a reference coordinate, and each of the digital representation of the partial arch is generated in relation to the reference coordinate. The reference coordinate may then be utilized to superimpose the digital representations of the partial arches.

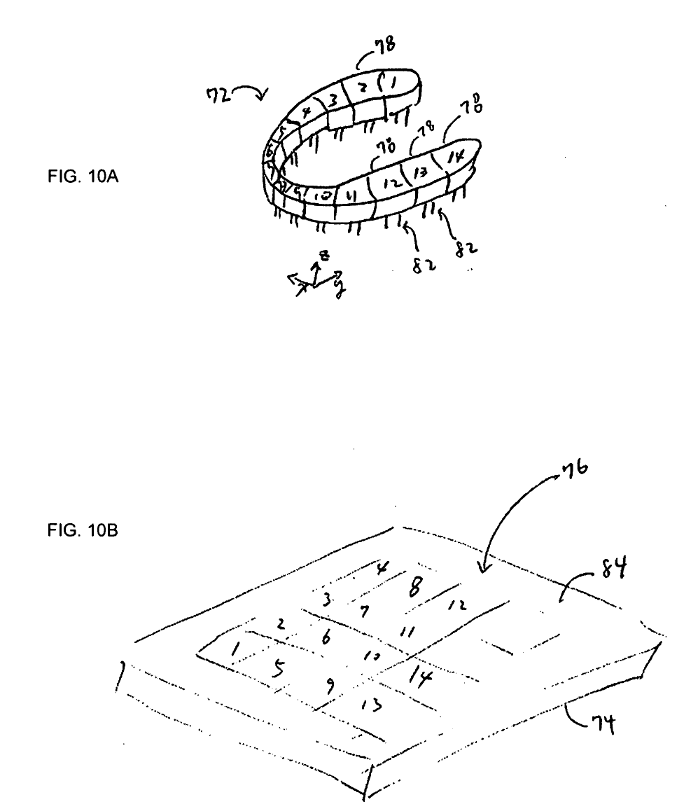

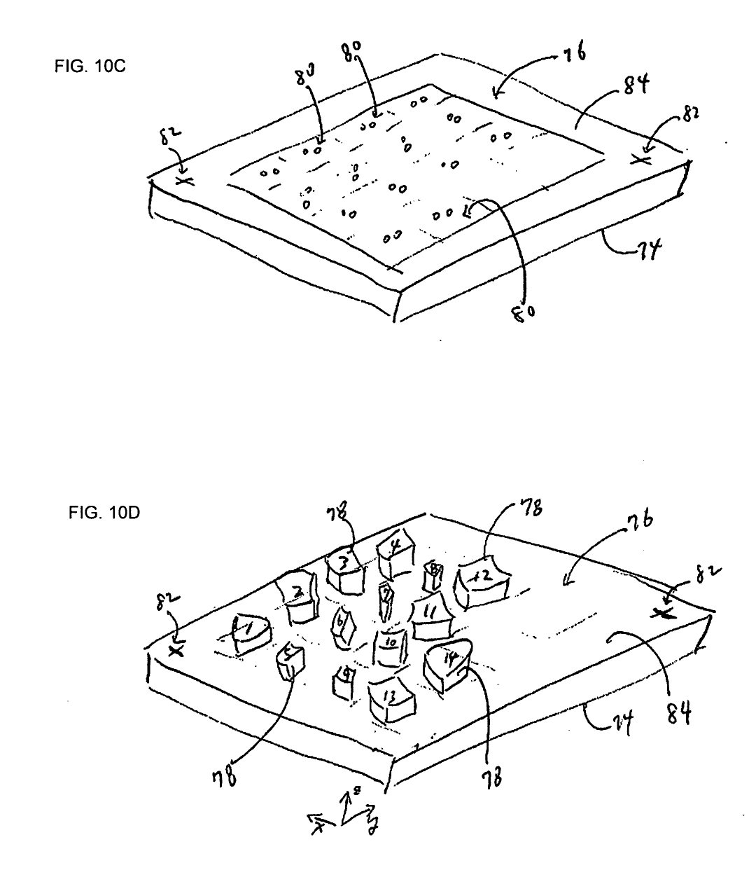

In another approach, the individual tooth replicas are placed on the scanning plate according to a matrix that is independent of the shape of the curved profile of the overall tooth arch. Referring to FIG. 10A, a positive dental arch replica 72 including reference numerals for each of the teeth 78 is shown. The reference numerals are provided for illustration purpose only. The reference numerals identify individual teeth 78 within the tooth arch. A plate 74 is configured with a matrix 76 for receiving the individual tooth replicas once the individual teeth 78 have been separated from the positive tooth arch replica 72. As shown in FIG. 10B, the plate 74 is provided with fourteen positions for receiving the fourteen tooth replicas 78. As one of ordinary skill in the art would appreciate, the tooth replicas do not have to be placed into the matrix in a specific order as long as the computer/apparatus performing the scanning is able to keep track of which tooth is placed in which position within the matrix. Within each position in the matrix 76, a receptacle 80 is provided to receive the extension 82 of the corresponding tooth replica 78, as shown in FIG. 10C. In this example, the tooth replicas 78 are positioned on the plate 74 such that the tilt/orientation for each of the tooth 78 corresponds to the tilt/orientation of the tooth within the tooth arch 72, and once the tooth replicas are scanned, the computer can construct the digital representation of the complete tooth arch by moving (e.g., recalculating the position of the of the digital representation of each tooth within the given coordinate system, etc.) the digital representation of the tooth replicas on an X-Y reference plane 84 (e.g., recalculate the X-Y position information) without the need move the digital representation of the tooth replica on the Z-axis nor tilting/rotating the tooth replicas. FIG. 10D shows the individual tooth replicas 78 from FIG. 10A inserted into their corresponding receptacles 80 in the scanning plate 74. Optionally, the scanning plate 74 may be provided with reference markers 82 for calibrating the base plate 74 and/or the tooth replicas 78 to a common coordinate system.

As illustrated in FIG. 10D, the distribution of the individual tooth replicas 78 on the scanning plate 74 in comparison to the tooth arch 72 shown in FIG. 10A, is such that the relative position of the tooth replicas 78 to each other are fixed (e.g., in terms of tilt and/or rotation position, etc.) except their relative X and Y position. Therefore, once the tooth replicas are scanned, by recalculating the X-Y coordinate (e.g., moving the individual tooth on the X-axis and the Y-axis), a digital representation of the complete tooth arch can be generated. In one variation, the tooth replicas are separated from each other on the plate with enough space such that at least 50% of the side surface for each of the tooth replicas can be scanned without interference from adjacent tooth replicas (i.e., tooth replicas in the adjacent matrix position). In another variation, the tooth replicas are separated with enough space to allow at least 70% of the side surface for each of the tooth replicas to be scanned. In yet another variation, the tooth replicas are separated enough to allow at least 95% of the side surface for each of the tooth replicas to be scanned. One of ordinary skill in the art having the benefit of this disclosure would appreciate that depending on the type of scanner being used (e.g., laser, IR, optical, CAT Scan, MRI, etc.) the required distance between the tooth replicas may vary.

In one approach, the plate loaded with the individual tooth replicas are placed on a laser scanning apparatus. The tooth replicas are separated form each other with enough distance such that each tooth can be scanned without the adjacent teeth interfering with the laser beam from the scanner. In one variation, the laser beam is rotated in relation to the plate during scanning. In another variation, the plate is rotated in relation to a laser scanning beam that is fixedly positioned within the scanning apparatus.

In addition, the complete physical dental arch replica, either before individual teeth are separated, or reconstructed from separated individual tooth replica, can be scanned to regenerate a digital profile of the full arch. This digital profile of the full arch can then be utilized to align the digital representation of individual tooth replicas to form a digital representation of a complete tooth arch, including information of individual teeth profile. For example, the position of the digital representation of individual tooth replicas can be adjusted relative to each other based on the surface profile of the digital representation of the arch determined based on the full arch scan

As one of ordinary skill in the art would appreciate, scanning of a complete tooth arch replica, such as the one shown in FIG. 10A, can not capture the crown profiles that are hidden/obstructed by the adjacent teeth. In addition, because the surface profiles of the teeth are curved/rounded, as a consequence, in-between teeth there are indentations. Even though the surfaces in these indentations are exposed, the scanner may have difficulty capturing the surface profile due to the concaved nature of these areas during scanning. For example, laser light entering these indentations between teeth may not properly reflect out and therefore may not be properly registered by the photo sensors. In addition, by constructing a digital representation of the complete tooth arch based on individual tooth scans, the profile of each of the teeth in the tooth arch is preserved, and the user/computer can then manipulate each tooth in the tooth arch relative to the other teeth in the tooth arch.

In another variation, the extension (e.g., one or more pins, etc.) on each of the individual tooth replicas can be utilized as a reference maker, such that by identifying the position and the orientation of the extension, one would be able to determine the position and orientation of the corresponding tooth replica. For example, extension may be incorporated into the positive tooth replica as it is being formed form the negative dental arch mold. Receptacles, which match the extensions on the corresponding tooth replicas, are then provided on the scanning plate to position the individual tooth replicas on the plate. The receptacles may be created by with a computer controlled milling device, such that the computer is able to keep track of the exact position and orientation for each of the receptacles on the scanning plate. Therefore, when the tooth replicas are inserted in their corresponding receptacle in the scanning plate, one can determine the position and orientation of the extension for each of the tooth replica based on the position and orientation of the corresponding receptacle. By tracking the position of the reference marker (i.e., extension) for each of the positive tooth replicas, the computer can construct the complete tooth arch from digital representation of individual tooth replicas, which may be scan in groups of two or more tooth replicas.

FIGS. 17A-17D illustrate one approach for making a positive dental arch replica 10114 based on a negative dental arch model 10100. First, negative impressions 10100 of the patient's upper and lower tooth arches, are taken through procedures that are well known to one of ordinary skill in the art. The negative impression 10100 of the patient's tooth arch is coupled (e.g., glued, bonded, interlocked, etc.) to a container 10102. A three-dimensional position input device (e.g., MicroScribe®, stylus, etc.) 10104 is then utilized to determine an approximate position for placement of an extension in each of the teeth within the tooth arch, as shown in FIG. 17A. In one variation, the extension (e.g., placement of pins) represents the approximate position of the root of the teeth, and serves as reference marker for the crown portion of the tooth. For example, a MicroScribe® 10106 can be inserted into the negative impression of a tooth to approximate the root position for that particular tooth. In one variation, the MicroScribe® is inserted into the cavity along the longitudinal orientation of the tooth, and, if necessary, further adjusted to a position that approximates the position of the root of the tooth. A computer is then used to record the position of the MicroScribe®, which corresponds to the approximate root position. In one approach, the placement of the MicroScribe® is controlled by an operator. In another variation, an automated system having optical and/or tactile feedbacks is utilized to position the MicroScribe®.

In addition, the extension or approximated root for each tooth may be defined by one or more positioning/placement of micro-scribes. For example, the micro-scribe may be placed within each tooth cavity to define a proximate position of the root for each of the teeth. In another variation, the micro-scribe is used to define two positions, which in combination approximates the position of the root of a tooth. Pin-like objects placed on a positive tooth model may be utilized later to simulate the positions defined by the micro-scribe, which in turn represents the approximate position of the root.

In another example, the MicroScribe® is implemented to define four points in each of the tooth cavity within the negative impression of the tooth arch. The four MicroScribe® defined points are then utilized to define the position for the placement of two pins, or an asymmetric peg/interface, which serve as the extension of the tooth replica. The extension may also simulate the root of the tooth. In another example, the MicroScribe® is implemented to sample a series of points that represent the profile of each of the tooth cavity within the negative impression 10100. For example, three or more points on the surface of the cavity, which represents a tooth, may be sampled by the MicroScribeg to define an approximate surface profile of the tooth. The approximate surface profile is then used to define/approximate the extension position. For example, two pin positions may be calculated to fit within the approximate surface profile along the longitudinal axis of the tooth. In one variation, a sectional plan is defined at the base of the tooth based on the MicroScribe® sampling of the portion of the negative impression that represents the gingival tissue. A pair of pins, with a pre-set distance “d”, is then positioned perpendicular to this sectional plan, and centered within the tooth that is defined by the approximate surface profile defined by the MicroScribe®.

Next, a cover plate 10108 is drilled with holes for holding pins that would correspond to positions defined by the MicroScribe®. The holes may be drilled with a Computer Numeric Control (CNC) machinery utilizing data collected from the micro-scribe measurements. In one variation, the cover plate 10108 and the container 10102 are manufactured with matching reference markers, such that the coordinate system relied on by the micro-scribe can be properly transposed over to the cover plate. Pins 10110 are then inserted into the holes on the cover plate, as shown in FIG. 17B. The cover plate 10108 is flipped over and placed on top of the container 10102 holding the negative impression 10100 of the tooth arch, as shown in FIG. 17C. When the cover plate 10108 and the container 10102 are properly aligned, the position of the pins (i.e., extensions) 10110 may correspond to the approximate root positions defined by the micro-scribe. A polymer or plaster is then injected into the cavity 10112 of the negative impression 10100. Once the polymer cures, a positive arch is created within the negative impression, with the pins bonded to the positive arch. The user may then decouple the negative impression 10100 from the positive arch 10114, resulting in a positive tooth arch replica 10114 with a plurality of pins 10110 (i.e., extensions), as shown in FIG. 17D. Optionally, the positive arch 10114 may be scanned (e.g., laser 3D scanning, etc.) to generate a three-dimensional surface profile of the tooth arch, which may be utilized later in this process to align digital representation of individual tooth.

In one variation, the pin positions can be utilized as reference marker to determine the relative positions of the teeth in the patient's tooth arch, since the pin positions were defined by the micro-scribe relative to the negative impression of the patient's tooth arch. In another variation, an optional scan of either the positive tooth arch model or the negative tooth arch impression may be performed to assist with the determination of the relative positions of the teeth in the tooth arch. The optional scan may also be utilized along with the pin information for determining the relative positions of the teeth within the tooth arch. In yet another variation, the optional scan is utilized alone, without the pin information, to determine the relative positions of the teeth within the tooth arch.

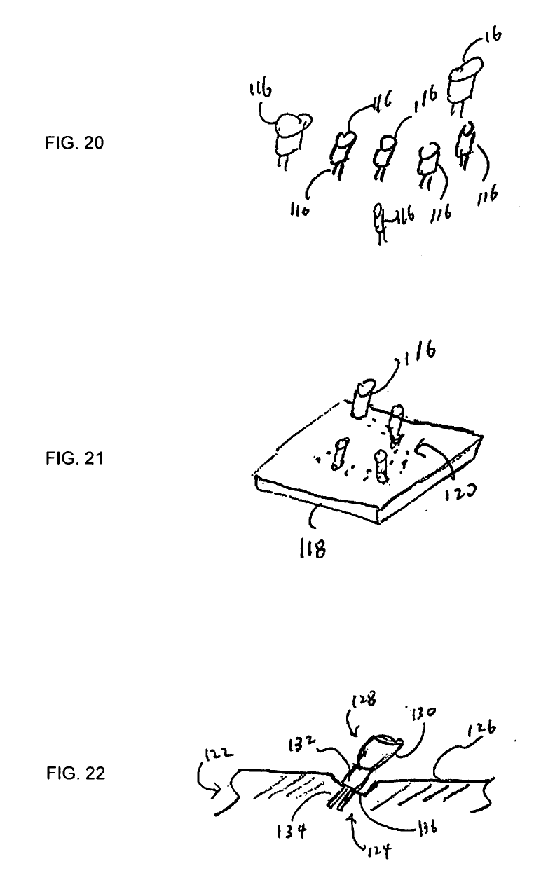

The teeth on the positive tooth arch 10114 are separated into individual tooth replicas 116, as shown in FIG. 20. The individual tooth replicas are then positioned on a base plate 118 and scanned with a scanner through method described above to create digital representation of individual teeth, as shown in FIG. 21. On the base plate 118, holes 120 (i.e., receptacles) are pre-fabricated for receiving the extension on the individual tooth replicas 116. The computer may be provided with information regarding the position of the predefined holes 120 on the base plate 118. The predefined holes 120 are configured to receive the pins 110 on the individual tooth replicas 116. Thus, once the crown portion of a tooth has been digitized with the scanner, the digital representation of the crown can be associated with the corresponding extension information, and be referenced to the proper tooth in the tooth arch.

In one variation, the scanning plate 122 is configured with receptacle 124 that are indented from the reference plane 126 of the scanning plate 122, such that the tooth replica 128 can be received and oriented at an angle representative of the orientation of the tooth within the dental arch, as shown in FIG. 22. In this example, the tooth replica 128 is configured with a crown portion 130 and a base portion 132. Two pins 134, which serve as extension (i.e., reference marker) extend from the base portion 132. Each of the receptacles 124 is configured with a receiving surface 136 perpendicular to the extension 134. The receiving surface 136 is arranged such that when the positive tooth replica 128 is inserted in the receptacle 124, it is orientated in an angle that corresponds to the orientation of the tooth in the tooth arch. Depending on the amount the tooth is tilted, the receiving surface 136 may be slanted resulting in an indentation forming on the surface of the plate 122. In one implementation, the plate is configured with a plurality of receptacle forming a shape of a tooth arch. When the tooth replicas are inserted in the corresponding receptacles, the tooth replicas forms a tooth arch corresponds to the tooth arch of the patient.

Referring to FIG. 9B, another exemplary method 142 for generating a digital representation of a tooth arch is illustrated. In this example, the positive tooth replicas are arranged on the scanning plate in relation to a reference plan such that each tooth's position/orientation in relation to each other is only shifted on the X-Y plane, and tooth replicas are not displaced in the direction perpendicular to the reference plane (e.g., no displacement on the Z-axis). Therefore the digital representation of the dental arch can be generated by recalculating the X-Y position of the digital representation of the individual teeth once the tooth replicas are scanned.

Digital Dental Arch Model of Occlusion

As used herein, “generating”, “creating”, “calculating,” and “formulating” a digital representation means the process of utilizing computer calculation to create a numeric representation of an object. For example, the digital representation may comprise a file saved on a computer, wherein the file includes numbers that represent a three-dimensional projection of a tooth arch. In another variation, the digital representation comprises a data set including parameters that can be utilized by a computer program to recreate a digital model of the desired object.

As described above, there are many potential uses for an accurate model of a subject's upper and lower arches. There are also many potential uses for an accurate model of the occlusion of a subject's upper and lower arches. As used herein, the term “occlusion” generally refers to the alignment between the teeth of the upper arch and the lower arch when the jaws are brought together during biting. The systems, methods and devices described herein may be used to create accurate models of a subject's dental arches during occlusion. For example, a dental arch occlusion model may include at least a portion of a subject's upper arch and lower arch, and may reflect the alignment between the upper and lower arches when the subject is biting. The model may be a digital, or a computer-manipulatable model.

A dental arch occlusion model may be generated using a mold (e.g., a positive or negative model) of a subject's upper dental arch and a mold of a subject's lower dental arch. A bite-down registration device may be used to take the subject's bite registration. The model may be created by identifying fiduciary references on the upper and lower arch models (e.g., by mounting the upper arch to a first fixture, and the lower arch to a second fixture), by aligning the upper arch model and the lower arch model to a bite-down position, and finally by measuring the relative positions of the upper arch model and the lower arch model.

The upper and lower dental arch refers to the arrangement of a teeth in the upper and lower jaws of a subject. As used herein, a subject may include any subject (human or animal) whose dental arches may be modeled by the methods and systems described herein, including orthodontic patients. At the start of the modeling procedure, a physical model (e.g., mold or cast) may be made of a subject's upper and lower dental arches. Any appropriate method of making a cast or model of a subject's dental arches may be used. In one variation, a negative mold is made from all (or a portion) of a subject's upper and lower arches. For example, a dental cast made be made showing the arrangement of the subjects upper and lower teeth with respect to each other. A positive replica may then be formed using this negative mold. The positive and negative mold may also be used to accurately model the relationship of the individual teeth with respect to each other, as described in many of the patent applications mentioned above.

For example, details of molding dental arch models are disclosed in the above referenced U.S. patent application Ser. No. 11/013,160 (“System and methods for casting physical tooth model”), and U.S. patent application Ser. No. 10/979,823 (“Method and apparatus for manufacturing and constructing a physical dental arch model”).

Generally, the dental arch refers to a subject's actual dental arrangement. For example, a subject's upper dental arch may model the subjects current arrangement of teeth (or “initial” arrangement of teeth in cases where the teeth are to be moved) in the upper arch. In some variations, the dental arch may be a “simulated” dental arch.

The dental arch models of the upper and lower arches may include any feature of the actual dental arches, or a subset of these features. For example, the dental arch model may include the crown regions of the teeth, the gums (gingival), the roots, etc. Some of these features may be actually measured or derived. For example, the structure and locations of the roots of the teeth may be calculated (or computer-generated) from measurements taken from the crown region or other portions of a subject's teeth or mouth.

The dental arch models can be reconstructed from digital arch models of each dental arch. For example, a positive model of the subject's tooth arch may be created from a negative impression of the subject's teeth. The teeth of the positive mold may then be segmented into individual units (e.g., teeth) and digitized or scanned by various 3D scanning techniques and reconstructed to digitally represent the subject's upper or lower arch. A physical model of the dental arches may therefore be made from a digital model of each of the arches. For example, physical upper and lower arch models may be fabricated using Computer Numerical Control (CNC) manufacturing (such as milling, stereo lithography, and laser machining).

It may also be beneficial to include markings such as fiduciary references on the upper and lower arch models.

Fiduciary references may be used to aligning the upper and lower arch models (or portions of the upper and lower arches). Virtually any mark, object or region of an object may be identified as a fiduciary reference for purposes of aligning the arch models. A fiduciary reference may be a stereotyped reference mark by which the orientation and/or location of an arch model or components of an arch model (e.g., individual teeth) may be identified. A fiduciary reference may include multiple marks, or an asymmetric mark. Fore example, a fiduciary reference may be a point or set of points scribed onto the arch model or onto an object to which the arch model is attached.

In some variations, an arch model is attached to a fixture, and the fixture comprises the fiduciary reference. A fixture may be a plate (e.g., a base plate) that is not part of the subject's actual dental arch, but to which the dental arch model is attached. A dental arch may be secured to the fixture so that the dental arch does not change position relative to the fixture. Thus, the fiduciary reference may be marked on the dental arch itself or it may be marked on the fixture. In one variation, the shape of the fixture provides the fiduciary reference. Thus, the fixture may be notched or otherwise shaped (e.g., asymmetrically shaped) to indicate the orientation of the arch model that is attached to the fixture.

Fiduciary references may include any number of markers. For example, a single fiduciary mark may be used to indicate location and orientation of dental arch components. A fiduciary reference may comprise two, three, or more individual marks. In some variations, the fiduciary reference is a three-dimensional structure (e.g., a cut, a pit, etc.). In some variations, the fiduciary reference is a two-dimensional structure (e.g., a mark). In some variations, the fiduciary reference may comprise a color or texture that is distinguishable from the rest of the dental arch model.

A bite-down registration device may be used to take a bite imprint from the subject of whom the dental arch occlusion model is being made. The bite-down registration device may be any device that reflects the orientation or position of the upper and lower dental arches (or portions thereof) when the subject is biting, e.g., during occlusion. Bite-down registration devices are generally negative imprints of the crown portions of the teeth that fit between the upper and lower arches when the subject is biting down. A bite-down registration device may therefore be made of a material that conforms to the spaces between the upper and lower arches when the subject bites down on the registration device, and retains this conformation when removed from the subject's mouth.

One example of a bite-down registration device includes a wax bite. A wax bite is typically a wax plate (e.g., having a thickness of approximately 3 to 4 mm). The wax bite may be softened by heating (or may be comprised of a relatively soft material) so that it conforms to the shape of portions of the upper and lower arches and retains this shape once removed. Other examples of bite-down registration devices may comprise materials such as a polymeric material (e.g., low-temperature thermoplastics, thermoplastic elastomers such as ethylene/vinyl acetate copolymers, thermoplastic resins such as wax, polycaprolactam resin, gutta-percha, or the like, etc.), gums, rubbers and the like, including mixtures of different materials. In some variations, the bite-down registration device comprises a settable material that may be hardened around at least a portion of the upper and lower arches after the subject has bitten down. For example, the bite-down registration device may comprise a paste, gel or liquid that may be cross-linked (e.g., a cement or resin that is cross-linked by UV light).

The bite-down registration device may also be in any shape, including a sheet or a mouthpiece-shape, so that it readily fits into a subject's mouth, and may fit between the upper and lower arches. It may be advantages for the bite-down registration device to comprise a thickness or shape so that it does not substantially interfere with the normal bite position of the subject. Thus, the bite-down material may comprise a thin sheet of material (e.g., less than 3 mm thick, less than 2 mm thick, less than 1 mm thick, etc.) shaped to fit into the mouth. In some variations, the bite-down registration device comprises a material that is held in a container (e.g., a mold) in the mouth until it can be hardened and removed.

Once the bite-down registration device is formed, it may be used to help align the models of the upper and lower dental arches. For example the bite-down registration device may be placed between the upper and lower dental arches to replicate the normal bite of the subject. The bite-down registration device may keep the upper and lower arches separate (or prevent complete closure during biting) and still be very useful to show the normal bite-down position of the upper and lower arches. The upper arch, bite-down registration device and the lower arch may be measured to determine the relative positions of the upper and lower arches during a normal bite. For example, this measurement may be done by scanning the assembled upper arch, bite-down registration device and lower arch.

Any appropriate scanning technique may be used to allow measurement of the relationship between the upper and lower arches, including contact scanning or non-contact types of scanning. Contact scanning includes scanning by actual (or computer assisted) measurement, including mechanical location devices such as a Microscibe. The scanner may be used to acquiring coordinates (e.g., 3D coordinates) from the dental arches including the fiduciary references.

For example, commercial Microscribes are available from Immersion and Phantom. A contact Microscibe scanner, as described above, may comprise one or more mechanical arms that have mechanical joints with precision bearings including sensors. The Microscibe then moves a stylus over the assembly of upper dental arch, bite-down registration device and lower dental arch, and records accurate 3D positional and angular information of the points that the stylus touches. Thus, the stylus may touch (or be directed to touch) the fiduciary references of the upper and lower dental arches. The mechanical location device may comprise additional sensors (e.g., a sensor located on the tip of the stylus of a Microscribe) for specifically or automatically detecting the fiduciary reference. Example of additional sensors include optical sensors, RF sensors, and the like.

Prior to any type of scanning, the assembly of upper arch, bite-down registration device and lower arch (“the assembly”) may be secured together to prevent shifting of the assembly. The assembly may be secured together in any appropriate fashion, including clamping, tying, gluing, or the like. For example, the assembly may be secured together by an elastic (e.g., rubber) band. Furthermore, it may be advantageous to attach or affix the assembly to a scan plate (e.g., a surface from which the scanning may take place). For example, the assembly may be attached to a scan plate that rotates or otherwise moves to position the assembly so that it might be accurately scanned. In some variations, the assembly is secured to a scan plate. In some variations, the assembly is merely placed on a scan plate.

The assembly may also be scanned by non-contact methods to determine the relationship between the upper and lower dental arches in an occlusion model. Examples of 3D non-contact scanners and scanning techniques include, but are not limited to, laser scanning, optical scanning, destructive scanning, CT scanning, and sound wave scanning.

The scanner may communicate with a computer that may be used to control the scanning, and/or to store information from the scan. Position and Orientation information can be obtained, stored and analyzed. The computer may also act as a controller, and may control other portions of the scanning process, including the scan plate. For example, the computer may allow user input, and may also provide output.

In some variations, the assembly may not include a bite-down registration device. For example, in some patients, the upper and lower dental arches may be aligned without a bite-down registration device. Thus, the alignment and modeling methods and systems described herein may be performed without the bite-down registration device. However, use of the bite-down registration device may be advantageous, e.g., by enhancing stability when the upper and lower dental arches are aligned into an assembly for scanning.

The upper dental arch and the lower dental arch may also be individually scanned (in whole or in parts) by any of the methods described herein, or by any of the incorporated methods. For each dental arch (e.g., upper or lower), the fiduciary reference may also be scanned as part of the individual scans. Thus, the scan of the upper or lower dental arch will include the fiduciary references identified on these models. Typically, digital models of the upper and lower dental arches are made from these scans. Each digital model may have its own coordinate system. In some variations, an individual arch may be scanned in pieces or sections, and later reconstructed to form a model of a single dental arch, having a single coordinate system.

Based on the positional information identified from the scanning, the relative positions of the upper and lower arches during biting may be calculated, so that a model of the upper and lower arches may be translated into a single coordinate system.

In general, models of the upper dental arch, the lower dental arch, the combined upper and lower dental arch, and any portions thereof may be identified by any appropriate coordinate system that can covey the relative positions of the different regions of the dental arches. For example, a Cartesian (XYZ) coordinate system may be used, a radial (r, theta, alpha) coordinate system may be used, or a referencing system may be used (e.g., modifying a standard template).

A user typically establishes a new coordinate system each time the user uses the scanning devices and methods described herein. For example, when scanning using a Microscribe, two points on the side of the target (e.g., dental arch, negative mold, etc.) may be chosen as an x-axis, and another point on this plane may be chosen to define the xy plane. The z-axis is normal to this plane. An origin may be determined in any appropriate location.

The location of the coordinate system (e.g., the origin, etc.) may be influenced or determined based on the fiduciary reference. For example, the upper dental arch may be modeled by scanning the physical model of the upper dental arch. The relationship of the components of the upper dental arch (e.g., the locations, orientations and sizes of each tooth, and of the fiduciary reference, etc.) may be described in the coordinate system. Thus, two or more coordinate systems may be transformed into a single coordinate system (a single model) by determining the relationship between two or more coordinate systems.

A simple way to determine the relationship between two or more coordinate systems is to measure the relative positions of the upper and lower arches. For example, in simplified terms, imagine an upper dental arch has a fiduciary reference A in a certain position and orientation determined by the scanning as described. The lower dental arch as a fiduciary reference B in a certain position and orientation determined by scanning of the lower dental arch as described. After scanning the assembly (comprising the upper dental arch, bite-down registration device, and lower dental arch), the fiduciary references A and B can be identified as A′ and B′ on the assembly. The difference between A′ and B′ rep resents the relative difference (e.g., position and orientation) between the upper and lower arches. Thus, it is possible to transform the model of the upper dental arch to have the same coordinate system as the lower dental arch (or vice-versa) by measuring the differences between the fiduciary references of the upper and lower arches.

The relative positions of the upper and lower aches may be determined from the relationship of the fiduciary references identified for the upper and lower dental arches. Any appropriate method of determining the relative positions of the upper and lower arches may be used.

In general terms, the difference between the fiduciary reference on the upper arch A′ and the fiduciary reference on the lower arch B′ may be calculated to yield a distance (A′-B′) between fiduciary reference A′ and fiduciary reference B′. The difference, A′-B′, can be used to transform the coordinate system of the upper arch into that of the lower arch by substituting A for A′. Thus, the coordinate system of the upper arch will be offset by the difference in distance measured by A′-B′ and incorporating the value of the location and orientation of B, and the different orientation of the upper arch may be measured by the difference in orientation between A and A′. This is true because we know that in an actual occlusion, the fiduciary reference A′ of the upper arch is offset from the fiduciary reference of the lower arch B′ by some distance and orientation that may be reflected in our calculation of A′-B′.

For example, in one variation the upper dental arch is attached to a first fixture and the lower dental arch is attached to a second fixture. After scanning the assembly of upper dental arch, bite-down alignment device, and lower dental arch, the relationship between the first fixture and the second fixture may be determined. For example, the first fixture may be located a distance (Δ_{distance}) from the second fixture, and the fiduciary reference of the first fixture may be oriented in a direction (Δ_{direction}) relative to the (un-occluded) first fixture that was scanned individually. Thus, since the upper dental arch is “fixed” relative to the first fixture, the coordinate system values of the upper dental arch may be normalized to the same coordinate system as the lower dental arch by transforming the coordinates of the first dental arch from the individual can of the (un-occluded) upper dental arch by the difference in distance (Δ_{distance}) and direction or orientation (Δ_{direction}). Any appropriate transformation method may be used (e.g., matrix transformation, geometric transformation, spline transformation, etc.).

Any dental arch may be modeled using some (or all) of the steps described herein. In general, any of the devices, methods or systems described in the any of the sections of this disclosure (e.g., the section titled “Digital Dental Arch Model of Occlusion”) may be used in whole or in part with any of the devices, methods and system described elsewhere herein.

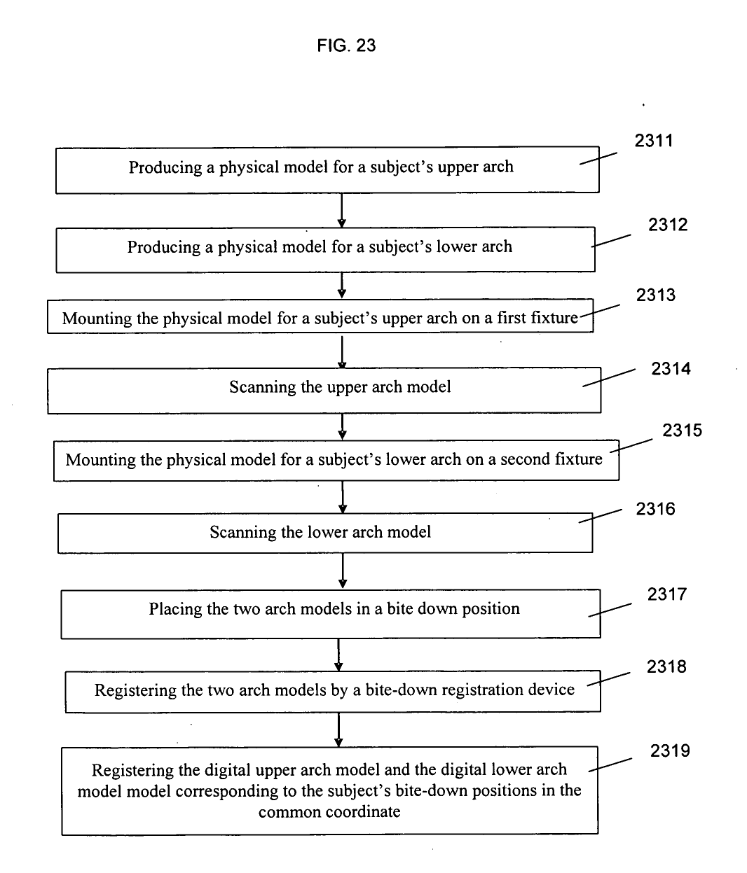

FIG. 23 illustrates one example of a process for digitally modeling a subject's dental arches during occlusion.

First, a model is produced for the subject's upper arch 2311 and a separate model is produced for the subject's lower arch 2312. The models for the upper arch or the lower arch can be produced by a number of techniques as described and referenced above. For example, a negative impression of the subject upper or lower arch may be first made (e.g., using procedure well known in the art). In one variation, arch models can be fabricated by molding. The impression of the subject's arch can be fixed in a container and then filled with malleable casting material. The container is then sealed. Heating, pressure or UV light may be applied, to solidify the casting material. An arch model is thus formed, and can be detached from the container.

Alternatively, in another example, an arch model may be formed from a digital reference. For example, impressions of the subject's upper arch and lower arch can be scanned by an image device, and the image data can be analyzed to produce digital upper and lower arch models. The digital upper and lower arch models can then be used as input data for fabricating physical upper and lower arch models using CNC based manufacturing such as milling, stereo lithography, and laser machining.

In some variations, the shape of the subject's arch models are digitized after mounting the subject's arch models on fixtures so that they can be individually represented in a fixed coordinate. Thus, each fixture comprises a fiduciary reference, as described. In this example, the physical model for a subject's upper arch is mounted on a first fixture 2313.

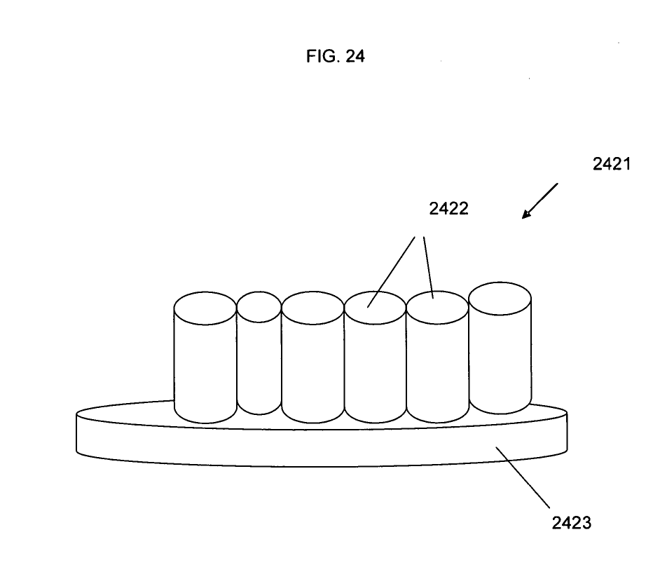

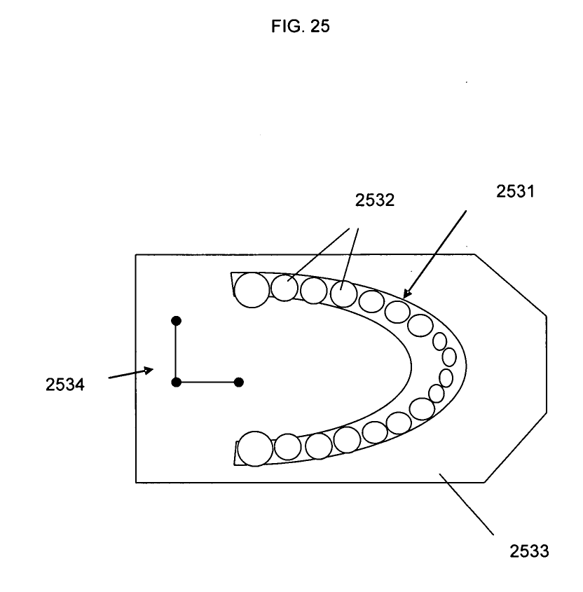

FIG. 24 shows a side view of a lower arch model 2421 comprising a plurality of tooth models 2422. The lower arch model 2421 is fixed to a first second 2423. FIG. 25 is a top view of an upper arch model 2531 that includes a plurality of tooth models 2532 that are fixedly mounted on a first fixture 2533. The upper arch model 2531 (similarly the lower arch model) can include the tooth models for all the subject's teeth in the upper arch, or just a subset of the subject's teeth in the upper arch.

The first fixture 2533 includes one or more reference marks 2534 for defining the coordinates of the upper arch model 2531 that is fixed on the first fixture 2533. The first fixture 2533 mounted with the upper arch model 2531 is then mounted on a scan plate in a three-dimensional scanning system. The scan plate can be rotated by a rotation mechanism. One or more image capture devices can capture images of the upper arch model 2531 as well as the reference marks 2534 at different angles. Throughput and accuracy of the scanning can increase with the number of the image capture devices. The captured image data is then analyzed to construct a three-dimensional digital model for the subject's upper arch. The three-dimensional digital upper arch model is based on a coordinate system defined by the reference marks 2534 on the first fixture 2533.

In another variation, a three-dimensional digital upper arch model can be obtained by first separating an upper arch model into a plurality arch model components. The criteria for separating the arch model into arch model components are first to ensure each arch model component can be easily scanned by an image capture device as described. In general, it is preferred that an arch model component is cut to a substantially convex shape such that the surfaces of the arch model component can be captured by an image capture device without being obstructed by another part of the same arch model component. The arch model components can be mounted on a scan plate and scanned at different angles. A digital arch model is constructed by combining digital representations of all the arch model components. The arch model components can be attached together and mounted on the first fixture. Alternatively, two copies of the upper arch model can be provided. One copy is mounted on the first fixture. Another copy is separated and scanned for constructing a digital upper arch model. Fiduciary references may be used to help reconstruct the individual arch model components.

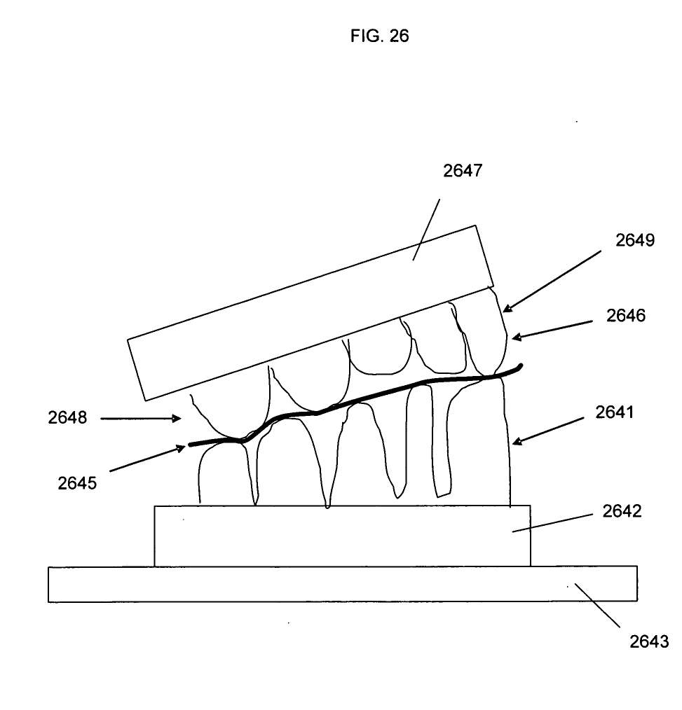

A lower arch model (e.g., the lower arch model shown in FIG. 26) 2641 is mounted on a second fixture 2642 as described 2315 in FIG. 1. The second fixture 2642 is mounted with the lower arch model 2641 on a scan plate 2643. The lower arch model 2641 is then scanned 2316 and digitized in a coordinate system based on reference marks fixed on the second fixture. Addition details of scanning the arch models to produce digital arch model are disclosed in U.S. Patent Application (titled “Digitization of dental arch model components”).

In FIG. 26, a bite-registration device 2645 such as a wax bite, is placed on top of the lower arch model 2641, such that the bite-registration device is in registration with the lower arch model 2641 in accordance with a desired bite position. The upper arch model 2646 mounted on the first fixture 2647 is then placed on top of the bite-registration device 2645 with the upper tooth models 2648 facing downward 2317. The second fixture 2647 is aligned such that the upper arch model 2646 is in registration with the bite-registration device 2645 and the lower arch model 2641 in a bite-down position for the subject's arches in step 2318. The first fixture 2642 and the second fixture 2647 can then by clamped so that they can be fixed to each other. For example the first fixture (upper arch) and the second fixture (lower arch) may be attached to each other by a rubber band.

The scan plate 2643 may be rotated to different directions to scan. The upper arch model 2646 that is clamped on the lower arch model 2641 is scanned at different angles. At least the visible parts 2649 of the upper tooth models can be captured by the image capture device. The visible parts 2649 can also include surfaces and edges of the first fixture 2647 that may have been also incorporated in the digital upper arch model. The image capturing can also include visible parts of the lower arch model 2641 and the second fixture 2642. To facilitate scanning of clamped lower arch model 2641 and the upper arch model 2646, the fiduciary reference can be located in visible areas of the first fixture 2647 or the second fixture 2642 (e.g., as half-spherical dents or domes that can be captured by the image capturing device). The fiduciary references can also be in different colors for identification purpose.

The captured image data allow a computer to represent at least a visible part 2649 of the upper arch model 2646 in the same coordinate system as the lower arch model 2642. The digital data for the surface points representing the visible part 2649 of the upper arch model 2646 can be fit with the complete digital upper arch model as described above. The complete digital upper arch model is therefore represented in the same coordinate as the lower digital arch model 2319. In addition, the coordinates of the reference marks are known in the coordinate system for individual fixtures and can thus be used to in the transformation of the upper or lower digital arch models into a common coordinate system.

In another variation, the lower arch model 2641 and the upper arch model 2646 can be swapped in positions in the scanning configuration illustrated the FIG. 26 to achieve the same result.

As described above, the relative positions of the upper arch model 2646 and the lower arch model 2641 can be measured by location measurement devices such as a Microscribe device. The mechanical location device can be used to measure the coordinates of the reference points in both the first fixture 2647 and the second fixture 2642. The coordinate information is used to transform the digital upper arch model and the digital lower arch model into a common coordinate system to be combined into a digital arch model including both arches.

Root Modeling

Once the tooth arch has been digitized, root modeling may be implemented to generate and/or simulate the roots for each of the tooth in the patient's tooth arch. The root modeling may be performed on the digital representation of a patient's tooth arch. The tooth arch may comprise three or more teeth positioned next to each other. In another variation, the tooth arch comprises twelve or more teeth. In yet another variation, each of the roots is coupled to its corresponding crown portion of the tooth, such that each corresponding set of crown and root rotate and/or move as a unit. As the user modifies the position and/or orientation of a tooth in the digital tooth arch, the user can visualize the position of the root relative to the crown and the adjacent teeth within the tooth arch.

After the crown portion has been digitized, the root portion for each of the corresponding crowns can be generated by a computer. For example, based on the morphology, dimension, size, and/or shape of the crown, an algorithm can be constructed to simulate a digital representation of the root and fit the root over the crown. In another variation, a data library comprising various predefined roots of different sizes and shapes may be provided. A computer program is configured to select a root that matches the crown. The selection criteria may include the type of the tooth and the size of the tooth. Data from X-ray images may also be utilized in the root selection process. Once the root is selected, the computer may further modify the size of the root to provide a better conformation between the root and the crown.

In yet another variation, the computer program first determines the category of the crown. Typically, the crown can be separated into four categories: incisor 106, canine 108, premolar 1010, and molar 1012. Each specific category of teeth will generally have a particular type of root 1014, 1016, 1018, 1020, as shown in FIGS. 11C, 11D, 11E, and 11F. Once the category of the crown has been determined, the software can access a library of one or more roots that are assigned to this particular category, and select the root that provides the best match with the crown.

Next, the simulated or selected root may be coupled to its corresponding crown. A computer algorithm may be utilized to determine the position and/or orientation to place the root over the crown. For example, the crown portion 102 may be represented by a group of mesh points. The computer program first determines a primary axis for the crown based on the distribution of the mesh points. Next, the axis for the root 104 is aligned with the primary axis for the crown 102, and then the base of the root is connected to the top of the crown, as shown in FIG. 11B. In another variation, the computer may calculate the best position and/or orientation to place the root based on the morphology of the crown and/or X-ray information. In another variation, the computer program is utilized to calculate the position and orientation to place the root based on a set of predefined parameters. Once the root is coupled to the crown, a visual representation of the complete tooth may be presented to the user. Optionally, the user may be provided with an opportunity to make manual adjustment on the position and/or orientation of the root. This manual adjustment may be based on X-ray or other clinical data.

In one variation, digital data representing the root is merged with the digital data representing the crown to form a single data unit that represents the tooth, which comprises both the root and the crown information. In one variation, the root is defined by a set of parameters (e.g., type of root, size of root, connecting position on the crown, orientation relative to the crown, etc.). The root information is then linked to the crown information. For example, the root parameter may include an element linking it to a particular tooth. The root parameter can be transmitted along with the crown information from one computer to another, such that the receiving computer can reconstruct the root based on the root parameter information. For example, the receiving computer may have a library of predefined roots. The root parameter received through the computer network may instruct the receiving computer to retrieve a specific type of root from the library, and couple the root to a specific crown at a position and orientation defined within the parameter.

In one variation, the digital representation of a tooth arch is saved into a file as data representing the profiles of individual teeth, which may include crown and/or root, and corresponding transformation matrixes, which defines the position and orientation for each of the teeth on a given tooth arch. For example, each of the transformation matrixes may comprise a 3×3 matrix of 109 floating point numbers. In another example, a 106 float format is utilized. For example a rigid body transformation matrix may be implemented. When the user modifies a tooth's position within the tooth arch, only the transformation matrix corresponding to that particular tooth is modified to record such a change. This particular configuration may allow efficient transfer of data, since the transmission of the transformation matrixes and the corresponding teeth profiles from one computer to the other may be enough to allow the receiving computer to recreate the tooth arch. In addition, if the receiving computer already has the tooth profiles, then the reception of the transformation matrixes along with appropriate reference information to link each of the transformation matrixes to the corresponding tooth profiles is typically enough to recreate the tooth arch in the receiving computer.

Displaying Digital Tooth Arch Models

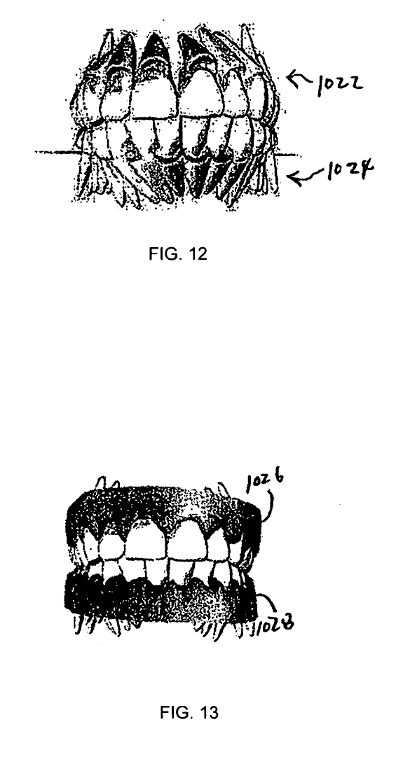

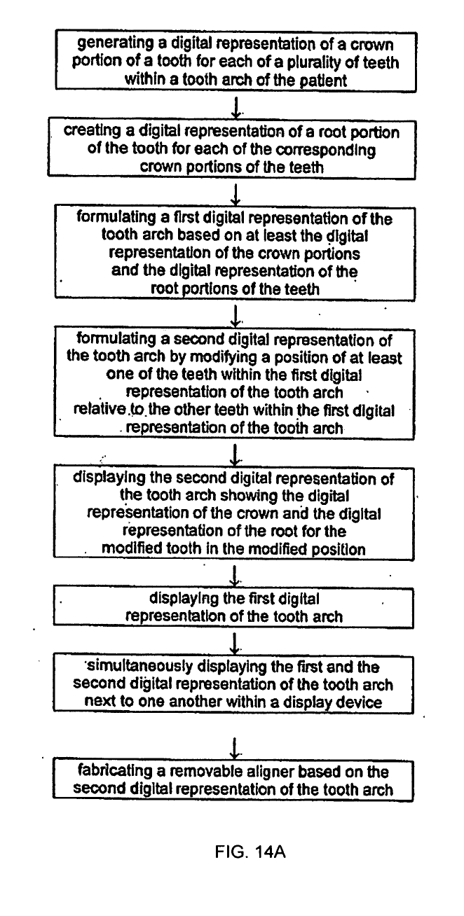

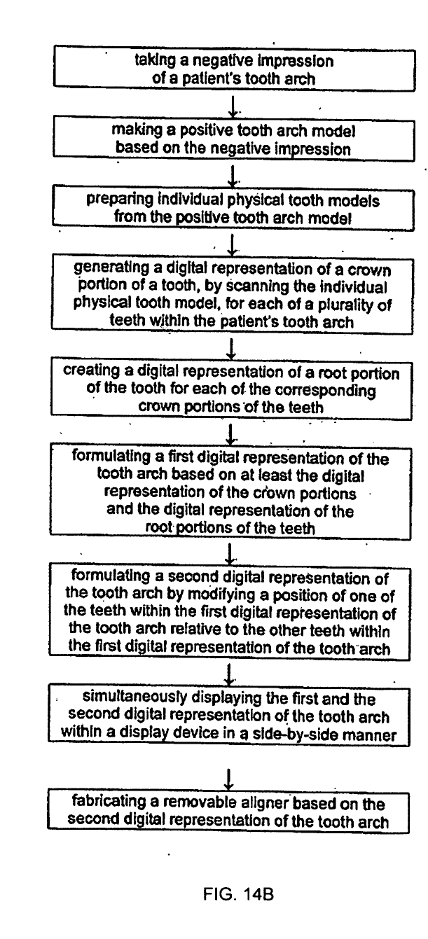

The digital representation of the patient's tooth arch can then be created based on the digital representation of individual teeth, which may comprise both the root information and the crown information. In one variation, information collected from the scanning of the complete tooth arch is utilized to align the digital representation of individual teeth to form the tooth arch. In another variation, information regarding fiduciary (e.g., pin) positions may be applied to align the digital representation of individual teeth to form the tooth arch. The digital representation of the tooth arch can then be displayed on an electronic display device by the computer. The computer may display the upper arch and the lower arch separately or simultaneously. FIG. 12 illustrates one example where the upper 1022 and lower 1024 arches of a patient's teeth are displayed simultaneously. The digital representation of the tooth arch may comprise gingival tissue information. In one variation, the computer program is configured to allow the user to selectively display or suppress the display of the gingival tissue. FIG. 13 shows the tooth arch model with its corresponding gingival tissue 1026, 1028 displayed. FIGS. 12 and 13 also show the digital dental arch models including both crown portions and root portions. In some variations, either just the crown portion, or just the (e.g., simulated) root portion may be displayed.

In displaying any of the digital dental arch (or components of the digital dental arch), the components (e.g., individual teeth) may be displayed in any relationship relative to each other. For example, individual components may be displayed arranged so that they represent the positions of the subject's dental arch. In some variations, the dental arch components may be arranged in an exploded view, so that some or all of the components are separated from each other. In some variations, the digital dental arch components are arranged differently from the subject's actual dental arch, as described further below.

In some variations, more than one view of the subject's digital dental arch model may be displayed simultaneously. For example, two different perspectives (e.g., frontal, top, side, etc.) may be displayed simultaneously. In other examples, two different arrangements of the components (e.g., teeth) of the digital dental arch may be simultaneously displayed. For example, a simulation of the arrangement of the subject's actual digital dental arch may be shown beside a simulated arrangement in which some or all of the components (e.g., teeth) have been moved relative to each other.

Various methods for preparing and/or utilizing the digital representation of the dental (e.g., tooth) arch are disclosed herein. FIG. 14A describes the steps of one method of displaying digital representations of all or a portion of a dental arch, including the root portion of the teeth. The digital tooth arch model (including the roots) can then be utilized to provide visual feedback to the user when the position and/or orientation of one or more of the individual teeth within the tooth arch are modified. This method may is also shown including a step for fabricating a removable dental aligner based on the movement of one or more of the digital dental arch models by the user. Thus, one (or both) of the displays of the digital dental arch model may be manipulated by a user. FIG. 14B describes another example of a method for displaying and/or modifying the arrangement of components of a digital dental arch model. Individual physical models of the teeth within a patient's tooth arch may be implemented to prepare the digital representation of the tooth arch.

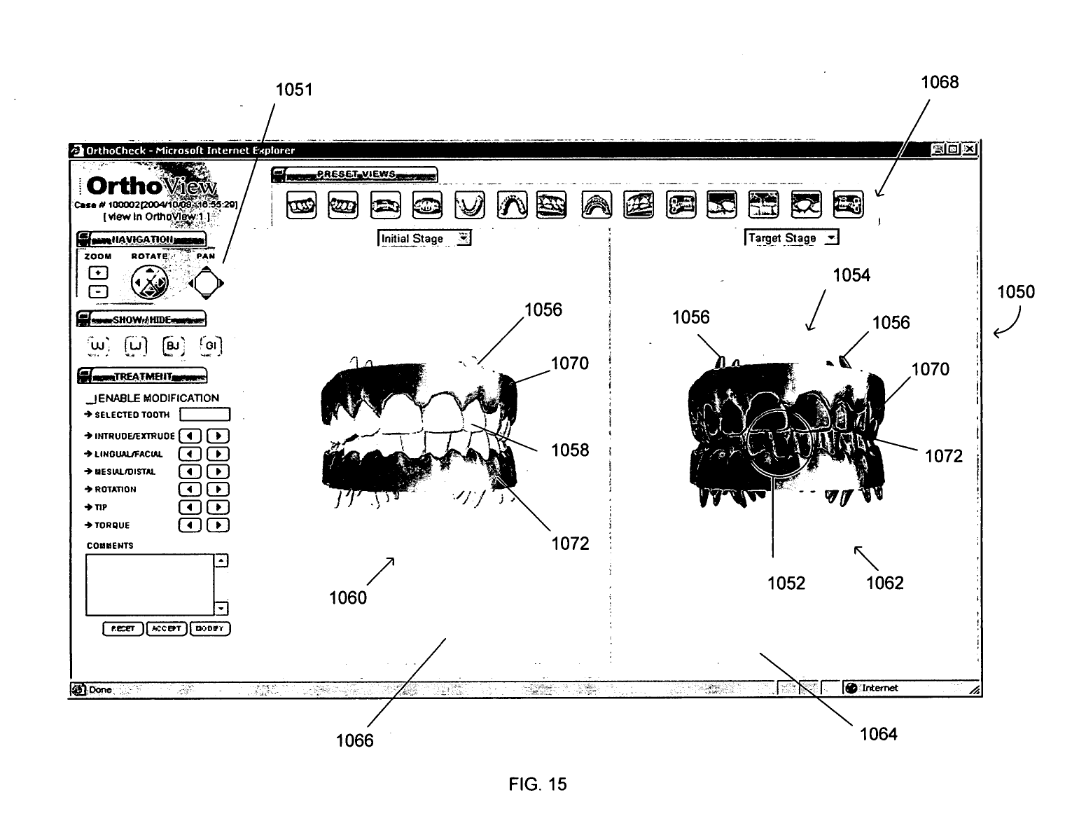

Software may be run on a computer that includes a user interface 1050 to allow the user to display and modify one or more of the teeth 1052 within the tooth arch model 1054, as shown in FIG. 15. The position of individual teeth within the tooth arch model may be electively modified (e.g., displaced, rotated, etc.) relative to the other teeth in the tooth arch model. In particular, the position of the individual components may be modified in predefined ways, as described below (e.g., treatment methods) and displayed on one of the displayed models. The digital dental arches may be displayed statically or dynamically. For example, the entire digital dental arch model may be moved continuously (e.g., rotated) or selectively (e.g., by the user). The user interface may also allow the digital dental arch model display to be manipulated to “move” components of the digital dental arch model (e.g., teeth). As a tooth moves (e.g., rotates), the root portion 1056 of the tooth will move accordingly. Since the root 1056 is elongated and extends from the crown 1058, the rotation of the crown (with the pivot point within or near the crown) may result in large displacement at the tip of the root. This representation of the position of the root may assist the user in determining the orientation of the tooth. The user interface 1050 may display a pre-modified tooth arch model 1060 and a post-modified tooth arch model 1062 in a side-by-side manner, as shown in FIG. 15. This display permits the user to verify changes made to a pre-modified digital dental arch model by comparing the modified arch 1062 with an unmodified arch 1060. As one of ordinary skill in the art having the benefit of this disclosure would appreciate, three or more digital arches models of the same patient may be provided with various changes or adjustments to one or more of the teeth. The user interface may be configured to allow the user to select any two of the arch models and display them side-by-side for comparison. Further, it should be clear that the “unmodified” digital dental arch model is not limited to a representation of the configuration of the subjects initial (e.g., actual) dental arch model. For example, the unmodified digital dental arch model could be a digital dental arch model that was previously modified (e.g., in an earlier step), but is not currently being modified.

In one example, a series of nine pairs of different tooth arches, representing projected teeth positions during the course of an orthodontic treatment plan, is transmitted to a receiving computer. The user may elect any two pairs of the tooth arches within the treatment plan and display them in a side-by-side manner. The user may be permitted to make changes to the teeth within the tooth arches. For example, the left window may show the tooth arch with the teeth in the original untreated positions. The right window may show the tooth arch with the teeth in their indented target positions. The user may modify the tooth arches in the right window if desired.

As the user modifies the digital dental arch model, the modifications may be recorded as one or more “instructions” for modification of the dental arch. For example, the modifications made to the digital dental arch may be saved as a series of instructions indicating how to reposition one or more of the individual components of the subject's teeth. Thus, the instructions may indicate the component being modified (e.g., which tooth), the type of modification (e.g., rotation, translation, trimming, etc., relative to any appropriate axis, such as the axis of the component), and the degree of modification (e.g., in rotational degrees, in mm, etc.). These instructions may be used by to fabricate a modified physical dental arch model, or may be used (e.g., for trimming) to directly modify a subject's dental arch).

An aligner may be created based on the modified tooth arch (e.g. shown in the right window in FIG. 15). In one variation, the aligner comprises a polymeric material. As one of ordinary skill in the art having the benefit of this disclosure would appreciate, this method may be followed to allow the user to check or prescribe a series of two or more sets of intended aligners. The aligners may then be fabricated based on the digital representations of the tooth arches at different stages of the treatment, or they may be fabricated from a physical model made from the modified digital dental arch model.

In the example shown in FIG. 15, the software is configured to allow the user to rotate the display of the digital dental arch model, such that the tooth arch can be examined from different views. In one variation, the two set of arches 1060, 1062 in the right and left windows 1064, 1066 are always shown in the same directional view, such that if the user rotates the post-modified tooth arches 1062 in the right window, the corresponding pre-modified tooth arches 1060 will also rotate in the same direction and in the same amount. If the unmodified (or pre-modified) tooth arches shown 1060 in the left window are rotated by the user, the corresponding post-modified dental arches 1062 will also rotate in the same amount simultaneously. In one variation, a curser controlled by a computer controller (e.g., a computer mouse, touch pad, etc.) may be utilized to drag the digital representation of the tooth arch shown in the user interface to rotate the tooth arch. Navigation tools may also be provided by visual ‘buttons’ or other icons 1051, as shown in FIG. 15. For example, buttons may help zoom the image, rotate the image, or pan to the left right, up, down, etc. Either dental arch image view may be manipulated individually or together (e.g., so that moving one of the images is reflected in movement of the other). In one variation, a user can also zoom in/out by dragging the mouse anywhere on the view, with the right mouse button pressed, and can rotate the viewpoint by dragging the mouse anywhere in the view with the left mouse button pressed. Finally, in one variation, the image may be panned by dragging the mouse anywhere in the view with both mouse buttons pressed simultaneously.

Optionally, icons 1068 representing selective predefined views of the tooth arch may be provided within the user interface 1050, such that the user can show a desired view by selecting one of the icons. FIG. 27 illustrates some of the predefined views that are configured as ‘buttons’ or icons on the display. In one variation, by clicking on an icon, both of the tooth arches displayed in the right and the left windows will be changed to show selected view of the tooth arches. Although in FIG. 15, both upper 1070 and lower 1072 tooth arches are shown, one of ordinary skill in the art having the benefit of this disclosure would appreciate that the computer program may be configured to allow the user to selectively show the upper tooth arches only, the lower tooth arches only, or both upper and the low arches at the same time.

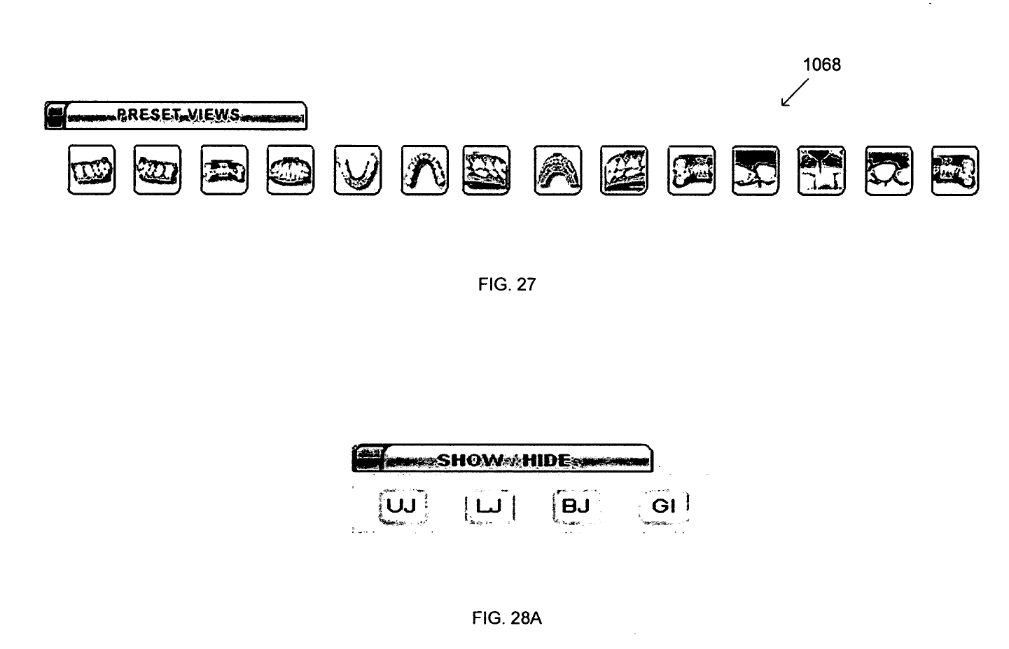

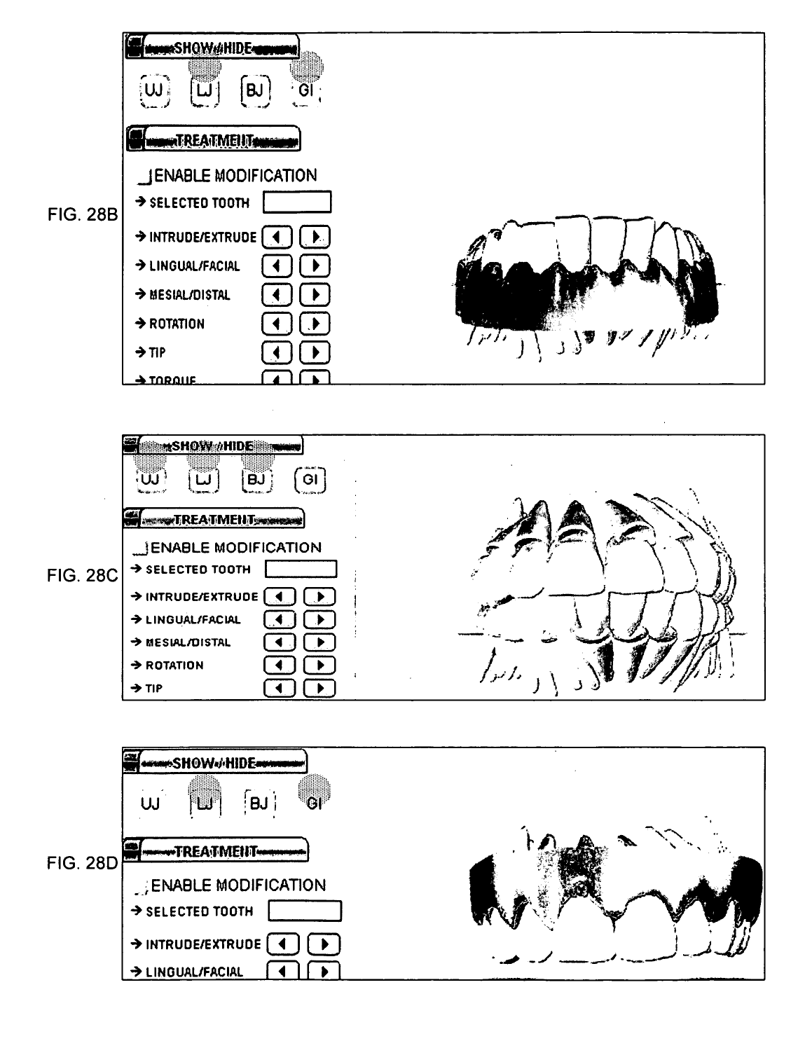

As described above, any features of the digital dental arch models being displayed may be made transparent, or “removed” from the display. For example, a show/hide menu may be included to toggle the view of the upper/lower dental arch (e.g., jaw), the gingiva, the roots, etc, as illustrated in FIG. 28A. FIGS. 28B-28D show the effect of showing or hiding various portions of the digital dental arch. For example, the “UJ” icon may be used to show or hide the upper jaw, the “LJ” icon may show or hide the upper jab, the “GI” icon may be used to show/hide the gingival, etc. FIG. 28B shows the gingiva and lower jaw. FIG. 28D shows the upper jaw and gingiva. FIG. 28C shows both the upper and lower jaw, without the gingiva.

In another variation, the user interface is configured to support synchronized movement of two digital arches that are displayed next to each other in an electronic display device. The viewing areas may be located within a single window defined by the operating system. The viewing areas in the window may be synchronized to allow the operator to compare the digital representation of the pre-treatment arch to the digital representation of the arch in one of the post treatment stages during the treatment plan. For example, as shown in FIG. 15, the viewing area on the right shows the “Target Stage” corresponding to the visual representation of the intended prescription for the next aligner.

One or more of the visual representation of the dental arch (e.g., the “target stage”) may be modified by the user. This allows the use (such as an orthodontist or other practitioner) to effect or correct the prescription if necessary by modifying the position of the components of the dental arch. As described herein, aligners may be fabricated based on the re-arranged dental arch models, thus an aligner may be fabricated based on a digital representation of the dental arch 1062, which can represent a corrected prescription. Further, a data input area (e.g., shown in FIG. 15 in the lower left-hand corner of the user interface) may be provided to allow the orthodontist to provide comments. Thus, the orthodontist may modify a prescription for an aligner by modifying one or more of the teeth in the digital representation of the tooth arch in the “Target Stage”, and/or by providing textual comments that are utilized by a dental technician during the fabrication of the dental aligner to make the necessary adjustments. The orthodontist may also utilize the textual input interface to provide comments that may assist with the treatment planning. For example, the orthodontist may indicate in a COMMENTS window whether the teeth have or have not made the desired amount of change after a number of treatments have been prescribed. Textual comments (e.g., entered by the user) may therefore be important in the viewing and modification of the digital dental arch model(s).

In one configuration, the user interface is configured to display an early stage (or “Current Stage”) tooth arch, which represents a pre-modified arrangement of the dental arch, before the dental arch is modified or further modified. In some variations, this is the current status of the tooth or the projected current status of the tooth. The user interface may further indicate a “Target Stage” of the dental arch, which may represent the intended target locations of the teeth (e.g., in the next aligner treatment). The user interface may be configured such that the operator (e.g., orthodontist, dentist, dental technician, etc.) is not permitted to modify the digital tooth arch in the Current Stage, but the operator is allowed to modify the digital tooth arch in the Target Stage. In one example, a control (e.g., a toggle or icon) is provided within the user interface to enable modification of one or more of the digital dental arch models, such as an “ENABLE MODIFICATION” icon. When the control (e.g., the “ENABLE MODIFICATION” function shown in FIG. 15) is activated (e.g., by selecting the icon), the operator may move one or more of the individual components (e.g., teeth) in Target Stage, and thereby modify the target dental arch model. Optionally, the user interface may also be configured with the ability to display the “Initial Stage” tooth arch, which represents the patient's tooth arch before the treatment was initiated. In another variation, the user interface is configured with the option to allow the operator to compare any number of models, including digital models representing the dental arch in the “initial stage”, the “current stage”, the “target stage”, etc.

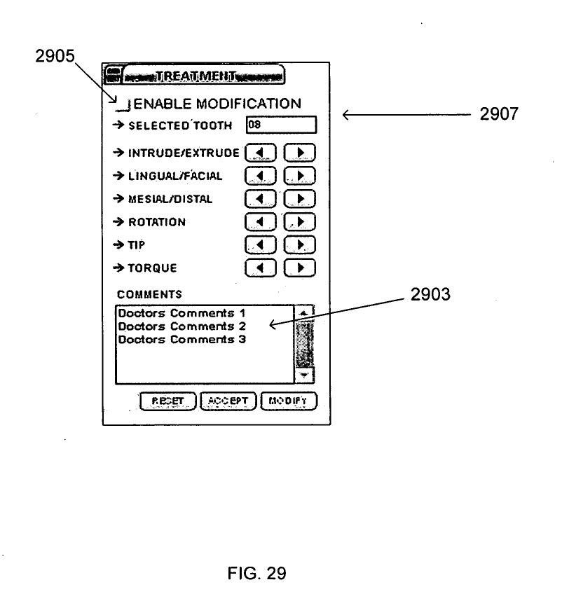

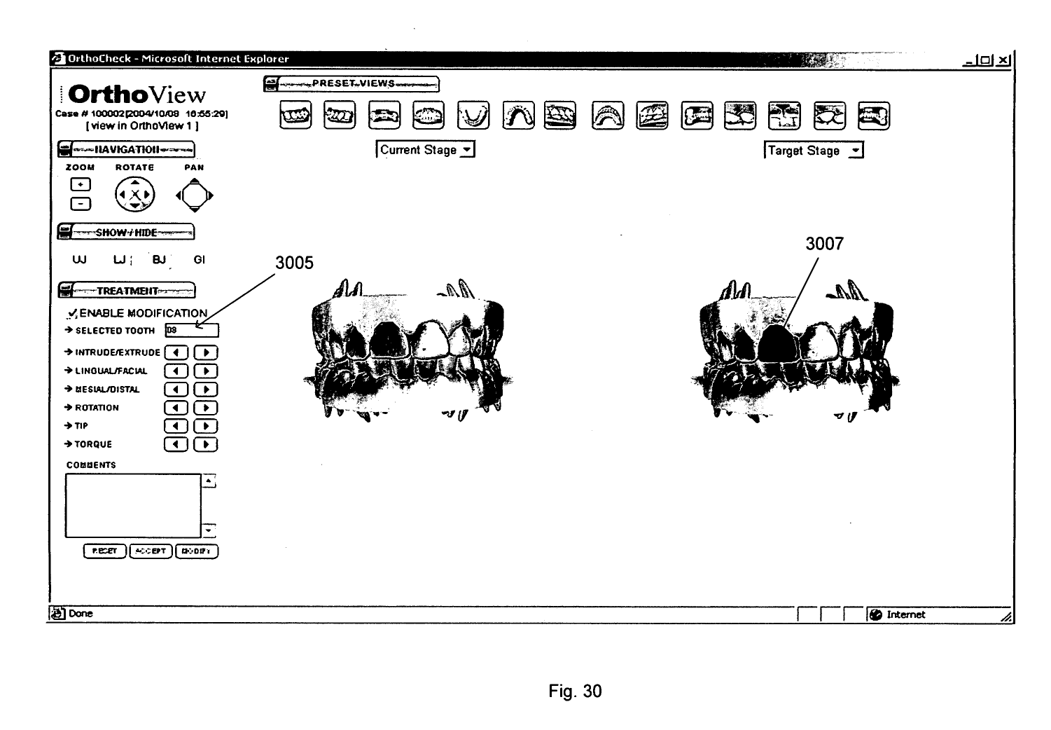

The user interface may allow control of various components of the digital dental arch. For example, a user may modify the digital dental arch, and may comment on the digital dental arch (or a portion of the digital dental arch). In some variations, the user interface includes a choice allowing the user to select (e.g., by clicking an icon, selecting a box or menu item, etc.) to enable modification of one or more of the digital dental arches. As described above, the user may indicate that they wish to modify the target digital dental arch (shown in the right on FIG. 15). Thus, in one example, the user may do any modification or write any comments for rejection, modification or acceptance after clicking an ENABLE MODIFICATION checkbox. FIG. 29 illustrates a “treatment” control region 2907 which may be used as part of a user interface. The ENABLE MODIFICATION checkbox 2905 may be selected (e.g., by tabbing or using the mouse, etc.) allowing the user to modify one region of the dental arch.

After enabling modifications, the user can select (e.g., by clicking on) any tooth to select it. The selected tooth may change color and a universal number for the selected tooth can be displayed in the treatment section of the control panel. Alternatively, a tooth may be selected for movement or modification by entering the universal number for the tooth into a selection region, as show in FIG. 29. The teeth may be referred to by any indicator (including a universal number) which uniquely identifies the tooth. In variations, more than one tooth may be selected. The selected tooth may be visually indicated by color or some other indicator, and then be moved relative to the rest of the dental arch.

FIG. 30 shows a tooth that has been selected 3007 (indicated by the shading. A unique identifier for this tooth is also indicated in the “selected tooth” box 3005 as tooth “08”. Once a tooth has been selected, it may be moved in any appropriate manner (e.g., it may be rotated or translated, etc.). For example, as indicated in the “Treatment” section of the user interface, the user may select any of the icons to translate this tooth. The translations may be dental-arch appropriate movements. For example, the movements may be based on the kinds of reasonable movements that an aligner may be capable of making, e.g., in both direction and degree (or magnitude of movements). For example, the tooth ay be moved to intrude or extrude (e.g., from the dental arch), moved in the lingual/facial direction, moved in a mesial or distal direction, rotated (e.g., about the central or long axis of the tooth), tipped, or torqued. Of course, many of these movements may overlap with each other. The amount of each movement made when clicking on (or otherwise activating) the icon for one of these types of movement is typically small enough to be reasonably achieved by dental aligners (e.g., 0.1 mm, 0.1°, etc.).

The user interface may also be configured to provide information to the orthodontist with regards to interproximal reduction of the tooth. The information provided may advise the orthodontist on how much material to remove (e.g., shave, etc.) from the tooth to allow the tooth or its adjacent member to rotate. The computer software may also recommend to the orthodontist on the specific location to perform interproximal reductions. In one variation, the software is configured with a safety value such that the maximum grinding recommended by the software can not exceed a predefined value. For example, the maximum grinding may be set at 0.5 mm. The interproximal reduction (e.g., suggestions provided to a practitioner) may be based on movements of the digital dental model made by the user, and may take into account other boundary conditions, as described further below.

In one example, as a tooth being rotated within the digital dental arch model overlaps an adjacent tooth, the software will calculate the amount of recommended interproximal reduction based on the location of the overlap and/or the amount of overlap. In some variations, the interface may include a choice to calculate or allow interproximal reductions. The software may also include output describing the recommended interproximal reductions. In some variations, the software may allow the user to input interproximal reductions between teeth as text (e.g., rather than having to manually move the teeth in a digital dental model to reflect the interproximal reduction). Thus, the user interface may include an icon or menu item to allow the digital modeling of interproximal reduction.

The digital representation of the tooth arch may also include information on the locations for the placement of protrusions, buttons, or attachments on the teeth. These protrusions on the teeth are configured to engage the corresponding holes or grooves on the aligner to secure the aligner to the patient's tooth arch. In one variation, the operator may use the computer user interface to prescribe the location for the placement of a protrusion on a specific tooth in the tooth arch. For example, the interface may allow the user to “drop” protrusions, buttons or attachments onto the digital dental arch model. Furthermore the software may also generate instructions (e.g., a “map” or guide) of the selected locations for the protrusions, buttons or attachments. For example, the software may generate a guide or instructions for forming a guide that can be used by a practitioner to attach the protrusions, buttons or attachments to the subject's teeth.

The digital representation of the dental arch model (including the simulated roots) may simulate potential collisions between the teeth, particularly when the positions of the teeth are modified by the user or through a computer program. In addition, boundary conditions may be predefined to limit the amount of root rotation by the software (or user). As shown in FIG. 12, the roots are elongated and extend from the crown of the teeth. Rotation of the crown of a tooth may cause large displacement at the tip of the root, which can cause the root to collide with the root of an adjacent tooth. In one variation, the computer software is configured to detect a collision (or collisions) when a boundary parameter representing a first component or region of the dental arch (e.g., tooth or root) crosses over a boundary parameter representing a second component or region of the dental arch (e.g., tooth or root). The software may indicate to the user that a collision has occurred. In another variation, once collision has been detected, the software will not allow the user to rotate the tooth further in the collision direction. In another example, each of the teeth (i.e., crown and/or root) is represented by a mesh of points. When the mesh of points representing the first teeth and the mesh of points representing the second teeth occupies the same space, this would indicate that the two teeth have collided.

In another variation, boundary parameters may be defined around the root to simulate physiological conditions in the patient's jaw that would limit the rotation and/or displacement of the root. Thus, the boundary condition may indicate that it becomes “harder” to move the teeth as the roots become closer. In one example, the software utilizes boundary parameters to prevent over-rotation of the teeth. For example, a boundary condition may be defined for each tooth to limit the amount of the rotation and/or displacement that can be prescribed by the user. The boundary condition may be generated based on population sample data of humans' teeth, gum, and jaw structures. The boundary condition may be utilized to prevent the user from directing the rotation or displacement of the teeth to an unrealistic condition. Furthermore, boundary conditions may be determined for different population subgroups. For each patient, the boundary condition from the appropriate population sub-group that matches the patient's physical parameters may be used to provide better estimation of the physiological limitations.

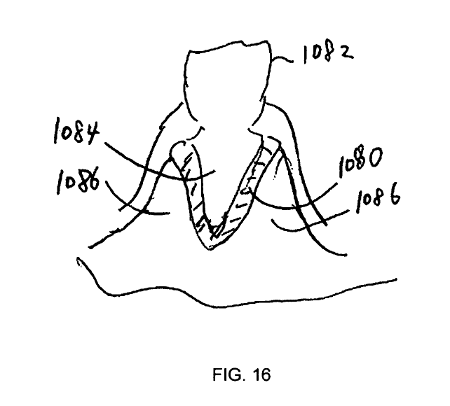

Other dental features may also be displayed by the user interface. For example, the user interface may display the teeth in the context of a model of the subject's mouth or face, or other dental features. For example, the software may model and display periodontal ligaments (PDLs) 1080 on each tooth 1082 for all of the teeth within the digital representation of a tooth arch. As shown in FIG. 16, typically the PDL 1080 surrounds the base of the root 1084. In one example, the digital representation of a patient's dental arch comprises a plurality of teeth, including both the crown and root portions, and a PDL layer is placed over the root portion for each of the teeth. The thickness and distribution of the simulated PDL layer over the root may be based on clinical data. For example, clinical data of the PDL layer thickness and distribution pattern may be used to generate a set of parameters defining the average PDL characteristics. A computer program then utilizes these parameters to simulate the PDL layers over the roots of the teeth. As one of ordinary skill in the art having the benefit of this disclosure would appreciate, various mathematical modeling techniques (e.g., finite element analysis, mass-spring model, etc.) and computer simulation tools may be implemented to model the tissue property of the PDL in relation to the root of the tooth and/or the surrounding tissues.

In another variation, in vivo analysis of the root and/or the PDL may be conducted to determine appropriate parameters for modeling the root and/or the PDL. For example, pressure or force may be applied onto a tooth within a patient's mouth while the amount of displacement or rotation of the tooth is measured. The data is then translated into an equation that models the movement of the tooth in response to force. Other experimental data collected on the tissue characteristics of the PDL may also be utilized to model the response of the PDL to force. For example, force or stress may be applied on a PDL tissue in an in vitro setting to measure the PDL's resistance to various levels of forces. The measurement may then be utilized to derive an equation that characterizes the PDL layer. This equation is then implemented in the digital tooth arch model to simulate the physical tissue characteristics of the PDL layer in response to the tooth displacement or rotation.

In addition, the computer program may be further configured to project stress or pressure that would be experienced by the PDL layer as the tooth is rotated or displaced. In one example, a boundary condition is defined around the PDL layer for each of the teeth. As a particular tooth within the tooth arch is rotated and/or displaced, the PDL layer may cross-over the boundary layer. The software then indicates to the user that stress and/or pressure are being exerted on the PDL layer. In one variation, a color and/or shading scheme are utilized to indicate to the user the amount of stress and/or pressure being exerted on the PDL. For example, as the pressure on the PDL is increased, the color display on the PDL layer may shift from a yellow to red, and within each color, the shading may increase with the projected pressure also. In another variation, as the pressure or stress is increased on the PDL layer the displayed image on the electronic display device may show a change in the thickness of the PDL. The variation in thickness of the layer may indicate to the user that a particular pressure point has developed over a specific region of the PDL as the user rotates or displaces the tooth. In addition, the display of stress (or even collision) may be used to indicate collision, proximity or even difficulty of movement of the dental arch components. For example, a color change may also be used to indicate a possible collision.

In another aspect, the jaw bone 1086 is simulated around the root 1084 of each of the teeth in the tooth arch. In one variation, the digital model also takes into account the PDL layer 1080 located between the root and the jaw bone. In another variation, the jaw bone is simulated around the root, without the simulated PDL layer, to serve as a boundary condition for the rotation and displacement of the tooth. In yet another variation, the program (e.g., the user interface) is configured to allow the user to selectively show the PDL layer and/or the jaw bone in the digital model of the tooth arch. The parameters used by the computer program to simulate the jaw bone may be based on clinical data of the general population, or data collected from a particular sub-ground of the population that matches the patient's profile. In another variation, the jaw bone is simulated based on X-ray data provided by the dentist. For example, two-dimensional X-ray image may be superimposed over the digital model of the tooth arch, and a digital representation of the jaw bone may be created based on the X-ray image. The three-dimensional depth profile of the jaw bone may be interpolated or defined with other predefined parameter along with the X-ray data. In yet another variation, MRI data is collected and utilized by the computer program to simulate the jaw bone.

The digital representation of the jaw bone superimposed over the tooth arch model may be utilized as a boundary condition to limit the amount of rotation and/or displacement of the roots of the teeth. In one variation, the software is configured to prevent the root from rotating or displacing beyond the boundaries defined by the jaw bone. In another variation, once the root collided with the boundary defined by the jaw bone, a color change within the interfering section of the root and the jaw bone will be displayed in the user interface as a different color (e.g., a red color may be used to draw the operator's attention; a dark shade may be imposed to isolate the interfering section from the back ground color, etc.) to warn the operator of such a condition. In yet another variation, an audible indicator (e.g., ring, buzz, etc.) may be generated by the computer to warn the user when a tooth is being over-rotated. Furthermore, a force-feedback device may also be implemented to provide tactile or other motion feedback to the operator. For example, a computer mouse or joystick, implemented to allow the operator to select a tooth and move the tooth within the tooth arch, may comprise an actuator that vibrates the computer mouse when the tooth is being displaced or rotated beyond a predefined boundary. As one of ordinary skill in the art would appreciate, computer software that support three-dimensional modeling and display of objects, and implementation of boundary conditions to constrain the movements of virtual objects in digital models, are well known to one of ordinary skill in the art. For example, Viewpoint Media Player and Macromedia Flash may be integrated into a customized software package to provide the three-dimensional display capability.

As mentioned above, images of the dental arch or individual teeth may also be displayed so that they appear three-dimensional. These three-dimensional images may also be configured for user interaction (e.g., rotation, manipulation, etc.). For example, 3D glasses or goggles may be used to view stereo images of the dental arch, presenting a 3D view of the dental arch. A 3D mouse or other appropriate controller may be used to manipulate the dental arch or individual teeth, including selecting menus, rotating the teeth, etc. For example, a haptic glove may be used to select and translate one or more of the teeth in a dental arch, or to move the entire dental arch. Force feedback may be used with the controller to indicate constraints on movement (e.g., preventing interference, or indicating that it is more difficult to more a tooth of the dental arch in certain directions).

The user may also use the interface described herein to indicate how to proceed with the digital dental arch model. For example, the user interface may allow a user to accept a proposed “prescription view” (e.g., Rx view) of a subject's dental arch, or it may allow the user to modify the proposed configuration of the subject's teeth. In one particular design, the user may make modifications to the digital tooth arch in the Target Stage, and then indicate the status or effect that the user wishes the modification to have on a digital dental arch model. The user interface may be provided with icons such as a RESET icon, an ACCEPT icon, and a MODIFY icon, as shown in FIG. 15. The “RESET” icon allows the orthodontist to erase his modification and reset the digital tooth arch in the Target Stage to an earlier configuration (e.g., before making any changes, or before saving changes). Selection of the “ACCEPT” icon may indicate to the system that the orthodontist accepts the treatment plan shown in the Target Stage, subject to any modification or comments he has provided. Once the “ACCEPT” button has been selected, the system can proceed to order the fabrication of the new aligner according to the tooth arch shown in the Target Stage and any comments provided by the user. The selection of the “MODIFY” icon indicates that the orthodontist is dissatisfied with the treatment plan shown in the Target Stage, and he would like the aligner manufacturer to make further modification. Once additional modification has been made, the orthodontist will be provided with another opportunity to revise and/or approve the revised digital tooth arch model in the Target Stage. Thus, the software interface can be used to approve/reject/modify a digital dental model, including a proposed reconfigured digital dental arch model that may be used as part of a treatment plan.

In one variation, if a user interface such as the one described in the example above is used, if the user modifies a treatment by pressing the Modify button, the digital arch model can be reformulated to propose a new dental arch model consistent with the treatment protocol used. The new model can take into account the comments and treatment changes submitted by the clinician. If the user enters some comments or changes (e.g., in the dialog box 2903 shown in FIG. 30), but accepts the treatment represented by the illustrated digital arch model by pressing the Accept button, the digital arch model (e.g., the Rx view) will be conditionally accepted. In operation, this may mean that the modifications will be performed in the treatment if possible, but no further acceptance/rejection decisions will be required from the user before an aligner can be made. The user interface may also reflect the status of the case (e.g., modifying/accepted, etc.). Alternatively, if the user selects the reset button, all modifications performed by the user will be rolled back and the user will need to restart the review process.

The user interface (e.g., software interface) described herein may include any of the features described above. The user interface may include display logic for controlling the display of one or more of the digital dental arch models (which may also be referred to as digital tooth models). The display logic may be in the form of computer- or machine-readable code which may run on a computer. In some variations, the display logic is configured to display two or more digital dental arch models in any of the ways disclosed and described herein. For example, the display logic may be configured to provide at last two viewing areas as described herein.

The features of the user interface may be arranged in any appropriate manner. For example, the features may be displayed as shown in FIG. 15, to include two dental arch display regions (e.g., side-by-side) for displaying different variations of a subject's dental arch, including a pre-modified and a modifiable version of the digital dental arch. The user interface may also include regions for controlling navigation (e.g., a navigation tool or toolbar, as shown in FIG. 15 1051), which may include tools (e.g., icons) for controlling the display of one or both digital dental arches. The navigation tool may include controls for selecting which display to modify. The user interface may also include features for showing or hiding various components of the digital dental arch as shown in FIGS. 28A-28D. The show/hide choices may include icons, or menu items for toggling on/off various aspects such as the upper arch, lower arch, gingiva, regions of stress, jaw, PDLs, face, etc. The user interface may also include preset views (e.g., a menu or icons/buttons) as shown in FIG. 27. The user interface may also include treatment choices, for moving or otherwise selecting and controlling components of the digital dental arch. For example, teeth may be modified by translation (e.g., intrusion/extrusion, lingual/facial, medial/distal), rotation, tipping, torquing, etc., as shown in FIG. 29. The user interface may also indicate patient-identification information.

### EXAMPLES

Another exemplary process for generating a digital dental arch model, is described in detail below. First, negative impressions of the patient's upper and lower tooth arches, and X-ray images of the teeth, are taken through procedures that are well known to one of ordinary skill in the art. Although the X-ray images are not required for generating the digital model of the tooth arch, X-ray images may be utilized either directly by the simulation program or indirectly by the operator to modify or enhance the digital tooth arch model. For example, the X-ray images may help in the placement of the fiduciary markers, or in modeling the roots of the teeth as described above.

The negative impression 10100 of the patient's tooth arch is coupled (e.g., glued, bonded, interlocked, etc.) to a container 10102, and a positive (or negative) dental mold may be made including fiduciary markers (e.g., pins) as described above. For example, a physical positive tooth model may be made from a preliminary scan of a negative mold of the teeth and casting a positive dental arch model including pins located by a preliminary scan (e.g., see the section above entitled “Digitization Examples”).

The teeth on the positive tooth arch 10114 can be separated to form physical models 10116 of the individual teeth, as shown in FIG. 17E. The individual physical models of the teeth are then positioned on a base plate 10118 and scanned with a scanner to create digital representation of individual teeth, as shown in FIG. 17F. On the base plate 10118, holes 10120 are pre-fabricated for receiving the individual tooth models 10116. The computer may be provided with information regarding the position of the predefined holes 10120 on the base plate 10118. The predefined holes 10120 are configured to receive the pins 10110 on the individual tooth models 10116. Thus, once the crown portion of a tooth has been digitized with the scanner, the digital representation of the crown can be associated with the corresponding pin information, and be referenced to the proper tooth in the tooth arch.

FIG. 17G illustrates examples of graphic projections of the individual digital representations of selective teeth 10122, each of which comprise a crown portion of the corresponding tooth. In one variation, a section of the gingival tissue is also digitized. Depending on the scanning machines configuration, one or more teeth may be scanned at a time. For example, the scanner may be configured to scan one tooth at a time. In another variation, the scanner is configured to scan eight individual tooth models at a time. In yet another variation, the scanner is configured to scan sixteen teeth at a time.

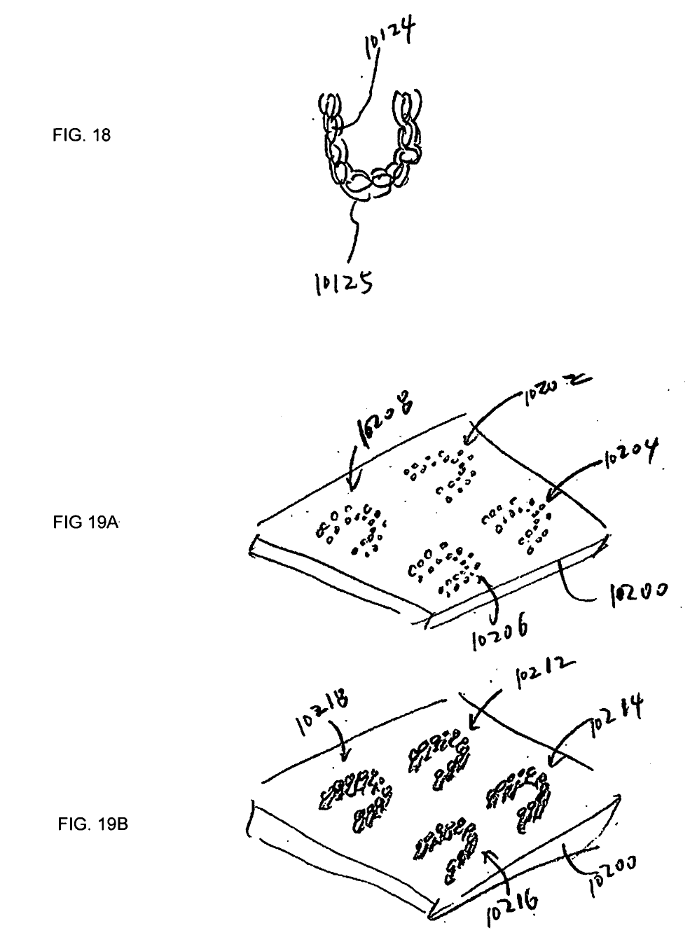

Once the individual teeth have been digitized, the digital representations of individual teeth 10122 are then utilized by a computer program to generate a digital representation of the complete tooth arch 10124, as shown in FIG. 17H-1a. In one example, the computer program utilizes the locations of the pins 10100 to calculate the relative position of the teeth within the tooth arch, in order to align the individual teeth to form the complete tooth arch. Optionally, the three-dimensional digital scan of the positive tooth arch 10114 of FIG. 17D, may be superimposed on the digital representation of the complete tooth arch 10124 of FIG. 17H-1a to serve as a reference to adjust the relative position of individual teeth within the digital tooth arch 10124, which is formed of a combination of a plurality of individual digital representation of teeth. As show in FIG. 18, the three-dimensional digital scan of the tooth arch 10125, which is generated from scanning a compete arch model (either a positive model or a negative impression), is superimposed on the digital representation of the tooth arch 10124, which is generated from combining digital representations of individual teeth. The overlaid individual teeth sections allow the operator and/or software to match up individual teeth between the two digital tooth arches. Each of the teeth within the digital tooth arch 10124 is then adjusted, such that each of the teeth would match up with the corresponding tooth in the three-dimensional digital scan 10125 of the tooth arch. The adjusted digital representation of the tooth arch 10124 may then be utilized for computer modeling or preparation of a dental appliance.

Once the digital tooth arch 10124 has been constructed, the computer program then calculates a simulated root with one or more of the methods describe above, to create a root for each of the teeth in the digital representation of the tooth arch. FIG. 17H-1b illustrates a graphical projection of the digital representation of the patient's arch 10124, which comprises both crowns 10128 and roots 10130.

In another variation, each of the digital representation of individual teeth 10122 is used as basis to create roots 10132 that match the crown portion 10134 for each of the teeth. Various methods for generating roots for the corresponding crown, which were described in detail above, may be applied to create the root portion for each of the teeth. Furthermore, information regarding the pin locations, which corresponds to the approximation of root positions, may be applied to position/couple the root profile to the crown. For example, the computer program may utilize the pin location information to determine if the root portion is centered in relation to the crown portion. The direction of the pin and the amount of misalignment (if any) may also be calculated. For example, the computer may use the pin information to determine whether the primary axis of the root is tilted in relation to the primary axis of the crown, such that the simulated root can be tilted by the proper amount and in the appropriate direction. FIG. 17H-2a shows examples of the graphical projections of the digital representation of the individual teeth 10136 with their simulated roots 10132. The computer program can then transform the individual digital representations of the teeth 10136 into a complete arch 10138 as shown in FIG. 17H-2b. Pin information corresponding to each of the digital representation of the teeth may be utilized to inter-relate the individual teeth, and can transform the individual digital representation of the teeth 10136 into a complete tooth arch 10138. In another variation, the dental arch may be reconstructed from the individual digital representation of the teeth based on data collected from scanning either a positive mold or a negative impression of a patient's complete arch. In yet another variation, a digital tooth arch produced from scanning of either a positive mold or a negative impression of the patient's arch is superimposed over the digital representation of the tooth arch 10138 formed from combining individual teeth representation. The overlaid digital tooth arch from scanning of a full arch is then utilized as a basis to adjust the position of the individual teeth within the digital representation of the tooth arch 10138. The adjusted digital tooth arch may then be implemented for further processing.

Although only the construction of the digital representation of the lower tooth arch is describe above, one of ordinary skill in the art having the benefit of this disclosure would appreciate, digital representation of the patient's upper tooth arch can also be prepared with the method describe above. In some variations, the dental arch (e.g., the upper dental arch) also models the palate region. The palate region may be measured for a negative or positive impression as with any other region of the dental arch described herein.

Once the digital representation of the patient's tooth arch has been prepared, software may then be utilized to modify one or more of the teeth within the digital tooth arch relative to the rest of the teeth in the tooth arch. The software may support a user interface to allow the user to modify the teeth within the digital tooth arch. FIG. 17I illustrates an example of a digital tooth arch 10140 with the position/orientation of one of the teeth 10142 within the tooth arch being modified.

The modified digital tooth arch may then be utilized to fabricate a removable aligning appliance for orthodontic treatment. In one variation, a digital representation of a shell 10144 configured to serve as an aligner is generated by a computer based on the modified digital representation of the tooth arch 140, as shown in FIG. 17J-1a. A physical shell 10146 is then fabricated based one the digital representation of the shell 10144. Various fabrication techniques that are well known to on of ordinary skill in the art may be utilized to create a physical object based on its digital representation. For example, three-dimensional polymeric printing technique may be utilized to create a polymeric aligner based on the digital representation of the shell. FIG. 17J-1b illustrates an example of a polymeric aligner 10146 created based on the digital representation of the shell 10144 shown in FIG. 17J-1a.

In another variation, the modified digital representation of the tooth arch 140 is provided as reference to modify the arrangements of a corresponding physical model of the tooth arch. The modified physical model of the tooth arch is then implemented to fabricate the desired aligner. For example, as a tooth in a digital representation of a tooth arch is displaced or rotated, the corresponding pin position for that particular tooth will also be changed relative to the pin positions of the rest of the teeth in the tooth arch. The digital representation of modified tooth arch 10140 can be configured to retain all the revised pin positions. These revised pin positions are then utilized to modify physical model of the tooth arch, such that the physical model would correspond to the modified digital representation of the tooth arch.

In one variation, holes 148 are drilled into a base plate 10150 with CNC machinery so that the position and orientation of these holes 10148 correspond to the revised pin position in the digital representation of the tooth arch 10140, as shown in FIG. 17J-2a. Physical models of the patient's individual teeth 10116, such as the ones shown in FIG. 17E, can then be inserted onto the base plate 10150 to form a tooth arch 10152 that corresponds to the modified digital representation of the tooth arch 10140, as shown in FIG. 17J-2b. As the operator places the individual teeth models 10116 onto the base plate 10150, the operator may adjust the individual teeth (e.g., shaving, or rounding out sections of the tooth profile, etc.) to ensure that proper fit between the teeth 10116 on the tooth arch 10152 can be achieved.

The physical tooth arch model 10152 including the modified tooth 10154 may then be utilized to fabricate a removable aligner. For example, a polymeric sheet 10156 may be placed over the physical tooth arch model 10152 with the modified tooth, as shown in FIG. 17J-2c. The polymeric layer 156 is suctioned onto the tooth arch 10152 and then heat-formed over the tooth arch 152. Once the heat-formed polymeric sheet has cooled off, the sheet 10158 is peeled off the physical tooth arch model, as shown in, FIG. 17J-2d. Excess materials on the heat-formed polymeric sheet 10158 are trimmed off to form a polymeric shell 10160 that can serve as a removable aligner, as shown in FIG. 17J-2e.

In another variation, one or more copies of the digital representation of the tooth arch, which represents the original condition of the patient's tooth arch, may be created. Each of the duplicate digital tooth arches may be modified in varying degrees to represent the projected or intended position of the tooth for a specific a stage within a series of stages during the process of orthodontic treatment. The modified digital tooth arches may then be implemented to fabricate a series of removable aligners that match the modified digital tooth arches.

In one example, a based plate is configured with multiple sets of holes, where each sets of holes forms an arch configured for receiving a plurality of positive teeth models to form a tooth arch. In one variation, the base plate 10200 comprises four sets of holes 10202, 10204, 10206, 10208 representing four arches, as shown in FIG. 19A. The holes correspond to projected pin positions based on the digital representations of the four different arches. Corresponding positive teeth models are then inserted into the holes on the base plate 10200 to form four positive arch models 10212, 10214, 10216, 10218 as shown in FIG. 19B. These four positive arch models are then utilized to form four separate dental aligners. For example, a casting material, such as a polymer sheet, may be place over the four positive arches on the base plate and heat-formed to create the four dental aligners.

This invention has been described and specific examples of the invention have been portrayed. While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well. Finally, all publications and patent applications cited in this specification are herein incorporated by reference in their entirety as if each individual publication or patent application was specifically and individually set forth herein.

What is claimed is:

1. A method for digitizing a patient's arch, comprising:
producing a physical arch model for the patient's arch;
separating the physical arch model into a plurality of arch model components;
mounting the arch model components on a scan plate;
capturing one or more images of the arch model components; and
developing digital representations of the arch model components using the captured one or more images.

2. The method of claim 1, further comprising:
transforming the digital representations for the arch model components into a common coordinate system.

3. The method of claim 2, further comprising:
combining the digital representations of the arch model components into a digital arch model.

4. The method of claim 1, further comprising:
producing registration features on the arch model components to define relative positions of the arch model components; and
producing receiving features on the scan table to receive the registration features on the arch model components when the arch model components are mounted on the scan table.

5. The method of claim 4, further comprising:
combining the digital representations for the arch model components into the digital arch model using the coordinates of registration features and the positions of the receiver features on the scan plate.

6. The method of claim 1, further comprising:
selecting a direction for the image capturing of the arch model components; and
determining the distribution of the arch model components on the scan plate.

7. The method of claim 1, wherein the one or more images of the arch model components are captured at 45 degrees relative to the surface of the scan plate.

8. The method of claim 1, wherein developing digital representations of the arch model components using the captured one or more images comprises:
computing the coordinates of a plurality of surface points on the arch model components by triangulation; and
interpolating the coordinates of the plurality of surface points to construct the surfaces of the arch model components.

9. The method of claim 1, further comprising:
capturing a first image of the arch model components when the scan plate is at a first orientation;
rotating the scan plate to a second orientation; and
capturing a second image of the arch model components when the scan plate is at the second orientation.

10. A method for digitizing a patient's arch, comprising:
producing a physical arch model for the patient's arch;
separating the physical arch model into a plurality of arch model components;
mounting the arch model components on a scan plate;
capturing one or more images of the arch model components;
developing digital representations of the arch model components using the captured one or more images; and
combining the digital representations for the arch model components into a digital arch model.

11. The method of claim 10, further comprising:
producing registration features on the arch model components wherein the registration features can define relative positions of the arch model components; and
producing receiving features on the scan table, the receiving features being configured to receive the registration features on the arch model components when the arch model components are mounted on the scan table.

12. The method of claim 11, further comprising:
combining the digital representations for the arch model components into a digital arch model using the coordinates of registration features and the positions of the receiver features on the scan plate.

13. The method of claim 10, wherein constructing surfaces of the arch model components comprising:
computing the coordinates of a plurality of surface points on the arch model components by triangulation; and
interpolating the coordinates of the plurality of surface points to construct the surfaces of the arch model components.

14. The method of claim 10, further comprising:
capturing a first image of the arch model components when the scan plate is at a first orientation;
rotating the scan plate to a second orientation; and
capturing a second image of the arch model components when the scan plate is at the second orientation.

15. A system for digitizing a patient's arch, comprising:
a scan plate configured to be mounted with a plurality of arch model components that are separated from a physical arch model corresponding to the patient's arch;
an image capturing device configured to capture at least one image of the arch model components; and
a computer configured to develop digital representations of the arch model components using the captured one or more image.

16. The system of claim 15, wherein the computer is configured to combine the digital representations for the arch model components into a digital arch model.

17. The system of claim 15, further comprising:
a rotation mechanism coupled to the scan plate, configured to rotate the scan plate under control of the computer to allow a plurality of images of the arch model components to be captured in a plurality of directions.

18. The system of claim 15, wherein the arch model components comprise registration features that define relative positions of the arch model components.

19. The system of claim 18, wherein the scan table comprises receiving features configured to receive the registration features on the arch model components.

20. The system of claim 15, further comprising:
a plurality of image capture devices configured to capture images at different directions relative to the arch model components.

21. A method for digitizing a patient's arch, comprising:
producing a physical tooth arch model for the patient's tooth arch;
separating the physical tooth arch model into a plurality of tooth arch model components;
scanning the tooth arch model component capture data representing the tooth arch model component; and
developing digital representations of the tooth arch model components using the data representing the tooth arch model component.

22. The method according to claim 21 wherein the scanning step comprises scanning the plurality of tooth arch model components one at a time.

23. The method according to claim 21 wherein the scanning step comprises scanning two or more tooth arch model components at a time.

24. A scanning platform comprising:
a scanner;
a rotating scan plate;
a plurality individual tooth models of a patient's teeth being positioned on the rotating scan plate in a configuration to allow all the tooth models to be scanned by rotating the rotating scan plate.

25. A method of generating a digital dental arch model comprising:
creating a positive dental arch replica based on a negative dental arch mold;
separating the positive dental arch replica into a plurality of individual tooth replicas;
placing a first group of said plurality of individual tooth replicas on a surface forming a first a partial dental arch;
scanning said first partial dental arch;
generating a digital representation of said first partial dental arch;
placing a second group of said plurality of individual tooth replicas on the surface forming a second partial dental arch;
scanning said second partial dental arch;
generating a digital representation of said second partial dental arch; and
superimposing the digital representation of said first partial dental arch with a digital representation of said second partial dental arch forming a digital representation of the positive dental arch replica.

26. The method according to claim 25, wherein the first group of said plurality of individual tooth replicas consists of every other tooth from said positive dental arch replica.

27. The method according to claim 26, wherein the second group of said plurality of individual tooth replicas consists of every other tooth from said positive dental arch replica.

28. The method according to claim 25, wherein each of the plurality individual tooth replicas comprises an extension, and said surface is located on a plate having a plurality of receptacles, each of which is configured to receive a corresponding extension to hold one of said plurality of individual tooth replicas on said plate.

29. The method according to claim 28, wherein each of the extension being configured to prevent the corresponding tooth from rotating in the corresponding receptacles.

30. The method according to claim 29, wherein each of the receptacles is configured to hold the corresponding tooth at an angle representative of a tilt of the tooth within the positive dental arch replica.

31. The method according to claim 25, wherein the surface is provided with a reference coordinate, each of said first and second digital representation of the partial arch is generated in relation to the reference coordinate.

32. A method of generating a digital dental arch model of a patient's tooth arch comprising:
making a positive dental arch replica of the patient's tooth arch;
separating the positive dental arch replica into a plurality of individual tooth replicas;
dividing the plurality of individual tooth replicas into a plurality of groups of tooth replicas, each of the groups having three or more teeth;
arranging each of said plurality of groups of tooth replicas on a plate, such that the tooth replicas within each group being positioned corresponding to their relative positions in the tooth arch;
scanning each of said plurality of groups of tooth replicas;
generating a digital representation of a partial arch for each of said plurality of groups of tooth replicas; and
superimposing the digital representations of the partial arches to form a digital representation of the patient's complete tooth arch.

33. The method according to claim 32 wherein each of the tooth replicas comprises an extension at a distal end and the proximal end of the tooth replica includes a profile representing a crown of a corresponding tooth in the patient's tooth arch, the plate comprises a plurality of receptacles for receiving the extensions of the tooth replicas, the receptacles are configured such that when all the tooth replicas are inserted into the plate a replica of the patient's complete tooth arch is formed.

34. The method according to claim 33 wherein the extension for each of the tooth replica being oriented to correspond to the orientation of a root of the corresponding tooth in the patient's tooth arch.

35. The method according to claim 33, wherein each of the extension being configured to prevent the corresponding tooth from rotating in the corresponding receptacles.

36. The method according to claim 33, wherein each of the receptacles is configured to hold the corresponding tooth on the plate at an angle representative of a tilt of the corresponding tooth in the patient' tooth arch.

37. The method according to claim 32, wherein the plate is provided with a reference coordinate, and each of the digital representation of the partial arch is generated in relation to the reference coordinate.

38. The method according to claim 37, wherein the superimposing step comprises utilizing the reference coordinate to superimpose the digital representations of the partial arches.

39. A method of generating a digital dental arch model of a patient's tooth arch comprising:
making a positive dental arch replica of the patient's tooth arch;
separating the positive dental arch replica into a plurality of individual tooth replicas;
arranging the plurality of individual tooth replicas on a plate having a reference plane;
scanning the plurality of individual tooth replicas while positioned on the reference plane of the plate;
generating digital representation of individual tooth replicas relative to the reference plane; and
rearranging the digital representation of individual tooth replicas on the reference plane to form the digital dental arch model of the patient's tooth arch.

40. The method according to claim 39, wherein each of the tooth replicas comprises an extension at a distal end, and the proximal end of the tooth replica includes a profile representing a crown of a corresponding tooth in the patient's tooth arch, the plate comprises a plurality of receptacles for receiving the extensions of the tooth replicas.

41. The method according to claim 40, wherein the extension for each of the tooth replica being oriented to correspond to the orientation of a root of the corresponding tooth in the patient's tooth arch.

42. The method according to claim 40, wherein each of the extension being configured to prevent the corresponding tooth from rotating in the corresponding receptacles.

43. The method according to claim 40, wherein each of the receptacles is configured to hold the corresponding tooth on the plate at an angle representative of a tilt of the corresponding tooth in the patient' tooth arch.

44. The method according to claim 40, wherein the receptacles are configured such that the rearranging step comprises moving the tooth on the reference plane on an X-axis and a Y-axis without rotation the tooth.

45. A method of modeling a subject's dental arches in occlusion, comprising:
identifying an upper arch model with a first fiduciary reference;
identifying a lower arch model with a second fiduciary reference;
aligning the upper arch model and the lower arch model to a bite-down position; and
measuring the relative positions of the upper arch model and the lower arch model by measuring the relative positions of the first and second fiduciary references.

46. The method of claim 45, further comprising mapping the upper arch model and the lower arch model to the same coordinate system.

47. The method of claim 45, wherein the step of aligning the upper arch model and the lower arch model to a bite-down position comprises aligning the upper arch model and the lower arch model to a bite-down position using a bite-down registration device.

48. The method of claim 47, wherein the bite-down registration device comprises a wax bit.

49. The method of claim 45, wherein identifying an upper arch model with a first fiduciary reference comprises labeling the upper arch model with a first fiduciary reference, and identifying a lower arch model with a second fiduciary reference comprises labeling the lower arch model with a second fiduciary reference.

50. The method of claim 45, wherein identifying an upper arch model with a first fiduciary reference comprises mounting the upper arch model on a first fixture, wherein the first fixture comprises a first fiduciary reference, and identifying a lower arch model with a second fiduciary reference comprises mounting the lower arch model on a second fixture, wherein the second fixture comprises a second fiduciary reference.

51. The method of claim 45, further comprising:
scanning at least a part of the upper arch model and the first fiduciary reference to model the upper arch model; and
scanning at least a part of the lower arch model and the second fiduciary reference to model the upper arch model.

52. The method of claim 51, further comprising:
producing a digital representation of the upper arch model; and
producing a digital representation of the lower arch model.

53. The method of claim 52, further comprising producing a digital representation of the upper arch model and the lower arch model in the same coordinate system.

54. A method for digitizing a subject's arch, comprising:
mounting an upper arch model for the subject on a first fixture;
mounting a lower arch model for the subject on a second fixture;
aligning the upper arch model and the lower arch model to a bite-down position using a bite-down registration device; and
measuring the relative positions of the upper arch model and the lower arch model.

55. A method of digitally modeling a subject's dental arch, comprising:
identifying an upper arch model with a first fiduciary reference;
identifying a lower arch model with a second fiduciary reference;
scanning the upper arch model to produce a digital upper arch model;
scanning the lower arch model to produce a digital lower arch model;
defining the coordinates of the digital upper arch model using the first fiduciary reference;
defining the coordinates of the digital lower arch model using the second fiduciary reference;
aligning the upper arch model and the lower arch model to a bite-down position;
using a bite-down registration device;
measuring the relative positions of the upper arch model and the lower arch model by measuring the relative positions of the first and second fiduciary references; and
transforming the digital upper arch model and the digital lower arch model into a common coordinate system.

56. The method of claim 55, wherein the bite-down registration device is a wax bit.

57. The method of claim 55, further comprising:
identifying the upper arch model with a third fiduciary reference; and
identifying a lower arch model with a fourth fiduciary reference;

58. The method of claim 55, wherein identifying an upper arch model with a first fiduciary reference comprises mounting the upper arch model on a first fixture, wherein the first fixture comprises a first fiduciary reference, and identifying a lower arch model with a second fiduciary reference comprises mounting the lower arch model on a second fixture, wherein the second fixture comprises a second fiduciary reference.

59. A system for digitizing a dental arch, comprising:
a scan plate configured to receive a plurality of arch model components separated from a model a dental arch;
an image capturing device configured to capture at least one image of the arch model components; and
a computer configured to construct the coordinates of the surfaces of the arch model components using the captured image to produce digital representations for the arch model components, and to transform the arch model components into a single coordinate system.

60. The system of claim 59, wherein the computer is configured to combine the digital representations for the arch model components into a digital dental arch model.

61. The system of claim 59, further comprising a rotation mechanism coupled to the scan plate, configured to rotate the scan plate under control of the computer to allow a plurality of images of the arch model components to be captured in a plurality of directions.

62. The system of claim 59, wherein the arch model components comprise registration features that define relative positions of the arch model components.

63. The system of claim 62, wherein the scan table comprises receiving features configured to receive the registration features on the arch model components.

64. The system of claim 59, further comprising a plurality of image capture devices configured to capture images at different directions relative to the arch model components.

65. A method of modeling a patient's teeth position within a tooth arch comprising:
generating a digital representation of a crown portion of a tooth, by scanning an individual physical model of the patient's tooth, for each of a plurality of teeth within the tooth arch of the patient,
creating a digital representation of a root portion of the tooth for each of the corresponding crown portions of the teeth; and
formulating a first digital representation of the tooth arch based on at least the digital representation of the crown portions and the digital representation of the root portions of the teeth.

66. The method according to claim 65, further comprising:
displaying the first digital representation of the tooth arch showing the crown portion and the root portion for each of the plurality teeth.

67. The method according to claim 65, further comprising:
formulating a second digital representation of the tooth arch by modifying a position of one of the teeth within the first digital representation of the tooth arch relative to the other teeth within the first digital representation of the tooth arch.

68. The method according to claim 67, further comprising:
displaying the second digital representation of the tooth arch showing the digital representation of the crown and the digital representation of the root for the modified tooth in the modified position.

69. The method according to claim 68, further comprising:
displaying the first digital representation of the tooth arch.

70. The method according to claim 69, wherein the first and second digital representation of the tooth arch are displayed simultaneously next to one another within a display device.

71. The method according to claim 70, wherein the first digital representation of the tooth arch being displayed in a first orientation, and the second digital representation of the tooth arch being displayed in a second orientation corresponding to the first orientation of the first digital representation of the tooth arch.

72. The method according to claim 71, further comprising:
rotating the first orientation of the first digital representation of the tooth arch; and
allowing the second orientation of the second digital representation of the tooth arch to rotate simultaneously in a manner corresponding to the rotation of the first orientation of the first digital representation of the tooth arch.

73. The method according to claim 70, wherein the first and the second digital representation of the tooth arch are displayed in perspective views.

74. The method according to claim 67, further comprising:
fabricating a removable aligning appliance based on the second digital representation of the tooth arch.

75. The method according to claim 74, wherein said removable aligning appliance comprises a polymeric shell.

76. The method according to claim 65, wherein the tooth arch comprises at least three teeth.

77. The method according to claim 65, wherein the tooth arch comprises at least twelve teeth.

78. The method according to claim 65, wherein the digital representation of a crown portion of the tooth further comprises at least a section of a gingival tissue.

79. The method according claim 65, wherein the generating step further comprises generating the digital representation of a crown portion of the tooth based on either a positive or a negative dental mold of the patient's tooth.

80. The method according to claim 65, wherein the digital representation of the crown portion comprises a mesh of points in a three-dimensional space.

81. The method according to claim 80, wherein the creating step further comprises determining an axis for the digital representation of the crown portion based on the distribution of the mesh of points, and positioning the digital representation of the root portion along said axis.

82. The method according to claim 65, wherein the creating step further comprises selecting the digital representation of the root portion from a library of a plurality of pre-defined digital representation of roots.

83. The method according to claim 82, wherein said selecting step further comprises selecting the digital representation of the root portion based on at least a dimension of the digital representation of the crown portion.

84. The method according to claim 83, wherein said selecting step further comprises determining a type of tooth represented by the digital representation of the crown portion.

85. The method according to claim 84, wherein the type of tooth is selected from a group consisting of incisor, canine, premolar, and molar.

86. The method according to claim 65, wherein the creating step further comprises generating a digital representation of the root portion based on at least a morphology of the digital representation of the crown portion.

87. The method according to claim 65, wherein the creating step further comprises simulating the digital representation of the root portion of the tooth, and linking the simulated digital representation of the root portion of the tooth with the digital representation of the crown portion of the tooth.

88. The method according to claim 87, wherein the simulating step further comprises selecting the digital representation of the root portion of the tooth from a library of roots of varying sizes and shapes.

89. The method according to claim 88, wherein the selecting step further comprises comparing the selected digital representation of the root portion of the tooth with an X-ray image of the patient's corresponding tooth.

90. The method according to claim 88, wherein the selecting step further comprises comparing the selected digital representation of the root portion of the tooth with data extracted from an X-ray image of the patient's corresponding tooth.

91. The method according to claim 65, wherein the creating step further comprising utilizing data extracted from an X-ray image of the patient's corresponding tooth.

92. A computer system configured to perform the method according to claim 66.

93. A method of presenting an orthodontic teeth correction regimen comprising:
presenting a tooth arch model on an electronic display device, wherein said tooth arch model comprises a plurality of teeth,
modifying a position of at least one of the tooth on the tooth arch model relative to the rest of the teeth on the tooth arch model, and
displaying both a pre-modified tooth arch model and a post-modified tooth arch model in a side-by-side manner on the electronic display device.

94. The method according to claim 93, wherein and each of the teeth in the tooth arch model comprises a crown portion and a root portion.

95. The method according to claim 94, wherein the modifying step further comprising changing a position of the corresponding crown portion and root portion of the modified tooth.

96. The method according to claim 94, wherein each of the teeth further comprises at least a section of a gingival tissue.

97. The method according to claim 96, wherein a distribution of the gingival tissues on the tooth is representative of an actual distribution of the gingival tissue of a patient's tooth.

98. The method according to claim 93, wherein the tooth arch models are shown in perspective views.

99. The method according to claim 98, wherein rotation of the post-modified tooth arch model results in a corresponding rotation in the pre-modified tooth arch model.

100. The method according to claim 93, further comprising:
fabricating a removable aligner according to the post-modified tooth arch model.

101. The method according to claim 100, wherein said removable aligner consists of a polymeric material.

102. The method according to claim 93, wherein the presenting step comprises displaying both an upper arch and a lower arch of a patient's tooth arches.

103. The method according to claim 102, wherein each of the teeth further comprises at least a section of a gingival tissue.

104. The method according to claim 102, further comprising:
displaying both a pre-modified upper and lower arch and a post-modified upper and lower arch in a side-by-side manner.

105. The method according to claim 93, wherein an orientation of the root portion of each of the tooth indicates to a user an orientation of the corresponding crown portion of the tooth.

106. A computer system configured to perform the method according to claim 93.

107. A system configured for displaying an orthodontic treatment regimen comprising:
a user interface configured to receive data representing a patient's dental arch through a network connection, wherein said data comprises root information and crown information for a plurality of teeth in the patient's dental arch;
the user interface further configured to read said data and display a dental arch model including a plurality of teeth on an electronic display device, the dental arch model comprising at least a crown and a root for each of the teeth in the dental arch model.

108. The system according to claim 107, wherein said user interface is further configured to allow the user to modify a position of at least one of the teeth in the dental arch model.

109. The system according to claim 108, wherein said user interface is further configured to display a pre-modified view of the dental arch model and a post-modified view of the dental arch model on the electronic display device in a side-by-side manner.

110. The system according to claim 109, wherein said pre-modified view and said post-modified view are perspective views.

111. The system according to claim 109, wherein said user interface is further configured such that as the user rotates the dental arch model in the post-modified view, a corresponding rotation will result in the dental arch model in the pre-modified view.

112. The system according to claim 108, wherein said computer program is further configured to incorporate information regarding the user modification into the data.

113. The system according to claim 107, wherein said data comprises information regarding positions of the plurality of teeth prior to an intended treatment, and information regarding positions of the plurality of teeth in projected positions after the intended treatment.

114. The system according to claim 113, wherein the said user interface is further configured to display a pre-modified view of the dental arch model showing the positions of the plurality of teeth prior to a intended treatment, and a post-modified view of the dental arch model showing the positions of the plurality of teeth in a projected positions after the intended treatment, on the electronic display device.

115. Method for simulating a root of a patient's tooth comprising:
providing a negative impression of a patient's tooth arch, wherein said negative impression comprises negative impressions of a plurality of teeth, and
approximating a root position for at least one of said plurality of teeth based on the negative impression of the tooth.

116. The method according to claim 115 further comprising:
forming a positive mold of one of said patient's teeth based on the negative impression, wherein said positive mold comprises a crown portion and a base including a protrusion corresponding to the approximated root.

117. The method according to claim 116, wherein said protrusion comprises a pair of pins.

118. The method according to claim 115, wherein said approximating step further comprises inserting a three-dimensional position input device into a cavity forming the negative impression of the tooth.

119. The method according to claim 115, further comprising:
generating a digital representation of a crown portion of one of the patient's teeth,
creating a digital representation of a root portion of a tooth corresponding to said crown portion, and
combining said root portion with said crown portion based on the approximated root position.

120. The method according to claim 1115, further comprising:
generating a digital representation of a tooth for each of the teeth in said patient's tooth arch, wherein said digital representation of a tooth comprises a root portion and a crown portion.

121. The method according to claim 120, wherein the orientation of said root portion relative to said crown portion is determined base on the approximated root position.

122. The method according to claim 120, further comprising:
displaying a projection of said patient's tooth arch on an electronic display device based on the digital representation of the patient's teeth.

123. The method according to claim 115, further comprising:
forming a positive mold of said patient's tooth arch based on the negative impression, said positive mold comprising a plurality of crown portions, and each of the crown portions includes a protrusion extending off a base of the crown portion, wherein an orientation of said protrusion corresponds to the approximated root position for that particular tooth.

124. Method for modifying a digital tooth arch model:
creating a first digital tooth arch model by scanning a complete tooth arch model which comprises a plurality of teeth;
creating a second digital tooth arch model by scanning positive models of individual teeth, then combining digital representations of individual teeth into an arch;
superimposing the first digital tooth arch model over the second digital tooth arch model; and
adjusting the position of at least one tooth within the second digital tooth arch model according to the first digital tooth arch model.

125. The method according to claim 124, wherein said complete tooth arch model comprises either a positive mold or a negative impression of the complete tooth arch.

126. A physical tooth arch modeling platform comprising:
a base plate including a plurality of holes, said holes are configured in a plurality of arch-shaped patterns; and
a plurality of individual tooth models inserted in said plurality of holes, wherein said plurality of individual tooth models are configured to forms a plurality of tooth arches on said base plate.

127. A user interface for displaying digital tooth arch model comprising:
display logic configured to run on a computer, wherein the logic is further configured to provide at least two viewing areas; the first viewing area for displaying a first digital tooth arch, and the second viewing area for displaying a second digital tooth arch; wherein the display logic is further configured to allow a user to move all or a part of the first digital tooth arch model so that the second digital tooth arch model rotates simultaneously with the first digital tooth arch model.

128. The user interface according to claim 127, wherein said first digital tooth arch represents a pre-modified tooth arch, and said second digital tooth arch represents a post-modified tooth arch.

129. The user interface according to claim 127, further comprising a window to allow an operator to provide textual inputs.

130. The user interface according to claim 127, further configured to permit an operator to selective move a tooth within said second digital tooth arch.

131. The user interface according to claim 130, further configure to prevent the operator from moving any of the tooth within the first digital tooth arch.

132. The user interface according to claim 127, wherein said first and second digital tooth arches are shown in perspective views.
